(19) United States
(12) Patent Application Publication
(10) Pub. No.: US 2004/0005921 A1
(43) Pub. Date: Jan. 8, 2004

(54) Built-in-IC-chip medal and inscription machine thereof

(76) Inventor: Tomohiro Shinoda, Funabashi-shi (JP)

Correspondence Address: WILLIAM COLLARD, COLLARD & ROE, P.C., 1077 NORTHERN BOULEVARD, ROSLYN, NY, 11576, US

(21) Appl. No.: 10/449,804

(22) Filed: May 29, 2003

(30) Foreign Application Priority Data
May 29, 2002 (JP) 2002-156389

(51) Int. Cl. A63F 13/00

(52) U.S. Cl. 463/29; 463/8

(57) ABSTRACT

A medal with the built-in IC chip used on a medal gaming machine, which provides a medal with the built-in IC chip having a storage section which can store the initial data and the historical data of the game supplied from the aforementioned medal gaming machine, and which also provides a medal that can be a medal gaming machine combining an unprecedented amusement with the interest of a game itself by giving a new value of a game to a medal itself used for a medal gaming machine.

### CROSS-REFERENCE TO RELATED APPLICATIONS

This application is based upon and claims the benefit of priority from the prior Japanese Patent Application No. 2002-156389 filed on May 29, 2002, the entire contents of which are incorporated herein by reference.

This application is related to co-pending U.S. patent applications entitled “MEDAL GAMING MACHINE” and “MEDAL GAMING MACHINE AND SYSTEM THEREOF”, respectively, both applications being filed on even date herewith. The co-pending applications are expressly incorporated herein by reference.

### BACKGROUND OF THE INVENTION

1. Field of the Invention

The present invention relates to an medal with the a built-in IC chip used for a medal gaming machine and an inscription machine of a medal with a built-in IC chip (referred to “built-in-IC-chip-medal inscription machine” hereinafter) for issuing the medal with built-in IC chip.

2. Related Art

A recent game that is manufactured in Japan and supplied as a video game or an arcade game combines the latest hardware and software technology. A composite art or integrated industry of the game with an advanced graphic display technology for displaying characters, backgrounds, etc and a sophisticated speculative method such as plot development is highly evaluated not only in Japan but also in the world. A video game is a type of game to be played with a home video game machine or a portable gaming machine. An arcade game is a type of game that is played with an arcade video game machine installed in a game hall (so-called a game arcade).

These kinds of games range widely and may include, for example, a racing game which displays simulatively a horse race or an auto race, a sports game which displays simulatively a baseball game or a foot ball game, a story game in which a character moves freely in the predetermined region to obtain an item disposed in a map, and a fighting game in which a player fights in a professional wrestling, a boxing, a sumo wrestling, a judo, a kendo (Japanese fencing), and other martial arts using swords or spears.

In these days, people especially enjoy a strategic simulation game among the provided video games.

In the strategic simulation game, a player operates a leader of a group such that the leader may direct an unit that belongs to the group and experiences a fictional strategy and combat in a virtual environment or space being deployed on a screen such as a television screen.

Among such strategic simulation games, Nobunaga's ambition type of game, for example, is popular. In the game, a player controls, in the Japanese Warring State Period, a character of Oda Nobunaga (a leader of a group) who governs the Owarino-kuni (Owari region), organizes military commanders (a head of the unit belonging to the group) to be his followers, develops his own military group belonging to the group by utilizing a military draft and training, fights and defeats an opponent group (opponent group) lead by another feudal lord such that he may broaden his own territory and finally unify the country.

As shown above, the player in the strategic simulation game can fight against the opponent by ordering the unit belonging to the group as the leader of the group with various strategies. The player can have various experiences as the leader of the group and commanders of the units such that the player enjoy easily virtual strategies and fights

Generally, the strategic simulation game requires several or several tens of hours in order to accomplish the final purpose. Many players devote themselves in the game for a long period of time enjoying virtual strategies and fights. In this respect, the strategic simulation game is significantly different from that in another category that may include a action game, a shooting game, and a puzzle game.

On the other hand, arcade games are often elaborated, for instance, a music game to actually dance or play instruments to the rhythm, an airplane simulation game utilizing a mock pilot's seat of the plane cockpit, and so on. A medal game, however, is still popular among the arcade games although it is spread widely.

In the medal game, a player purchases one or more medals from a medal inscription machine such that the player starts the medal game with the medal gaming machine by inserting the medal. If the player wins the game, a predetermined number of medals are paid out. So, the player who has obtained many medals can enjoy the game again without purchasing a new medal.

In such typical medal games as a roulette, a card game, a horse racing game, etc., the way to use the medal is quite simple. Therefore, it is not easy to give the player a novel feeling or surprise so that it may be difficult to obtain more and more players to make the medal game so popular as to make a boom.

Therefore, a new kind of medal gaming machine such as a simulation game has emerged. By way of example, a horse racing game having a training mode and a racing mode may be played by a plurality of players at the same time.

In such horse racing game, the plurality of players can raise and train horses virtually in the training mode if they insert medals. In the racing mode, the players can select jockeys so as to start the race by inserting medals. The player can make their virtual horses enter the race and purchase betting tickets by inserting medals so that they may receive a predetermined number of medals according to the race result.

However, the above-mentioned horse racing game may offer medals according to the race result and the payout is not necessarily closely related with the game procedure. In this respect, there is not a large difference between the conventional medal gaming machine and the horse racing medal gaming machine. Therefore, it may not be easy for the horse racing medal gaming machine to obtain more and more new players as the medal gaming machine has a unique concept.

Therefore, it is considered that it is possible to provide a medal gaming machine combining an unprecedented amusement with the interest of a game itself by giving a new value of a game to a medal itself used for a medal gaming machine. However, how to provide the medal itself with a new value in the game is a difficulty.

### SUMMARY OF THE INVENTION

Considering the above, it is an object to provide a medal gaming machine with a lot of amusing features unlike the conventional gaming machine and enhance amusement as well as excitement of the medal game by giving medals various values.

To achieve the above object, according to the present invention, it is provided that a medal with a built-in IC chip comprises a storage section for storing initial data of the game and history data of the game supplied from the medal gaming machine.

More specifically, according to the present invention, it is provided that an medal with a built-in IC chip used for a medal gaming machine comprises a storage section for storing initial data and historical data of the game supplied from the medal gaming machine.

(1) A medal used for a gaming machine, comprises an external body of a substantially thin disk shape which constitutes a medal external body; an IC chip built-in said external body, wherein the IC chip comprises a storage section which is capable of storing initial data of a game and history data of the game supplied by the gaming machine; and an interface section for transmitting the initial and/or history data between the gaming machine and the storage section.

As mentioned above, since it is possible to read and/or write initial and history data of the game on a medal with a built-in IC chip, various data (for example, data of a character appearing on the game or items owned by the character, etc) can be stored in a medal with a built-in IC chip (“built-in-IC-chip medal”, hereinafter). The data may be stored in a plurality of built-in-IC-chip medals. Thus, the built-in-IC-chip medal can have various values in the game.

For example, when data of a military commander (e.g., Oda Nobunaga or Takeda Shingen) who appears on a strategic simulation game setup in the warring state period is stored on a built-in-IC-chip medal, the built-in-IC-chip medal has a different value depending on whose data is stored even if the appearance of the built-in-IC-chip medal is exactly the same.

Therefore, the player can play the strategic simulation game with the built-in-IC-chip medal having the data of Oda Nobunaga or Takeda Shingen at the player's discretion if the player has collected both medals. Further, since either medal has a different value to the player, the player can have a special affinity to either because of the stored data.

Thus, the player may have a desire to collect medals with various data such that the player may be motivated to devote himself to the game. The player can have a special affinity to each medal and the medal gaming machine may enhance amusing features and novel excitements of the game

According to the invention, it is possible to provide a medal with a new unprecedented value, invoke the player's want for collecting medals, and make the player have a feeling toward a medal (medal with the a built-in IC chip). Therefore, by applying the medal to the medal gaming machine, it is possible to make the player have a great enthusiasm toward the game and realize the medal gaming machine give the player much fun.

(2) The medal according to (1) comprises a distinction section being mounted on the external body such that the medal can be distinguished by the distinction section.

(3) The medal according to (2) is characterized in that the distinction section comprises a figure of a three-dimensional shape, which includes a planner shape.

(4) The medal according to (2) is characterized in that the distinction section has an appearance in association with a game character in a game played with the medal gaming machine.

According to the invention, it is possible to enhance the affection of the player to the medal (the medal with built-in IC chip) and further increase the player's want for collecting the medal by making the image of the three-dimensional shape similar to an image of a character appearing on the game. Therefore, it is possible to make the player have a great enthusiasm for the game.

(5) The medal according to (1) is characterized in that the IC chip comprises at least one pin being connected from the storage section and being exposed from an opening disposed on one side of the medal such that a contact of a connector of the gaming machine passes through the opening. The pin may conduct signal or encoded information to the outside of the storage section. The pin may have a direct or indirect contact with a contact of a reading/writing device of the gaming machine or of a medal inscription machine.

(6) The medal according to (5) comprises at least one notch portion on a periphery of the external body.

(7) The medal according to (6) is characterized in that the medal may be set in a right rotational position by the notch portion to start a game. The notch portion may make the disk shape asymmetrical such that the medal may be placed on a medal receiving part of the gaming machine or the medal inscription machine with a fixed rotational direction by having the notch portion engage with a convex portion of the receiving part.

(8) The medal according to (1) is characterized in that a strategic simulation game is played with the gaming machine by utilizing the medal. In other words, the above-mentioned medal with a built-in IC chip is characterized in that the medal gaming machine provide a strategic simulation game.

Among the entire characters appearing on the strategic simulation game, many characters which can be operated by the player are included in the game if compared to another kind of game. Each medal with a built-in IC chip can store different data and it is possible to make various built-in IC chip medals with various values.

Therefore, the player can collect various built-in IC chip medals having different values and play the game by using the various built-in-IC-chip medals. As a result, it is possible to remarkably enhance the player's want for collecting medals (medals with built-in IC chips) and give the player much fun.

According to the present invention, a built-in-IC-chip-medal inscription machine has data writing means for writing initial data of the game on the built-in-IC-chip medal.

(9) Thus, a medal inscription machine for issuing a medal used for a gaming machine comprises a main body; a medal or coin inlet on the main body; a control section on the main body for a purchaser to control the machine with; a built-in-IC-chip-medal pay outlet on the main body; and a data writing device for writing an initial data of a game. The built-in-IC-chip medal may be issued by the medal inscription machine, which pay out one or more built-in-IC-chip medals from the built-in-IC-chip-medal pay outlet according to the purchaser's operation with the control section.

The built-in-IC-chip-medal inscription machine denotes an apparatus for issuing the above-described built-in-IC-chip medal. The machine issues as many medals as determined by the number of inserted medals for the purchase.

According to the present invention, it is possible to issue the built-in-IC-chip medal with the initial data of the game. Therefore, it is possible to issue built-in-IC-chip medals in which different data are stored every time of issuing built-in-IC-chip medals. As a result, various built-in-IC-chip medals having various values can be issued. Thus, the player may be strongly impressed that the built-in-IC-chip medal (medal with a built-in IC chip) has a new value to the player. For example, when data of characters appearing on the game is stored in the built-in-IC-chip medal at the medal issuance, it is possible to make the player feel remarkably for the medal (medal with the a built-in IC chip).

(10) The medal inscription machine according to (9) is characterized in that the medal comprises: an external body of a substantially thin disk shape which constitutes a medal external body; an IC chip built-in the external body, wherein the IC chip comprises a storage section which is capable of storing an initial data of a game and a history data of the game played with the gaming machine; and an interface section for transmitting the initial and/or history data between the gaming machine and the storage section.

(11) A medal system used for a game comprises: a first kind of medal which has a value for the game; and a second kind of medal which has a built-in IC chips comprising a storage section for storing a status data of the game; wherein the first and second kinds of medals are separated and different at least in possessed information thereof; and wherein the first and second kinds of medals are used at the same time to play the game.

(12) The medal system according to (11) comprises: a medal inscription machine which may issue as many medals as a purchaser requests, wherein the medal inscription machine comprises: a main body; a medal or coin inlet on the main body; a control section on the main body for a purchaser to control the machine with; a built-in IC chip medal pay outlet on the main body; and a data writing device for writing an initial data of a game; and a gaming machine which requires at least one of the first and second kinds of medals, the game being played with the gaming machine such that the at least one of the first and second kinds of medals is disposed on the gaming machine so as that information from the at least one of the first and second kinds of medals is directed to a control section of the gaming machine.

The data reader may read the initial gaming data or the gaming history data such that the player can start the game from the initial status or an advanced status. The combined data may enable the player to select either status as a starting status.

The medal gaming machine having the data reading/writing means for writing at least one of the initial and history data of the game reading at least one of the initial and history data of the game comprises a payout means for paying out the built-in-IC-chip medal when a predetermined condition is satisfied during the game.

Since the player can receive medal payouts when the predetermined condition is satisfied during the game process, the player's desire for collection of medals is invoked and he may devote himself to the game more. Further, the player can have an affinity to the medal and the medal game machine may enhance amusing features and novel excitements of the game.

The medal gaming machine having the data reading/writing means for writing at least one of the initial and history data of the game reading at least one of the initial and history data of the game may provide a strategic simulation game.

In general, the strategic simulation game has a larger number of characters that appear on a game and can be operated by the player than a game in another category. The player can collect many built-in-IC-chip medals with different values so as to play the game using many medals if data of many characters are stored on as many medals. As the result, the desire for collection of the built-in-IC-chip medals is enhanced significantly so that the medal game machine enhances amusement of the game.

[Definition of Terms]

The medal gaming machine refers to a gaming machine which can receive a medal at an inlet, an insertion slot, an opening, a recess, and so on. The medal gaming machine may have a medal pay outlet to pay out medals. The player may insert a medal into the above-mentioned medal inlet to play the game. The medal may be paid out from the above-mentioned medal pay outlet according to the player's input operation. The player can insert one or more medals while the game is being played. The above-mentioned medal gaming machine may offer one or more games to one or more players. The medal gaming machine also may comprise a plurality of satellites as many players who play games at the same time.

The satellite used herein is a device comprising a control section composed of one or more control buttons or knobs with which the player inputs predetermined instructions and/or commands, and an image display device to display images related to the game. The control section may include an input part with which the player plays the game. The player operates the above-mentioned control section with viewing images displayed on the above-mentioned image display device such that the game deployed with the medal gaming machine proceeds.

In the medal gaming machine according to the present invention, the number of satellite is not limited. It can be set one or more depending on the size of the medal gaming machine, the nature of the game, and so on.

The medal denotes a substance for playing the game on the medal gaming machine. The medal may be inserted or injected into the above-mentioned medal gaming machine or a part thereof. In general, it may work like a coin. The above-mentioned medal may be different from a currency circulating in an actual society. The above-mentioned medal may be, for example, purchased from a medal inscription machine installed in a game hall. The medal obtained by a game result generally may not be exchanged with money or goods.

The number of medals inserted into the medal gaming machine according to the present invention, for example, may be stored on a storage media (for example a RAM, a flash memory, etc) built in the medal gaming machine or the medal with a built-in IC chip placed or set at a predetermined position of the medal gaming machine as game points. On the other hand, when the player operates the control section or the input part so that a predetermined instruction is input by the player, medals are paid out in the number corresponding to the number of stored points.

The point used herein refers to information of the game to be played with the medal gaming machine or information equivalent to the number of medals. For example, if the game can be started by inserting ten medals into the medal gaming machine according to the present invention, the game can be also started by inputting ten points instead ten medals.

The medal with a built-in IC chip refers to a medal having an IC chip and being used in the above-mentioned medal gaming machine or a medal having a storage section that can store initial and history data of the game supplied by the above-mentioned medal gaming machine.

In the medal gaming machine according to the present invention, the player can use one or more built-in-IC-chip medals to play the game.

The above-mentioned storage section may be composed of, for example, an EPROM (Erasable Programmable ROM), an OTPROM (Optical Programmable ROM), an EEPROM (Electrically Erasable Programmable ROM), a flash memory (flash type EEPROM), and so on. It may be composed of an integrated circuit other than this kind of memory, for example, micro processor, etc.

The initial data and the history data of the game are stored in the storage section provided in the built-in IC chip medal In the present specification, the data is stored in the storage section of the built-in IC chip medal when the data is stored in the medal with built-in IC chip unless it is specified otherwise.

A shape of the above-mentioned built-in-IC-chip medal is not limited. But it is preferably disk-shaped like an ordinary medal so that the built-in-IC-chip medal is recognized without a strange feeling. It is desirable that the size and thickness of the above-mentioned medal are substantially the same as the ordinary medal.

The above-mentioned medal may be made of an ordinal material such as resin. The medal may be made of metal if the IC chip or pins thereof are coated with resin or the like so that insulation of the embedded IC chip and pins thereof to each other is secured.

The Initial data of the game refers to data required for starting the game with the above-mentioned medal gaming machine. For example, it may include an ID code and a check code to identify the player, personal information of the player, data about the above-mentioned points, data about the initial setting on starting the game, etc.

The history data of the game refers to data about the game in progress with the above-mentioned medal gaming machine. The history data of the game may include an ID code and a check code to identify the player, personal information of the player, data about the above-mentioned points. The game stopping data (or game stop data) used herein is included in the above-mentioned history data of the game. It is the history data when the game in progress with the above-mentioned medal gaming machine is stopped.

The above-mentioned built-in-IC-chip medal is preferably configured integrally with an image of a three-dimensional shape.

Because of this, if the image of the three-dimensional shape (referred to as “figure” hereinafter) is made into an image simulating an appearance of a character that appears on the game, the player's desire for collecting the medals (medals with built-in IC chips) is invoked and the player can have a feeling toward the medals (medals with built-in IC chips). Further, he may devote himself to the game. However, it is not necessary that the built-in-IC-chip medal configured integrally with the figure is formed so that the medal portion can not be removed from the above-mentioned figure. It may be configured in such a manner that it can be removed from the above-mentioned figure. The built-in-IC-chip medal integrally configured with the figure will be explained in detail referring to the drawings later.

The above-mentioned medal may be issued or inscribed by a inscription machine (referring to a built-in IC chip medal inscription machine hereinafter), which may be installed in the game hall.

The built-in-IC-chip-medal inscription machine used herein is a device to issue or inscribe built-in-IC-chip medals used with the above-mentioned medal gaming machine. It issues built-in-IC-chip medals in the number corresponding to the predetermined number of inserted medals.

The built-in-IC-chip-medal inscription machine mentioned above preferably has a data writing means for writing the initial data of the game.

It can issue built-in-IC-chip medals with the initial data of the game stored at each built-in IC chip. So, it is possible to issue a built-in-IC-chip medal with different data at every time when a built-in-IC-chip medal is issued so as to have a different value. The built-in-IC-chip-medal inscription machine will be explained in detail later referring to the drawings.

In the medal gaming machine according to the present invention, the built-in-IC-chip medal mentioned above may be used instead the ordinary medal, which does not have the IC chip. However, the built-in-IC-chip medal mentioned above may preferably be used with the ordinary medal.

By allowing the built-in-IC-chip medal to store a character appearing on the game and by using the ordinary medal which has been used conventionally, different kinds of medals with different values may be utilized at the same time. For example, it is possible to pay out different medals such as the ordinary medal and the built-in-IC-chip medal depending on the status of the game so as to provide the game with an enhanced excitement.

The medal gaming machine according to the present invention may preferably pay out the built-in-IC-chip medals if the predetermined condition is satisfied during the game.

The player can obtain payout of built-in-IC-chip medals when the predetermined condition is satisfied while the game is proceeding so that the player's desire for collecting built-in-IC-chip medals is invoked and he can devote himself to the game more. The predetermined condition may not particularly be limited. It may include, for example, a condition that the player wins in a fight with another group.

The simulation game may refer to one game category and be defined with a common concept in the art. For instance, the simulation game may be a game in which the player can enjoy a virtual world with a virtual environment and /or a virtual space provided.

The strategic simulation game may refer to a game, among the above-mentioned simulation games, in which the player can experience and enjoy, especially, virtual strategies and fights in the virtual environment and virtual space provided (referred to “virtual environment” hereinafter).

The medal gaming machine according to the present invention may preferably be a medal gaming machine to offer a strategic simulation game. The above-mentioned built-in-IC-chip medal according to the present invention is preferably used with the medal gaming machine to offer the strategic simulation game.

In general, the strategic simulation game has a larger number of characters which appear on the game and can be operated by the player than a game in another category. By storing data of different characters on as many built-in-IC-chip medals, the player can collect many built-in-IC-chip medals with different values and play the game with many built-in-IC-chip medals.

As the result, the desire for collection of medals (built-in-IC-chip medals) is enhanced significantly so as to provide the medal game machine with an enhanced amusement.

The group used herein is a virtual group (military group) that can be operated by the player in the virtual environment etc, provided with the above-mentioned strategic simulation game. The group is composed of a leader and a unit to be described later. For example, if the strategic simulation game adopts the Japanese territory in the Warring State Period as a virtual environment, the above-mentioned group may include a military group led by Oda Nobunaga, or Takeda Shingen, or the like.

If the strategic simulation game adopts a modern war as a virtual environment, the above-mentioned group may include a military force such as a tank, a battleship, and a battle plane.

The unit refers to a unit to constitute the above-mentioned group. The above-mentioned group is composed of one or more units.

For example, if above-mentioned group is an army group (or military group) led by Oda Nobunaga, the group is composed of an army unit led by Hashiba Hideyoshi and Hashiba Hideyoshi himself. If the above-mentioned group is a military force including tanks, battleships and battle planes, the unit configuring the group includes tanks, battleships and battle planes.

The leader refers to a head of the unit among the above-mentioned units. For example, if the above-mentioned group is an army group led by Oda Nobunaga, the leader is Oda Nobunaga himself.

The above-mentioned group, unit, and leader may have ability values in various manners, respectively. The ability values vary depending on conditions of the strategic simulation game in progress. Data about the group, unit, and leader may include data about these ability values. Data about the group, unit, and leader are stored in the built-in-IC-chip medal as the initial or the history data of the game.

One built-in-IC-chip medal may store data about the entire group, or data about one or more units belonging to the group.

However, one built-in-IC-chip medal preferably stores data about one unit belonging to one group.

In the following explanations, “starting a game” means to start a game using the above-mentioned initial data of the game includes joining the game in progress using the above-mentioned initial data of the game.

On the other hand, “joining a game” means joining a game using above-mentioned history data of the game.

“Stopping a game” means exiting a game temporarily after starting or joining the game. When a plurality of players are playing a game at the same time, a game played by a player may be suspended temporarily if the player stops the game. The other players, however, can play the game without interruption.

“Resuming a game” means resuming a game after the game being stopped once. So, unlike the case of joining the game, the player can resume the game only when the game he played is still in progress.

Other features and advantages of invention will be explained in detail in the following description referring to the drawings.

### BRIEF DESCRIPTION OF THE DRAWINGS

FIG. 1 is a schematic perspective view of a medal game machine according to an embodiment of the present invention.

FIG. 2A is a schematic plan view of a built-in-IC-chip medal according to an embodiment of the present invention.

FIG. 2B is a cross-sectional view along A-A line in FIG. 2A.

FIG. 3A is a schematic front view of a built-in-IC-chip medal integrally configured with an image having a three-dimensional shape according to an embodiment of the present invention.

FIG. 3B is a schematic perspective view of a built-in-IC-chip medal shown in FIG. 3A. The medal is set on a built-in-IC-chip medal setting table installed on a medal gaming machine according to the present invention.

FIG. 4A is a block diagram to show an internal structure of a medal gaming machine shown in FIG. 1.

FIG. 4B is a block diagram showing an internal structure of a satellite constituting a medal gaming machine.

FIG. 5 is a schematic perspective view of a built-in-IC-chip-medal inscription machine according to an embodiment of the present invention.

FIG. 6 is a block diagram showing an internal structure of a built-in-IC-chip-medal inscription machine shown in FIG. 5.

FIG. 7 is a flow chart showing a sub-routine executed to issue built-in-IC-chip medals with a built-in-IC-chip-medal inscription machine.

FIG. 8A is a schematic diagram showing an example of an image displayed on a screen of an image display device installed in a built-in-IC-chip-medal inscription machine.

FIG. 8B is a schematic diagram showing an example of an image displayed on a screen of an image display device installed in a built-in-IC-chip-medal inscription machine.

FIG. 8C is a schematic diagram showing an example of an image displayed on a screen of an image display device installed in a built-in-IC-chip-medal inscription machine.

FIG. 9A is a flowchart showing a sub-routine executed when starting a new strategic simulation game.

FIG. 9B is a flow chart following than in FIG. 9A.

FIG. 10A is a schematic diagram showing an example of an image displayed on a screen of an image display device installed on a satellite of a medal gaming machine.

FIG. 10B is a schematic diagram showing an example of an image displayed on a screen of an image display device installed on a satellite of a medal gaming machine.

FIG. 10C is a schematic diagram showing an example of an image displayed on a screen of an image display device installed on a satellite of a medal gaming machine.

FIG. 11 is a flowchart showing a sub-routine executed when a strategic simulation game is in progress.

FIG. 12A is a schematic diagram showing an example of an image displayed on a screen of an image display device installed on a satellite of a medal gaming machine.

FIG. 12B is a schematic diagram showing an example of an image displayed on a screen of an image display device installed on a satellite of a medal gaming machine.

FIG. 12C is a schematic diagram showing an example of an image displayed on a screen of an image display device installed on a satellite of a medal gaming machine.

FIG. 13A is a schematic diagram showing an example of an image displayed on a screen of an image display device installed on a satellite of a medal game machine.

FIG. 13B is a schematic diagram showing an example of an image displayed on a screen of an image display device installed on a satellite of a medal game machine.

FIG. 14A is a flowchart showing a sub-routine executed when starting a fight between a group and another group in a strategic simulation game.

FIG. 14B is a flow chart following that in FIG. 14A.

FIG. 15A is a schematic diagram showing an example of an image displayed on a screen of an image display device installed on a satellite of a medal game machine.

FIG. 15B is a schematic diagram showing an example of an image displayed on a screen of an image display device installed on a satellite of a medal game machine.

FIG. 15C is a schematic diagram showing an example of an image displayed on a screen of an image display device installed on a satellite of a medal game machine.

FIG. 16A is a schematic diagram showing an example of an image displayed on a screen of an image display device installed on a satellite of a medal game machine.

FIG. 16B is a schematic diagram showing an example of an image displayed on a screen of an image display device installed on a satellite of a medal game machine.

FIG. 16C is a schematic diagram showing an example of an image displayed on a screen of an image display device installed on a satellite of a medal game machine.

FIG. 17A is a flowchart showing a sub-routine executed when executing a fight between a group and another group in a strategic simulation game in a medal game machine.

FIG. 17B is a flow chart following that in FIG. 17A.

FIG. 18A is a schematic diagram showing an example of an image displayed on a screen of an image display device installed on a satellite of a medal game machine.

FIG. 18B is a schematic diagram showing an example of an image displayed on a screen of an image display device installed on a satellite of a medal game machine.

FIG. 18C is a schematic diagram showing an example of an image displayed on a screen of an image display device installed on a satellite of a medal game machine.

FIG. 19 is a flowchart showing a sub-routine executed when a strategic simulation game is in progress.

FIG. 20A is a schematic diagram showing an example of an image displayed on a screen of an image display device installed on a satellite of a medal game machine.

FIG. 20B is a schematic diagram showing an example of an image displayed on a screen of an image display device installed on a satellite of a medal game machine.

FIG. 20C is a schematic diagram showing an example of an image displayed on a screen of an image display device installed on a satellite of a medal game machine.

FIG. 21A is a flowchart showing a sub-routine executed when a strategic simulation game in a medal game machine is in progress.

FIG. 21B is a flow chart following that in FIG. 21A.

FIG. 22A is a schematic diagram showing an example of an image displayed on a screen of an image display device installed on a satellite of a medal game machine.

FIG. 22B is a schematic diagram showing an example of an image displayed on a screen of an image display device installed on a satellite of a medal game machine.

FIG. 22C is a schematic diagram showing an example of an image displayed on a screen of an image display device installed on a satellite of a medal game machine.

FIG. 23 is a flowchart showing a sub-routine executed when a strategic simulation game is in progress in a medal game machine;

FIG. 24A is a flowchart showing a sub-routine executed when a strategic simulation game is in progress in a medal game machine.

FIG. 24B is a flow chart following that in FIG. 24A.

FIG. 25 is a flowchart showing a sub-routine executed when resuming a strategic simulation game in a medal game machine.

FIG. 26A is a schematic diagram showing an example of an image displayed on a screen of an image display device installed on a satellite of a medal game machine.

FIG. 26B is a schematic diagram showing an example of an image displayed on a screen of an image display device installed on a satellite of a medal game machine.

FIG. 26C is a schematic diagram-showing an example of an image displayed on a screen of an image display device installed on a satellite of a medal game machine.

FIG. 27 is a flowchart showing a sub-routine executed for allowing a new group to join a strategic simulation game in progress.

FIG. 28A is a schematic diagram showing an example of an image displayed on a screen of an image display device installed on a satellite of a medal game machine.

FIG. 28B is a schematic diagram showing an example of an image displayed on a screen of an image display device installed on a satellite of a medal game machine.

FIG. 28C is a schematic diagram showing an example of an image displayed on a screen of an image display device installed on a satellite of a medal game machine.

FIG. 29 is a sub-routine showing a flow chart executed in a medal game machine.

FIG. 30 is a sub-routine showing a flow chart executed in a medal game machine.

FIG. 31A is a schematic diagram showing an example of an image displayed on a screen of an image display device installed on a satellite of a medal game machine.

FIG. 31B is a schematic diagram showing an example of an image displayed on a screen of an image display device installed on a satellite of a medal game machine.

### DETAILED DESCRIPTION OF PREFERRED EMBODIMENT

Embodiments according to the present invention will now be explained referring to the drawings.

A medal gaming machine to offer a strategic simulation game in which a player can enjoy virtual fights and strategies in the warring state period of Japan as a virtual environment, a medal with a built-in IC chip (refering to “built-in-IC-chip medal,” hereinafter) used in the above medal gaming machine, and a built-in-IC-chip medal inscription machine for issuing the medal with built-in IC chip will now be explained. The built-in-IC-chip medal stores data about one leader or unit constituting a group.

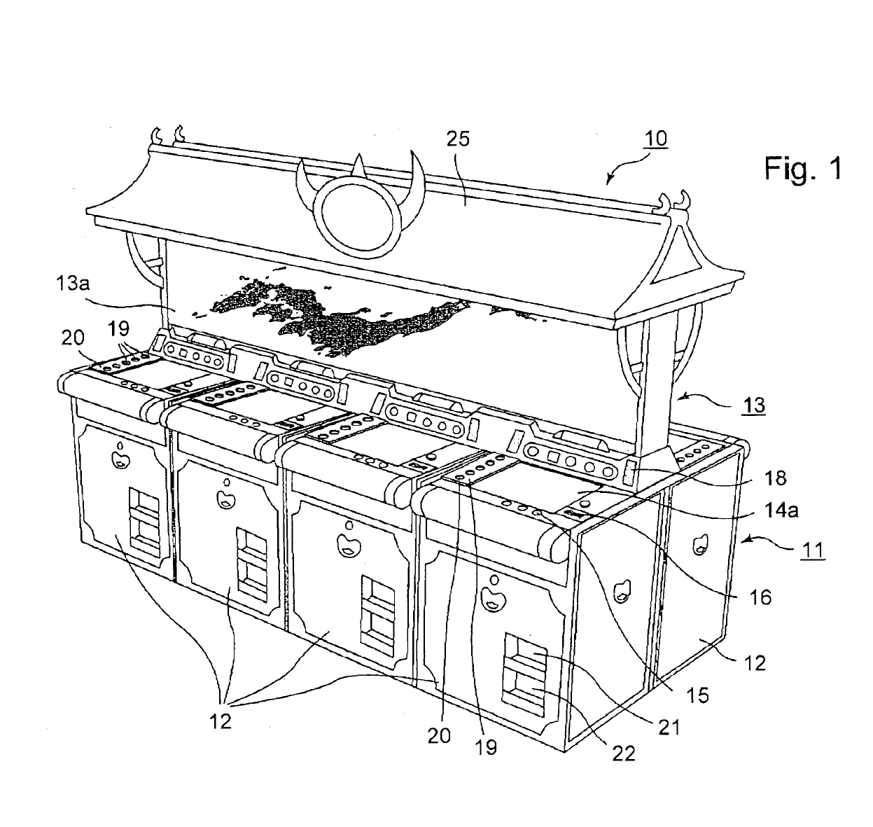

FIG. 1 is a perspective view schematically showing an embodiment of a medal gaming machine according to the present invention.

The medal game machine 10, as shown in FIG. 1, comprises a main body device 11 composed of a satellite 12 comprising eight units including four units on the front side and eight units on the back side. Up to eight players can enjoy the strategic simulation game at the same time by the medal gaming machine 10.

On the top surface the main body device 11, between four units of the satellite 12 and four units of the satellite 12, there suspended a large display device 13 having a screen 13a on the front side and the back side respectively.

The screen 13a of the large display device 13 displays large images of a game and people other than players who play the strategic simulation game by the satellites 12 can watch the strategic simulation game played on the medal gaming machine 10. A roof 25 simulating a part of a castle in the warring state period is installed on the upper side of the large display device 13.

An image display device 14 (not shown) is installed on each satellite 12 constituting a main body device 11. A screen 14a of the image display device 14 is exposed on the center of top surface of the satellite 12. The screen 14a displays images related to a game in progress. Screens 14a of the image display device 14 installed on each satellite 12 do not always display the same images. They sometimes display different images depending on progresses.

A control section 15 constituted of multiple control buttons on the front side of the screen 14a of the satellite 12. A player can proceed a game by operating multiple control buttons (the control section 15) as watching images displayed on the screen 14a.

A medal inlet 16 is installed on the right side of the screen 14a. A medal sensor 120 (not shown) is installed inside the medal inlet 16. Medals injected to the medal inlet 16 are detected by the medal sensor 120.

A medal with built-in IC chip installation unit 20 having five depressed portion 19 to which the built-in-IC-chip medal is inserted is installed on the left side of the screen 14a. A connector 19a (not shown) is installed at the bottom of the depressed portion 19. The connector 19a is connected to information reading/writing device 112 installed inside the satellite 12. The information reading/writing device 112 can write at least one of initial data of the game and history data of the game onto the medal with the built-in IC chip installed to the depressed portion 19 via the connector 19a and read at least one of initial data of the game and history data of the game from the medal with the built-in IC chip (built-in-IC-chip medal).

So, each player can play the strategic simulation game by using up to five built-in-IC-chip medals at the same time.

A speaker 18 is installed on the backside of the screen 14a. Background music (referred to as “BGM” hereinafter), sound and sound effect, etc, are output corresponding to the progress of the strategic simulation game.

A medal pay outlet 21 and a built-in-IC-chip-medal pay outlet 22 are installed at the front side of the satellite 12.

A hopper 121 and a medal detection part 122 (not shown) are installed inside the satellite 12 equipped with the medal pay outlet 21.

When an instruction to pay out medals via the control section 15 is input, medals are paid out from the hopper 121. Paid out medals are detected by the medal detection part 122. After that, when the medal detection part 122 detected a predetermined number of medals, payout of medals from the hopper 121 are completed.

The built-in-IC-chip-medal pay outlet 22 is an opening to pay out built-in-IC-chip medals. An information writing device 113 (not shown) that writes data onto the built-in-IC-chip medal and a built-in-IC-chip-medal payout device 114 to pay out medals with built-in IC chips with data written by the information writing device 113 from the built-in-IC-chip-medal pay outlet 22 are installed inside of inside of the satellite 12 where the built-in-IC-chip-medal pay outlet 22 is provided.

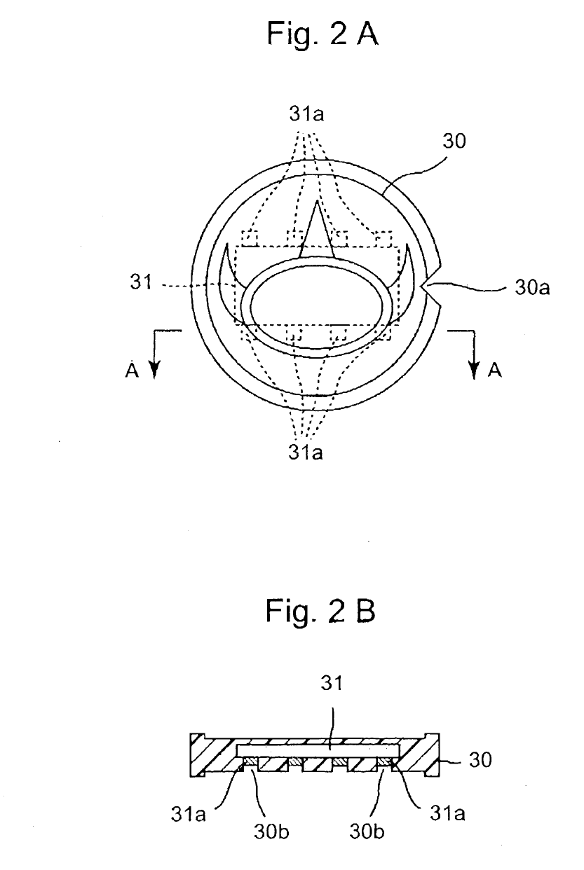

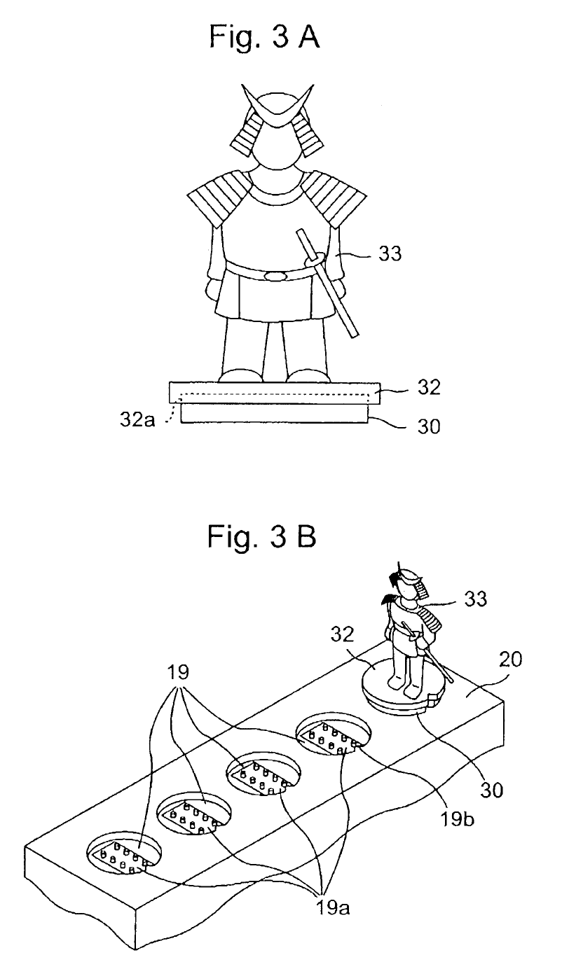

Then, the built-in-IC-chip medal used the above-mentioned medal game machine is explained referring to FIG. 2A, FIG. 2B, FIG. 3A and FIG. 3B.

FIG. 2A is a plane view schematically showing the above-mentioned built-in-IC-chip medal.

FIG. 2B is a cross section diagram of A-A line.

As shown FIG. 2A, a medal with a built-in IC chip (built-in-IC-chip medal) 30 has a substantial circular disc shape. There is a decoration (so-called relief) of an armor of warring state period on the obverse side surface of the built-in-IC-chip medal 30. There is a notch 30a for positioning at a part of rim part of the built-in-IC-chip medal 30.

An IC chip 31 with eight pins 31a is embedded inside of the built-in-IC-chip medal 30. The IC chip 31 comprises a storage section (not shown) to store initial data of the game and history data of the game supplied from the medal gaming machine 10.

As shown in FIG. 2B, eight openings 30b are installed on the backside of the built-in-IC-chip medal 30. Eight pins 31a of the IC chip 31 are exposed in the opening 30b.

By inserting the built-in-IC-chip medal 30 into the depressed portion 19 of the built-in-IC-chip medal installation unit 20, the connector 19a installed at the bottom of the depressed portion 19 and the pin 31a of the IC chip 31 embedded in the built-in-IC-chip medal 30 contact to each other.

As the results, the information reading/writing device 112 installed inside of the satellite 12 of the medal gaming machine 10, via the connector 19a, can write at least one of initial data of the game and history data of the game onto the built-in-IC-chip medal 30 and read at least one of initial data and history data of the game out the built-in-IC-chip medal 30.

FIG. 3A is a front view schematically showing a built-in-IC-chip medal according to the present invention integrally configured with an image having a three-dimensional shape;

FIG. 3B is a schematic perspective view of a built-in-IC-chip medal shown in FIG. 3A being set on a built-in-IC-chip medal installation unit installed on a medal gaming machine according to the present invention.

As shown FIG. 3A, in the built-in-IC-chip medal 30, a part including the obverse side of surface is inserted and fixed into a depressed portion 32a formed at the bottom of a mount part 32 of a circular disc shape. A resins FIG. 33 mocking an appearance of a military commander of in the warring state period is fixed. The built-in-IC-chip medal 30 is integrally configured with the FIG. 33.

In addition, the FIG. 33 is mocking an appearance of a character (unit) appearing in a strategic simulation game offered in the medal gaming machine 10.

As shown in FIG. 3B, five depressed portions 19 having substantially circular shape are installed in the built-in-IC-chip medal installation unit 20 installed in the medal gaming machine 10. As mentioned above, the connector 19a is connected to the information reading/writing device 112 installed inside the satellite 12.

There is the notch 30a for positioning at a part of rim part of the built-in-IC-chip medal 30. By installing the built-in-IC-chip medal 30 onto the depressed portion 19 so that a projection 19b is engaged with the notch 30a formed on the built-in-IC-chip medal 30, eight metal terminals equipped on the connector 19a are inserted into the eight openings 30b installed at the bottom of the built-in-IC-chip medal 30.

As the results, the pin 31a of the IC chip 31 exposed in the openings 30b and the metal terminal are contacted to each other, the information reading/writing device 112 installed inside of the satellite 12 of the medal gaming machine 10, via the connector 19a, can write at least one of initial data of the game and history data of the game onto the built-in-IC-chip medal 30 and read at least one of initial data of the game and history data of the game out the built-in-IC-chip medal 30. In addition, a medal with a built-in IC chip according to the present invention is not necessarily composed integrally with a figure having a three-dimensional shape.

Next, an internal structure of the medal gaming machine according to the present invention will now be explained.

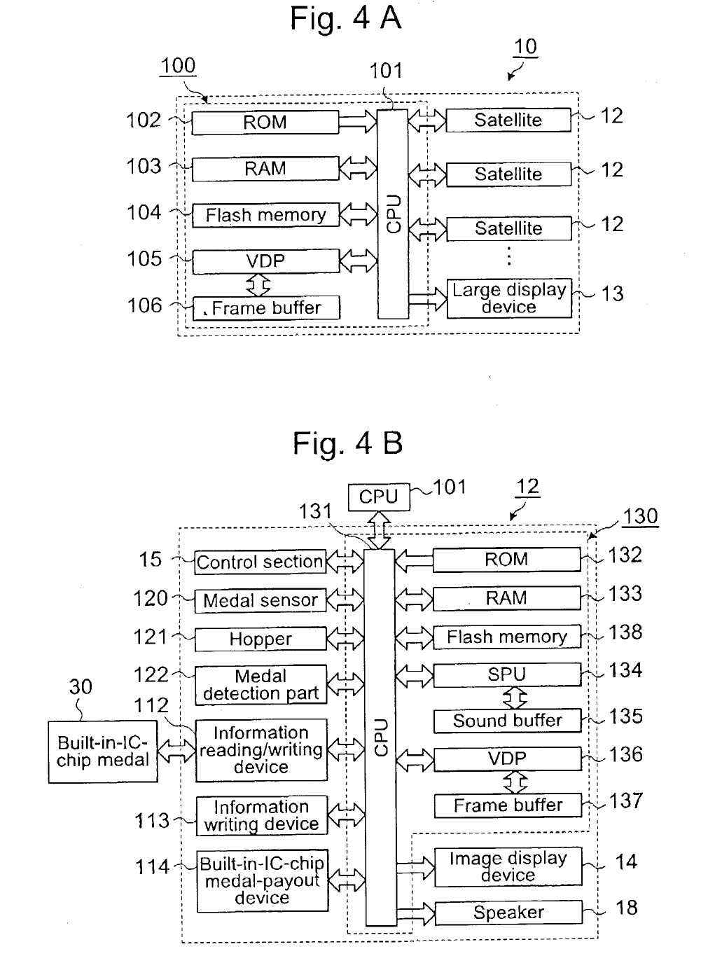

FIG. 4A is a block diagram to show an internal structure of the medal gaming machine 10 shown in FIG. 1 and FIG. 4B is a block diagram showing an internal structure of the satellite 12 constituting the medal gaming machine 10.

As shown in FIG. 4A, the medal gaming machine 10 is composed of a CPU (Central Processing Unit) 101, a ROM (Read Only Memory) 102, a RAM (Random Access Memory) 103 and a main control unit 100 including a flash memory 104 and, eight units of the satellite 12 and, the large display device 13. Some of eight units are not shown.

The CPU 101 performs each processing based on input signals supplied from the satellite 12, data or program stored on the ROM 102, the RAM 103, and the flash memory 104.

Based on the results, it transmits instruction signals to the satellite 12, primarily controls each satellite 12 and proceeds the strategic simulation game.

The CPU 101 comprises a DSP (Digital Signal Processor), and is configured in such a manner that it can execute each processing based on input signals supplied from the satellite 12, data or program stored on the ROM 102, the RAM 103 and the flash memory 104 at a high speed.

The ROM 102 is, for example, configured by a semiconductor memory etc, stores a program to realize a basic function of the medal gaming machine, a program to proceed the strategic simulation game, a program to primarily control each satellite 12 and stores various types of images data to be displayed on the screen 13a of the large display device 13 and data about ability values of a unit constituting a group.

The RAM 103 temporarily stores initial data of the game and history data of the game supplied from each satellite 12 and data about results of processing executed by the CPU 101. Above-mentioned initial data of the game and history data of the game include data about groups and a leader and units constituting a group. The flash memory 104 stores data about players who play a game at each satellite 12 (for example, game stopping data etc,). The flash memory 104 may store data stored by the RAM 103. The RAM 103 may store data stored by the flash memory 104. The flash memory 104 is not necessarily installed in the medal gaming machine 10.

The VDP (Video Digital Processor) 105 and a frame buffer 106 are connected to the CPU 101. Further, the large display device 13 is connected to the main control unit 100 (CPU 101).

The VDP 105 reads out required images data from the ROM 102 according to the draw instructions from the CPU 101 and generates composite image data in the frame buffer 106 based on images data. A 3D graphic accelerator may be built in the VDP 105. It is possible to perform processing to generate composite image data with the 3D graphic accelerator at a high speed.

The frame buffer 106 is a memory in which composite image data is generated by the VDP 105. The above-mentioned composite image data is output to the large display device 13 by the VDP 105. Generally, the frame buffer 106 is configured with a dual port RAM that can perform input of image data from the VDP 105 and output of composite image data to the large display device 13 at the same time.

The large display device 13 displays the composite image data generated by the VDP 105 at the frame buffer 106 on the screen 13a.

The large display device 13 displays the same images as displayed on the screen 14a of each satellite 12 and images different from the screen 14a.

The satellite 12 connected to CPU 101 of the main control unit 100 will now be explained.

As shown in FIG. 4B, each satellite 12 is configured of a control unit 130 and its peripherals.

The control unit 130 is composed of a CPU 131, a ROM 132, a RAM 133 and a flash memory 138, further comprising a SPU (Sound Processing Unit) 134, a sound buffer 135, a VDP 136 and a frame buffer 137.

The CPU 131 executes various types of processing based on input signals supplied from control section 15 responding to operations of players being input, data and program stored on the ROM 132, the RAM 133 and flash memory 138, transmits results to the CPU 101 of above-mentioned main control unit 100.

On the other hand, the CPU 131 receives instruction signals from the CPU 101, controls peripherals constituting the satellite 12, proceeds the strategic simulation game in the satellite 12.

The CPU 131, depending on contents of processing, executes various types of processing based on input signals supplied from the control section 15 responding to operations of players being input, data and program stored on the ROM 132, the RAM 133 and the flash memory 138, and based on the results, controls peripherals constituting the satellite 12 and proceeds the strategic simulation game in the satellite 12. A method to execute processing is selected from the two methods by processing depending on the contents of processing.

Further, the CPU 131 comprises a processor that performs computing processing such as matrix, vector etc, about generation of the image data as a coprocessor, and transmits results of computing processing to the VDP 136 to be described as a draw instruction.

The ROM 132 stores a program to realize basic functions of satellites, a program required for performing the strategic simulation game, the image data, BGM such as PCM (Pulse Code Modulation) data etc, sound and sound effects.

The RAM 133 stores, for example, initial data of the game and history data of the game read out the built-in-IC-chip medal 30, further, stores data supplied from the CPU 101 and data about processing executed by CPU 131. The flash memory 138 stores data about players who play a game at each satellite 12 (for example, game stopping data etc).

The SPU 134, for example, is a sub-processor containing the PCM sound source device etc, controlled by the CPU 131.

The CPU 131 selects and reads required sound data out sound data stored in the ROM 132 and transfer them to the sound buffer 135. The SPU 134 generates, for example, sound signals to generate BGM, sound, sound effect, etc, based on the above-mentioned sound data stored on the sound buffer 135, and transmits the sound signals to the speaker 18. As the results, a sound based on the above-mentioned sound data is output from the speaker 18.

The VDP 136 reads out required images data from the ROM 132 according to the draw instructions from the CPU 131 and generates composite image data in the frame buffer 137 based on images data. The 3D graphic accelerator may be built in the VDP 136. It is possible to perform processing to generate composite image data with the 3D graphic accelerator at a high speed.

The frame buffer 137 is a memory in which composite image data is generated by the VDP 136. The above-mentioned composite image data is output to the image display device 14 by the VDP 136. Generally, the frame buffer 137 is configured with a dual port RAM that can perform input of image data from the VDP 106 and output of composite image data to the image display device 14 at the same time.

The control section 15 to input operations by players, the medal sensor 120 to detect inlet to the medal inlet 16, the hopper 121 to pay out medals, the medal detection part 122 to detect medals paid out by the hopper are connected to the above-mentioned control unit 130 (CPU 131).

The control section 15 comprises multiple control buttons. When a predetermined instruction is input with control buttons operated by players, instruction signals corresponding to the indication are supplied to the CPU 131. The CPU 131 executes various types of processing based on input signals supplied from control section 15 responding to operations of players being input, data and program stored on the ROM 132, the RAM 133 and the flash memory 138.

When the medal sensor 120 detects medals injected to the medal inlet 16, transmits the detection signals to the CPU 131. The CPU 131, received the above-mentioned detection signals updates (increment) and stores the point number stored on the RAM 133.

For example, when 10 points as points are stored in the RAM 133, if three medals are injected to the medal inlet 16, the medal sensor 120 detects a medal three times, transmits a detection signal three times to the CPU 131. Each time CPU 131 receives the detection signal, it adds one point to the points stored in the RAM 133. As the results, 13 points are stored in the RAM 133.

The hopper 121 is driven by an instruction signal responding to an operation to pay out medals as points generated from the CPU 131 of control section 15, and performs processing to pay out medals.

The medal detection part 122, when detecting a medal paid out from the hopper 121, transmits a detection signal to the CPU 131. The CPU 131 stores the fact of receipt of a detection signal on the RAM 133 each time it receives a detection signal, if it judged the times of receipt of a detection signal reached a predetermined times, transmits an instruction signal to stop a payout of medals to the hopper 121.

The information reading/writing device 112 is connected to the above-mentioned control unit 130 (The CPU 131). The information reading/writing device 112,

Through the built-in-IC-chip medal 30 installed in the depressed portion 19 of the built-in-IC-chip-medal installation unit 20 via the connector 19a, writes at least one of initial data of the game and history data of the game onto the built-in-IC-chip medal 30 and reads at least one of initial data and history data of the game from the built-in-IC-chip medal.

In other words, the information reading/writing device 112 performs processing to recognize the built-in-IC-chip medal 30 installed in the depressed portion 19 responding to receipt of a instruction signal from CPU 131. If it recognizes the installation of the built-in-IC-chip medal 30, it reads at least one of initial data of the game and history data of the game out the built-in-IC-chip medal 30. The read data is stored in the RAM 133 or the flash memory 138 by the CPU 131.

The information reading/writing device 113 and the built-in-IC-chip-medal payout device 114 are connected to control unit 130 (CPU 131).

The information reading/writing device 113 performs processing to write data about a unit onto the built-in-IC-chip medal 30 contained in a predetermined area of the satellite 12 when receiving an instruction signal generated from the CPU 131 corresponding to predetermined conditions fulfilled during the strategic simulation game in progress.

The built-in-IC-chip medal payout device 114 performs processing to payout built-in-IC-chip medals 30 in which data about a unit is written from the built-in-IC-chip medal pay outlet 22 corresponding to an instruction signal received from the CPU 131.

Further, the image display device 14 and the speaker 18 are connected to the control unit 130 (CPU 131).

The image display device 14 displays composite image data generated on the frame buffer 137 by the VDP 136 on the screen 14a. The speaker 18 receives sound signals generated by the SPU 134 and outputs sounds based on the sound signals. The strategic simulation game proceeds by the images displayed on the screen 14a or sound output from the speaker 18.

A player can proceed a game by operating the control section 15 as watching images displayed on the screen 14a and listening to the sound output by the speaker 18.

Medals with built-in IC chips used in the above-mentioned medal gaming machine are issued by the built-in-IC-chip medal inscription machine installed in a game hall.

Then, the built-in-IC-chip medal inscription machine to issue the built-in-IC-chip medal according to the present invention will now be explained.

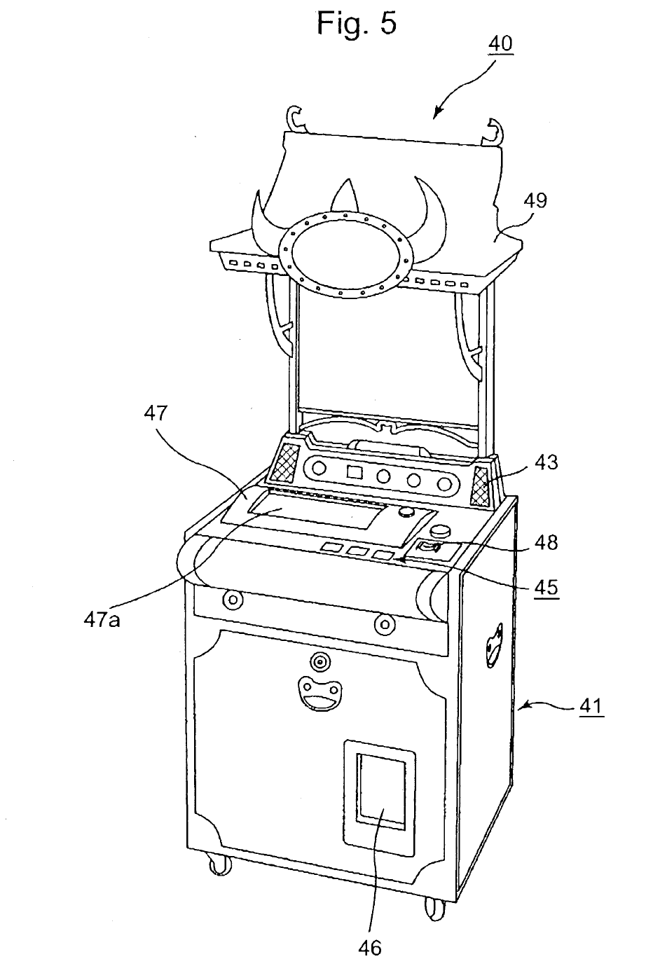

FIG. 5 is a perspective view schematically showing an embodiment of a built-in-IC-chip medal inscription machine according to the present invention.

A built-in-IC-chip medal inscription machine 40 comprises a main body device 41 composed of a control section 45 and an image display device 47, a roof 49 installed at the upper side of main body device 41.

The control section 45 composed of multiple control buttons and a medal inlet 48 are provided at the front side of the main body device 41. A player can inject medals into the medal inlet 48 and operate the control section 45 to obtain built-in-IC-chip medals 30 from the built-in-IC-chip medal inscription machine 40.

A medal sensor 320 (not shown) is installed inside of the medal inlet 48. Medals injected into the medal inlet 48 is detected by the medal sensor 320.

A built-in-IC-chip medal pay outlet 46 is installed at the front side of the main body device 41.

Built-in-IC-chip Medals with initial data of the game stored are paid out from the built-in-IC-chip medal pay outlet 46.

Though they are not shown in the drawing, multiple built-in-IC-chip medals (not shown) are contained inside of the main body device 41. Further, an information reading/writing device 312 and a built-in-IC-chip medal payout device 315 to pay out built-in-IC-chip medals in which initial data of the game are written are installed inside of the main body device 41.

The image display device 47 having a screen 47a is installed at the substantial center part of a main body device 41. For example, images to prompt an input of an instruction required for issuing built-in-IC-chip medals are displayed on the screen 47a by operating the control section 45 or injecting medals into the medal inlet 48. Two speakers 43 are installed at the back side of the screen 47a. For example, sounds to prompt an input of an instruction required for issuing built-in-IC-chip medals, BGM, sound effect are output.

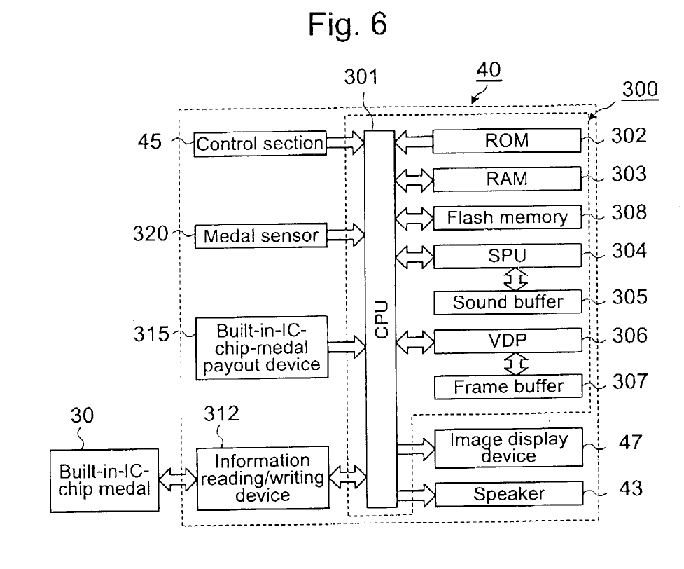

FIG. 6 is a block diagram showing an internal structure of the built-in-IC-chip medal inscription machine 40 shown in FIG. 5.

The built-in-IC-chip medal inscription machine 40 according to the present invention is composed of a control unit 300 and its peripherals.

A control unit 300 is composed of a CPU 301, a ROM 302, a RAM 303, and a flash memory 308, further, comprising an SPU 304 and a sound buffer 305 and, a VDP 306 and a frame buffer 307.

The CPU 301 controls peripherals constituting the built-in-IC-chip medal inscription machine 40 to perform processing of issuing built-in-IC-chip medals based on instruction signals supplied from the control section 45 corresponding to instructions input by a player and the data and program stored in the ROM 302, the RAM 303 and the flash memory 308.

The CPU 301 comprises a processor that performs computing processing such as matrix, vector etc, about generation of image data as a coprocessor, and transmits results of computing processing to the VDP 306 to be described as a draw instruction.

The ROM 302, for example, is configured with a semiconductor memory, stores a program for realizing basic functions of the built-in-IC-chip medal inscription machine, a program required for a process to issue built-in-IC-chip medals, the image data and the PCM data as the sound data for BGM, the sound and the sound effect.

The RAM 303, for example, is composed of a semiconductor memory etc, temporarily stores data and programs required for processing.

The flash memory 308 stores data (identify information) about each player received IC issuance of built-in-IC-chip medals.

For example, a battery backup RAM may be installed instead of the flash memory.

The SPU 304, for example, is a sub-processor containing a PCM sound source device etc, controlled by the CPU 301.

The VDP 306 reads out required images data from the ROM 132 according to the draw instructions from the CPU 301 and generates composite image data in the frame buffer 307 based on images data.

The frame buffer 307 is a memory in which composite image data is generated by the VDP 306. The above-mentioned composite image data is output to the image display device 47 by the VDP 306. Generally, the frame buffer 307 is configured with a dual port RAM that can perform input of image data from the VDP 306 and output of composite image data to the image display device 47 at the same time.

The control section 45 to which an instruction of a player is input and the medal sensor 320 detects medals injected to the medal inlet 48 are connected to the above-mentioned control unit 300 (CPU 301).

When an instruction of a player is input by a button constituting the control section 45, an instruction signal corresponding to the instruction signal is supplied to the CPU 301. The CPU 301 proceeds a process of issuance of built-in-IC-chip medals based on the instruction signal.

The medal sensor 320, when detecting a medal injected into the medal inlet 48, transmits a detection signal to the CPU 301. The CPU 301 that received the above-mentioned detection signal, adds cumulatively 1 point to the point stored in the RAM 303 or the flash memory 308.

Further, the built-in-IC-chip medal payout device 315 to pay out built-in-IC-chip medals in which initial data of the game are written are installed inside of the main body device 41.

The above-mentioned control unit 300 (CPU 301) comprises the information reading/writing device 312 to write initial data of the game into the built-in-IC-chip medal contained in a predetermined region of the main body device 41 and the built-in-IC-chip medal payout device 315.

The information reading/writing device 312 performs a process to write the initial data of the game stored in the ROM 302, the RAM 303 and the flash memory 308 into the built-in-IC-chip medal by an instruction signal from CPU 301.

Here, the controller 300 and the information reading/writing device 312 function as a data writing mean which writes the initial data of the game into the built-in-IC-chip medal.

In addition, the built-in-IC-chip medal inscription machine according to the present invention may be composed to be able to read the initial data or the history data of the game that are stored in the built-in-IC-chip medal by the information reading/writing device 312. In this case, the initial data or the history data of the game being read is stored in the above-mentioned RAM 303 or the flash memory 308. The built-in-IC-chip medal inscription machine may be also composed to be able to write the initial data or the historical data of the game stored in the RAM 303 or the flash memory 308 into the medal with the built-in IC chip.

In this case, the controller 303 and the information reading/writing device 312 function as a data writing mean which writes the initial data of the game into the built-in-IC-chip medal.

The built-in-IC-chip medal payout device 315 performs a process to payout the built-in-IC-chip medal on which initial data of the game is written by an instruction signal from CPU 301 from the built-in-IC-chip medal pay outlet 46.

Further, the image display device 47 and, the speaker 43 are connected to the above-mentioned control unit 300 (CPU 301).

The image display device 47 displays composite image data generated on the frame buffer 307 by the VDP 306 on the screen 47a. The speaker 43 receives sound signals generated by SPU 304 and outputs sounds based on the sound signals. An input of an instruction required for issuing built-in-IC-chip medals is prompted by images displayed on the screen 47a and sounds output by the speaker 43.

A player can proceed a process such as issuance of built-in-IC-chip medals by operating the control section 45 according to the procedure indicated by the images displayed on the screen 47a and sounds output by the speaker 43.

Methods for a player to play the strategic simulation game with above-mentioned medal gaming machine at a game hall will now be explained.

Methods for a player to play the strategic simulation game with above-mentioned medal gaming machine at a game hall include methods including the six steps [1] to [6].

[1] is a step to receive issuance of built-in-IC-chip medals from a built-in-IC-chip medal inscription machine using medals.

[2] is a step to start a strategic simulation game using issued built-in-IC-chip medals with a medal gaming machine.

[3] is a step to proceed a strategic simulation game.

[4] is a step to stop a strategic simulation game in progress.

[5] is a step to resume a strategic simulation game stopped.

[6] is a step to join a strategic simulation game in progress.

Each steps of [1] to [6] mentioned above will now be explained referring to drawings.

In the flow charts shown below, explanations are omitted except specially required.

Background music (referred to as “BGM” hereinafter), the sound and the sound effect, etc, are output corresponding to the progress of the strategic simulation game.

When a sub-routine shown in each flow chart is being executed in the medal gaming machine, images corresponding to progress of the strategic simulation game are displayed on the screen 13a of the large display device 13 and the screen 14a of the image display device 14 installed at each satellite 12, and the BGM, the sound, the sound effect are output from the speaker 18 installed at the satellite 12 in an appropriate manner.

This is the same as the built-in-IC-chip medal inscription machine. When a sub-routine shown in a flow chart is being executed, images corresponding to progress of a process are displayed on the screen 47a of the image display device 47. The BGM, the sound and the sound effect are output from the speaker 43.

[1] A Step to Receive Issuance of Built-in-IC-Chip Medals from a Built-In-IC-Chip Medal Inscription Machine using Medals

A player who came to a game hall should buy multiple numbers of medals from a medal inscription machine in order to play a strategic simulation game with a medal gaming machine according to the present invention, then, have built-in-IC-chip medals issued from the built-in-IC-chip medal inscription machine.

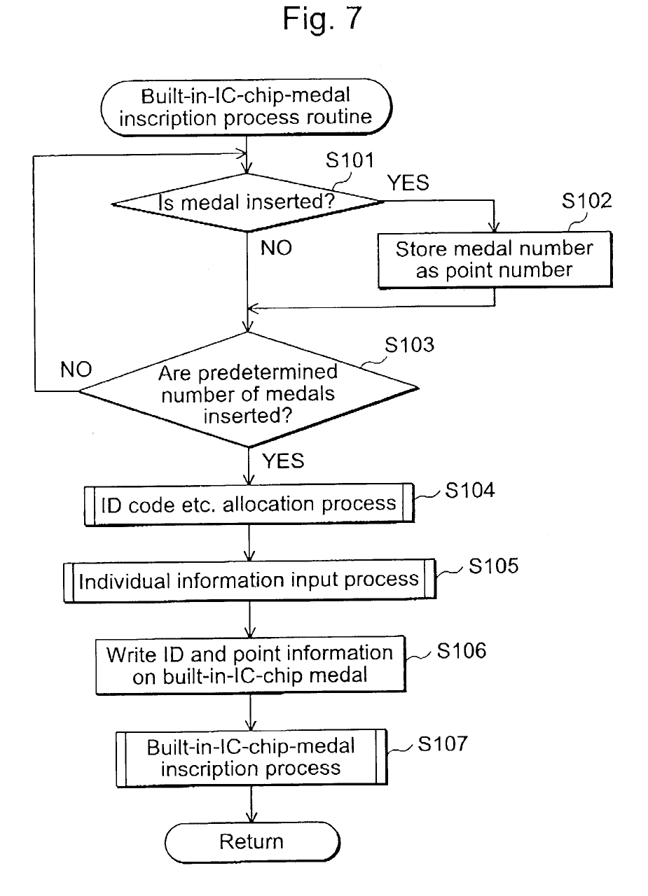

FIG. 7 is a flow chart showing a sub-routine executed to issue built-in-IC-chip medals in the built-in-IC-chip medal inscription machine 40. This sub-routine is executed by being called from the main routine executed in the built-in-IC-chip medal inscription machine 40 in an predetermined timing.

The CPU 301 judges whether a medal is injected (step S101). In other words, the CPU 301 judges whether a detection signal generated from 320 is received or not by detecting a medal inlet to the medal inlet 48.

If CPU 301 judged a medal is inlet, it stores the number of medals as points in the RAM 303 (step S102).

If CPU 301 judged medals are not injected in step S101, or, a process of S102 is executed, the CPU 301 judges whether a predetermined number of medals is injected (step S103). In other words, the CPU 301 compares the number of points stored in the RAM 303 and the predetermined number of points (for example, 10 points) and if the number of points stored in the RAM 303 reached the predetermined number of points, it considers that a predetermined number of medals have been injected.

If it judged that a predetermined number of medals have not been injected, it returns the process to the step S101.

On the other hand, if the CPU 301 judged a predetermined number of medals has been injected, it performs ID code allocation processing (step S104). The ID code allocation processing is a processing to allot an ID code or check code to a player. The ID code is a code to be allotted to a player one by one. It is set so that the ID code is reused by other players. A check code is an error detection code (having the same function as the so-called check digits) that is prepared by, for example, the above-mentioned ID code or current date. It is used to judge whether data stored on the built-in-IC-chip medal 30 are falsified in an unauthorized manner.

Then, personal information input processing is executed (step S105). This personal information input processing, for example, prompts a player to input personal information of the player. (for example, name) by displaying specific images on the screen 47a of the image display device 47 or outputting specific sounds from the speaker 43. If personal information of a player is input, the personal information is stored on the RAM 303 or the flash memory 308.

The ID codes allocated in the above-mentioned step S104, and personal information input in step S108 are used as initial data of the game to start a strategic simulation game in the medal gaming machine 10.

Then, the CPU 301 transmits instruction signals to the information reading/writing device 312 and performs processing to write identification information and information about point stored in the RAM 303 and the flash memory 308, in other words, initial data of the game to a built-in-IC-chip medal (step S106).

Then, the CPU 301 drives the built-in-IC-chip medal payout device 315 by transmitting an instruction signal to the built-in-IC-chip medal payout device 315, issues built-in-IC-chip medals from the built-in-IC-chip medal pay outlet 46 and exits this sub-routine (step S107).

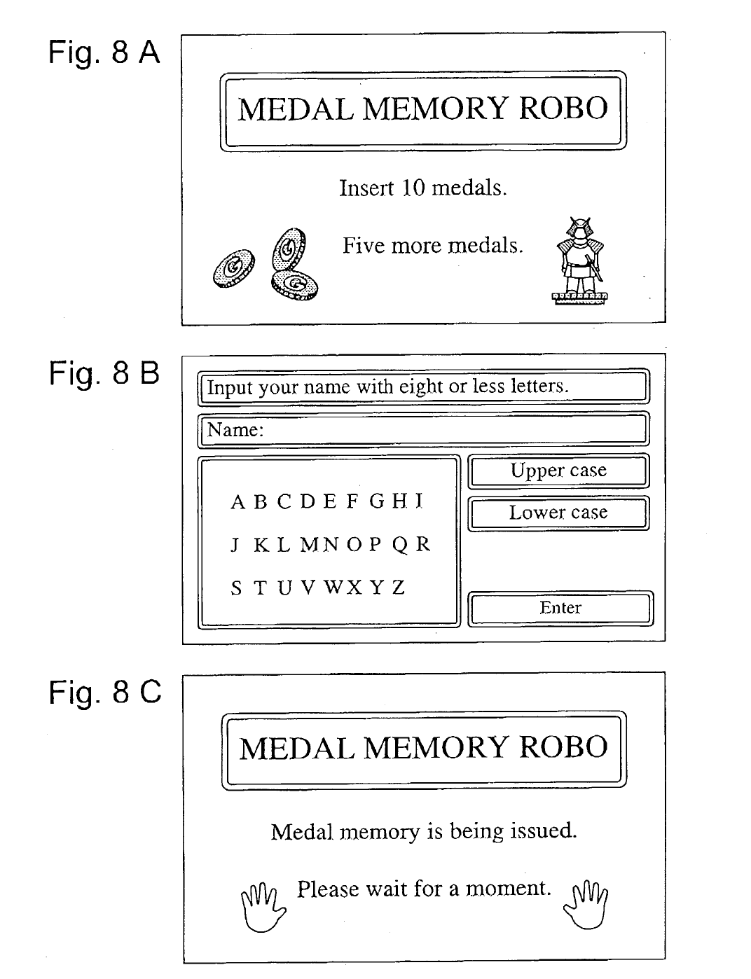

FIG. 8A to FIG. 8C are drawings schematically showing examples of images displayed on the screen 47a of the image display device 47 installed in the built-in-IC-chip medal inscription machine 40 when the sub-routine shown in FIG. 7 is executed.

The image shown in FIG. 8A is an image to prompt a player to inject medals.

This images is a image displayed when a process of sub-routine steps S101 to S103 shown in FIG. 7 are being executed.

An image of “medal memory robo ” that is a name of the built-in-IC-chip medal inscription machine 40 is displayed at the upper side the screen 47a. At the lower side of the image, an image to show an operation procedure “Insert 10 medals ” is displayed. At the lower side of it, a display “five more medals” to show the required number of medals is displayed.

When an image shown in FIG. 8A is displayed, a player can proceed a process of issuance of built-in-IC-chip medals by injecting ten medals into the medal inlet 48.

An image shown FIG. 8B is displayed on the screen 47a when ten medals are injected to the medal inlet 48, after that, process of step S105 is performed.

An image shown in FIG. 8B is an image to prompt a player to input personal information (name of a player).

An image to show an operational procedure “Input your name with eight or less letters.” is displayed at the upper side of the screen 47a. At the lower side, there is a column to input “name (name of a player)”. A list of alphabet is displayed at the lower left side of the column to input a “name”. At the right side of the list of alphabet, options to select a type of characters for inputting a name such as “upper case letter”, “lowercase letter” and an image to show an option “Enter” to confirm a name of a player who input are displayed.

When an image shown in FIG. 8B is displayed, a player can input personal information by operating the control section 45 according to the operational procedure show by the images.

Then, steps S106 and S107 are performed. An image shown in FIG. 8C is displayed in the screen 37a.

The image shown in FIG. 8C is an image to prompt a player to wait for completion of issuance of built-in-IC-chip medals.

At the upper side of the screen 47a, the image of “medal memory robo ” is shown as FIG. 8A. Under the image of “MEDAL MEMORY ROBO”, “Medal memory is being issued” to show the status of the current process is displayed. Further, an image “Please wait for a moment” to prompt a player to wait for completion of issuance of built-in-IC-chip medals are displayed.

When the image shown in the FIG. 8C is displayed, the CPU 301 of the controller 300 sends a command signal to the information reading/writing device 312 and processes the writing of the information related to the ID information and the points stored in the RAM 303 or the flash memory 308. In short, the process to write the initial data of the game into the medal with the embedded IC chip is carried out. In this case, the controller 300 and the information reading/writing device 312 function as a data writing mean which writes the initial data of the game into the built-in IC chip medal.

Built-in-IC-chip medals in which initial data of the game is stored are issued when a predetermined time has passed after the image shown in FIG. 8C is displayed.

[2] A Step to Start a Strategic Simulation Game using Issued Built-In-IC-Chip Medals with a Medal Gaming Machine

A player who received issuance of built-in-IC-chip medals in which initial data of the game is stored starts a strategic simulation game using built-in-IC-chip medals in a medal gaming machine.

A player who played a game in the past and has built-in-IC-chip medals in which history data of the game is stored can join a strategic simulation game using built-in-IC-chip medals in the medal gaming machine.

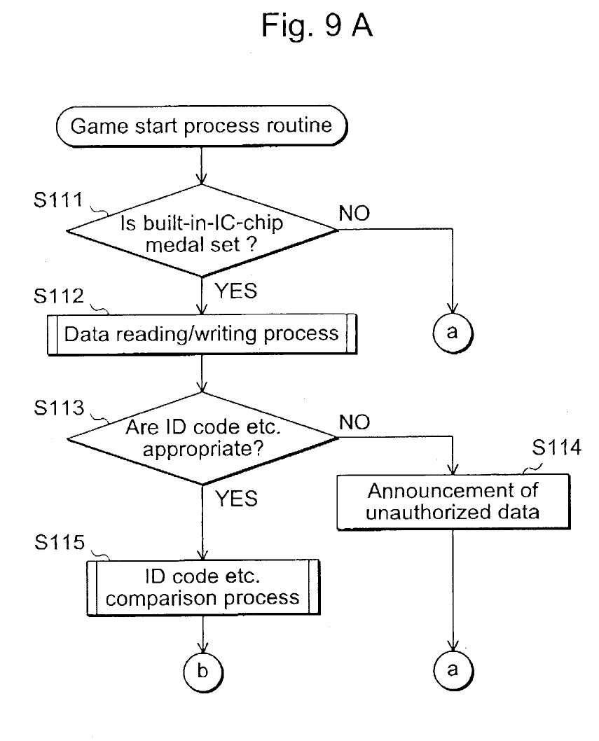

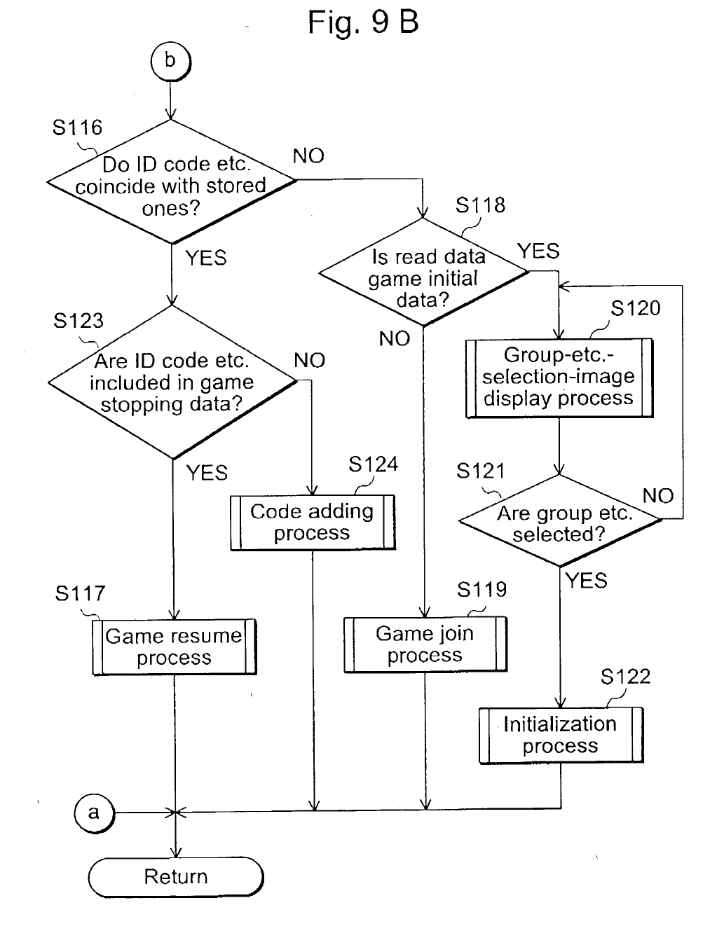

FIGS. 9A and 9B show a flowchart of a sub-routine executed when starting a new strategic simulation game in the main control unit 100 of the medal gaming machine 10. This sub-routine is executed by being called from the control program to control the strategic simulation game in medal gaming machine 10 in a predetermined timing.

First, the CPU 101 judges whether the built-in-IC-chip medal 30 has been set (step S111). In other words, CPU 101 judges whether a recognition signal showing setting of the built-in-IC-chip medal 30 has been received from CPU 131 of the control unit 130 installed at the satellite 12.

The recognition signal is a signal generated from the information reading/writing device 112 corresponding to the built-in-IC-chip medal 30 set to the depressed portion 19 of the built-in-IC-chip medal installation unit 20 installed at the satellite 12 mentioned above.

If it considers the built-in-IC-chip medal 30 has not been set to the depressed portion 19 of the built-in-IC-chip medal installation unit 20 installed at the satellite 12, this sub-routine is exited.

In the step S111, if the built-in-IC-chip medal is judged to be set on the depressed portion 19 of the built-in-IC-chip medal installation unit 20 installed at the satellite 12, the CPU 101 performs data reading process to read data stored in the built-in-IC-chip medal (step S112).

In this data reading process, the CPU 101 transmits an instruction signal to read the data stored in the built-in-IC-chip medal to the CPU 131 of the control unit 130 installed in the satellite 12 mentioned above. On the other hand, the CPU 131 of the control unit 130 installed in the satellite 12 mentioned above, when receiving an instruction signal mentioned above, drives the information reading/writing device 112, performs a process to read the data stored in the built-in-IC-chip medal and store the read data on the RAM 133 or the flash memory 138.

Further, the CPU 101 obtains the data stored in the RAM 133 or the flash memory 138 of the control unit 130 installed in the satellite 12 mentioned above and performs a process to store the data on the RAM 103 or the flash memory 104.

At this time, the main control unit 100, the control unit 130 and the information reading/writing device 112 installed in the satellite 12 function as data reading/writing means and reads at least one of initial data of the game and history data of the game.

Then, the CPU 101 judges whether the ID code, the check code and personal information (referred to as “ID code etc” hereinafter) included in the read data are appropriate (step S113). This judgment is performed by the functions of check code, etc. If the ID code etc, is not appropriate, as the read data is unauthorized, an announcement indicating unauthorized data being input is carried out (step S114). The data read in step S112 is deleted and this sub-routine is exited. An announcement of unauthorized data being input can be carried out, for example, by displaying a specific image indicating a warning “unauthorized data input” on the screen 14a of the image display device 14.

If the data read in S113 is judged as appropriate, the CPU 101 performs a process to compare the ID code, etc included in the read data and the ID code, etc stored in the RAM 103 or the flash memory 104 before performing a process S112 (step S115) and judges whether the ID code, etc included in the read data coincides with the ID code, etc stored in the RAM 103 or the flash memory 104 before performing a process S112 (step S116).

The ID code, etc stored in the RAM 103 or the flash memory 104 before performing a process S112 is data included in the history data of the game including initial data of the game and game stopping data.

If there is no ID code, etc stored in the RAM 103 or the flash memory 104 before performing a process S112, without performing a process of step S115, in the step S116 the ID code, etc included in the read data is considered not to coincide with the ID code, etc stored before performing a process S112.

In the step S116, the ID code, etc included in the read data is judged to coincide with the ID code, etc stored in the RAM 103 or the flash memory 104 before performing a process S112 (step S115), then, whether the ID code, etc included in the read data is included in the game stopping data is judged (step S123). The game stopping data is data stored in the RAM 103 or the flash memory 104 when stopping the strategic simulation game.

In the step S116, if the ID code, etc included in the read data is judged to coincide with the ID code, etc stored and in the step 123, the ID code, etc included in the read data is judged to be included in the game stopping data, it means there is a strategic simulation game currently played, the strategic simulation game currently played was being played in the past, and the history data of the game is stored in the built-in-IC-chip medal. The CPU 101 performs a game resuming process (step S117) to be described and exits this sub-routine. As the results, a player can resume the strategic simulation game stopped to play a game.

A detailed game resuming process will be explained referring to drawings later.

In the step S116, if the ID code, etc included in the read data is judged to coincide with the ID code, etc stored and in the step 123, the ID code, etc included in the read data is judged to be included in the game stopping data, it means that the data about the unit as the game stopping data is stored in the built-in-IC-chip medal, and the data about the unit is the data about the unit belonging to a group appearing in the strategic simulation game currently played. The CPU 101 performs a process to add the data about a group stored in the RAM 103 or the flash memory 104 with the data about the unit (step S124). Then, the CPU 101 proceeds the strategic simulation game by adding a new unit to the unit constituting the above-mentioned group.

On the other hand, in the step S116, if the read ID code etc, is judged not to coincide with stored ID code, etc, step S115 judges whether the read data is the initial data of the game (step S118). If the read data is judged not to be initial data of the game, the read data is history data of the game and the CPU 101 performs a game joining process to be described (step S119) and exits this sub-routine.

As the results, a player can join the strategic simulation game currently in progress using the history data of the game. If there is no strategic simulation game currently in progress a player can start a new strategic simulation game using the history data of the game. A detailed game joining process will be explained referring to drawings later.

In the step S118, if the read data is judged to be the initial data of the game, the CPU 101 transmits an instruction signal to display a group selection image to prompt a player to select a group, etc to the CPU 131 of the control unit 130 installed on the satellite 12 mentioned above (step S120).

On the other hand, the CPU 131, when receiving the above-mentioned instruction, performs a process to display a group selection image on the screen 14a of the image display device 14a. In other words, the VDP 136 reads out required image data from the image data stored in the ROM 132 by the draw instruction from the CPU 131 and generates composite image data and write it in the frame buffer 137. After that, the composite image data written into the frame buffer 137 is transmitted to the image display device 14, group etc, selection images is displayed on the screen 14. This group etc, selection image is an image to prompt a player to select a group (leader of a group) operated by the player. This group etc, selection image includes, for example, data about a group to be selected. So, if there is a strategic simulation game in progress, a group appearing in the above-mentioned strategic simulation game is not included in the above-mentioned group etc, selection images.

This is the same as a group included in the game stopping data stored in the RAM 103 or the flash memory 104.

The group etc, selection images will be explained later referring to drawings.

Then, the CPU 101 judges whether a group etc, has been selected (step S121). If it judged no group etc, has been selected, it returns the process to the S120.

On the other hand, if the CPU 101 judged the group etc, has been selected, it performs initialization processing (step S122) and exit the sub-routine so that a strategic will be started by the group etc. selected.

As the results, a player can start a new strategic simulation game using a initial data of the game. If there is a strategic simulation game currently in progress, a player can join a strategic simulation game currently in progress using initial data of the game.

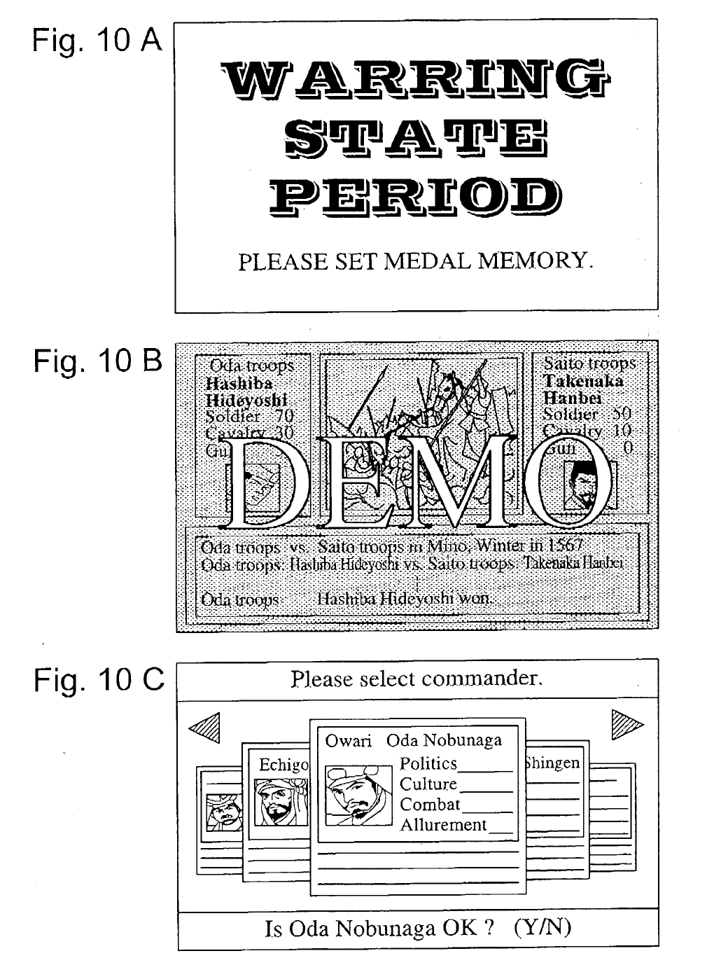

FIGS. 10A to 10C are diagrams schematically showing an example of an image displayed on the screen 14a of the image display device 14 installed on the satellite 12 of No. 1 when a sub-routine shown in FIG. 9A and FIG. 9B is being executed.

An image shown in FIG. 10A is a so-called title screen to prompt player to set the built-in-IC-chip medal, that is an image displayed no strategic simulation game is played in the No. 1 satellite mentioned above.

At the center part of the screen 14a, an image showing “the warring state period” that is the name of the strategic simulation game played in the medal gaming machine 10. At the lower side of image, an image “Set medal memory” showing an operational procedure is displayed.

At this time, a player can play a strategic simulation game by setting a built-in-IC-chip medal into the depressed portion 19 equipped at the built-in-IC-chip medal installation unit 20 of the satellite 12 according to the operational procedure shown by images.

In the example of a strategic simulation game, “Oda Nobunaga ”, “Hashiba Hideyoshi”, “Takenaka Hanbee”, “Shibata Katsuie”, “Maeda Toshiie”, “Takigawa Kazumasu”, “Saitoh Dohsan” are historical characters respectively in the Japanese warring state period, and names of characters in the strategic simulation game. “Owari” and “Mino” are the names of places appearing on the strategic simulation game.

If the built-in-IC-chip medal has not been set into the depressed portion 19 of the built-in-IC-chip medal installation unit 20 installed at the satellite 12 for a predetermined period of time after the image shown in FIG. 10A is displayed, an image shown in FIG. 10B is displayed instead of an image showing the name of the above-mentioned strategic simulation game.

FIG. 10B is a diagram schematically showing a demonstration image displayed introducing the contents of the strategic simulation game.

An image in which a unit “Hashiba Hideyoshi ” belonging to No. 1 group “Oda army” and, a unit “Takenaka Hanbee” belonging to other group “Saitoh army” are fighting each other is displayed on the screen 14a. At the center part the screen 14a, an image “DEMO” indicating that the image shown in the FIG. 10B is a demonstration image is displayed.

Images shown in FIG. 10A and FIG. 10B are displayed on the screen 14a of the image display device 14 on the No. 1 satellite 12 until a built-in-IC-chip medal is installed at the depressed portion 19 at the built-in-IC-chip medal installation unit 20 on the No. 1 satellite 12. That is the same in other satellite 12.

If a built-in-IC-chip medal is installed at the depressed portion 19 at the built-in-IC-chip medal installation unit 20 on the No. 1 satellite 12, no title screen or demonstration screen is no longer displayed on the screen 14a of the image display device 14 equipped at the No. 1 satellite 12. Instead, a group, etc selection image as shown in FIG. 10C is displayed. At this time, a title screen or demonstration screen are being displayed on the screen 14a of the image display device 14 equipped at the other satellite 12 where a title screen or demonstration screen is displayed.

FIG. 10C is a diagram schematically showing an example of group, etc selection image displayed on the screen 14a of the image display device 14 installed on the No. 1 satellite 12 of a medal gaming machine when a step S120 of a sub-routine shown in FIG. 9B is executed. An image to indicate an operational procedure “Select a military commander” is being displayed at the upper side of the screen 14a. Under the image, an image indicating names and ability values of multiple groups that can be selected by a player are displayed (for example, “politics”, “culture”, “combat”,“allurement” etc are digitalized). In the image shown in FIG. 10C, “Oda Nobunaga” is selected.

At the lower side of the screen 14a, an image “Oda Nobunaga, OK?” to prompt a player to confirm is displayed. Further, an image indicating options “(Y/N)” is displayed. At this time, if “Y” is selected, a group having “Oda Nobunaga” as a leader is selected to set the initial setting in the step S122. And a strategic simulation game starts.

[3] A Step to Proceed a Strategic Simulation Game

When a image shown in FIG. 10C is displayed, if an instruction to select a group is input, an initialization processing is executed in the step S122 of the sub-routine shown in FIG. 9B, after that, a strategic simulation game proceeds.

The strategic simulation game offered by the present invention of the medal gaming machine is not particularly limited. However, it preferably includes a training mode where a player breeds and enhances a group that he operates, and a combat mode where players make their own group that were bred and enhanced fight with each other to proceed a game.

For example, a training mode is preferably constructed so that a player can collect built-in-IC-chip medals in which data about the units is stored to increase the number of unit belonging to a group, enhance the ability value of each unit, further, a combat mode is preferably constructed so that players can make units fight with each other, in order to make players have attachment to the medals (medals with built-in IC chips), further enhance the desire for collecting medals (medals with built-in IC chips) and arouse a spirit of competition among players, making players get involved in a game.

An embodiment where a strategic simulation game that is provided by the medal gaming machine according to the present invention has a development mode and fight mode will now be explained.

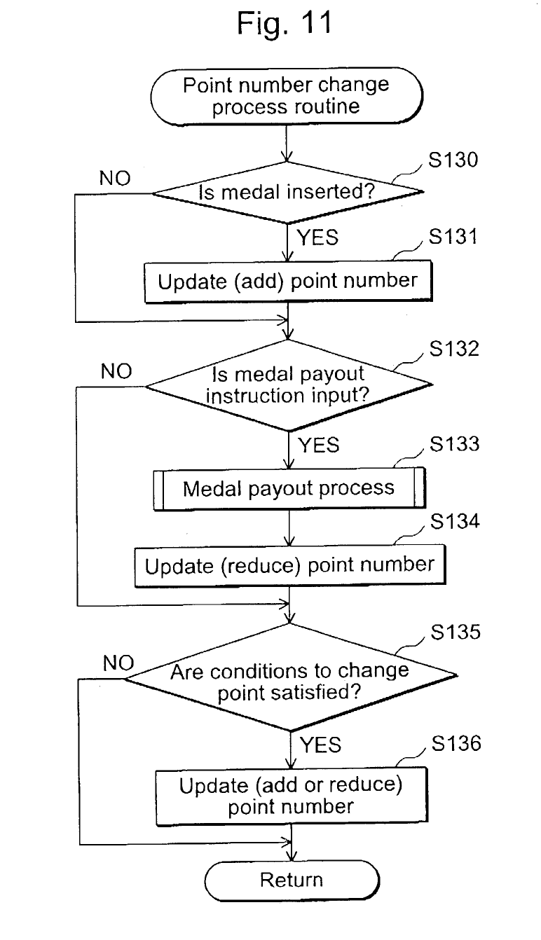

FIG. 11 is a flow chart showing a sub-routine executed in order to change the point number in the control unit 130 of No. 1 satellite 12 (referred to as “satellite A”). This sub-routine is repeatedly executed when a strategic simulation game that is in progress at a satellite A is in the training mode in a predetermined timing.

First, the CPU 131 of a control unit 130 at the satellite A judges whether a medal was injected to the medal inlet 16 (step S130). In other words, the CPU 131 judges whether a detection signal has been received from the medal sensor 120.

If it considered that a medal has been injected, it performs a process to update (add) points (step S131). For example, if 10 points are stored in the RAM 133 as points, one point is added to the point to make the point 11 and cumulatively store the point.

If point number is stored in the RAM 103 or the flash memory 104 of the main control unit 100, the CPU 131, when executing the process of step S131, transmits an instruction signal to the CPU 101 of main control unit 100.

The CPU 101 of the main control unit 100, when received this instruction signal, performs a process to update (add) points stored in the RAM 103 or the flash memory 104.

In step S130, if it is judged that no medal has been injected, then, whether an instruction to payout medals has been input is judged (step S132). In other words, the CPU 131 judges whether it received an instruction signal to pay out medals from the control section 15.

If it judged an instruction to payout medals has been input, it performs a process to pay out medals (step S133). In this medal payout process, the CPU 131 drives the hopper 121 to payout medals by transmitting an instruction order to the hopper 121. The medal detection part 122, when it detects medals paid out from the hopper 121, sends a detection signal to the CPU 131. The CPU 131, each time receiving a detection signal, stores the times of reception of a detection signal in the RAM 133 and when it judged the times of reception of a detection signal reached a predetermined times, transmits an instruction signal to stop the payout of medals to the hopper 121. As the results, payout of medals by the hopper 121 ends.

After that, the CPU 131 performs a process to update (reduce) the number of points stored in the RAM 133 depending on the number of medals paid out (step S134).

If the number of points is stored in the RAM 103 or the flash memory 104 of the main control unit 100, the CPU 131, when a process of the step S134 is executed, transmits an instruction signal to update the point stored in the RAM 103 or the flash memory 104 to the CPU 101 of the main control unit 100.

When the CPU 101 received the instruction signal, it performs process to update the point stored in the RAM 103 or the flash memory 104.

In the step S132, if it is judged that no instruction of payout of medals has been input, or a process of the step S134 is executed, it is judged whether the conditions to change the number of points have been fulfilled (step S135).

This judgment is performed by judging whether the CPU 131 has received an instruction signal to change the number of points from CPU 101 the main control unit 100 that makes a strategic simulation game proceed. This instruction signal is transmitted to the CPU 131 when the CPU 101 of the main control unit 100 judges the conditions to change the number of points in a strategic simulation game are fulfilled. If the CPU 101 judges the conditions to change the number of points in a strategic simulation game are fulfilled, it performs a process to update (add) points (step S136).

The conditions to change the number of points mentioned above are not particularly limited. Among the conditions to change the number of points, conditions to increase the points include, for example, winning a fiting with other groups, establishing a purpose given in a strategic simulation game.

Conditions to reduce the points include, for example, an input of instruction to develop a group or a unit belonging to a group, an input of instruction to start fighting against other groups. In step S135, if predetermined conditions to change the number of points is considered not to be fulfilled or a process of S136 is executed, this sub-routine ends.

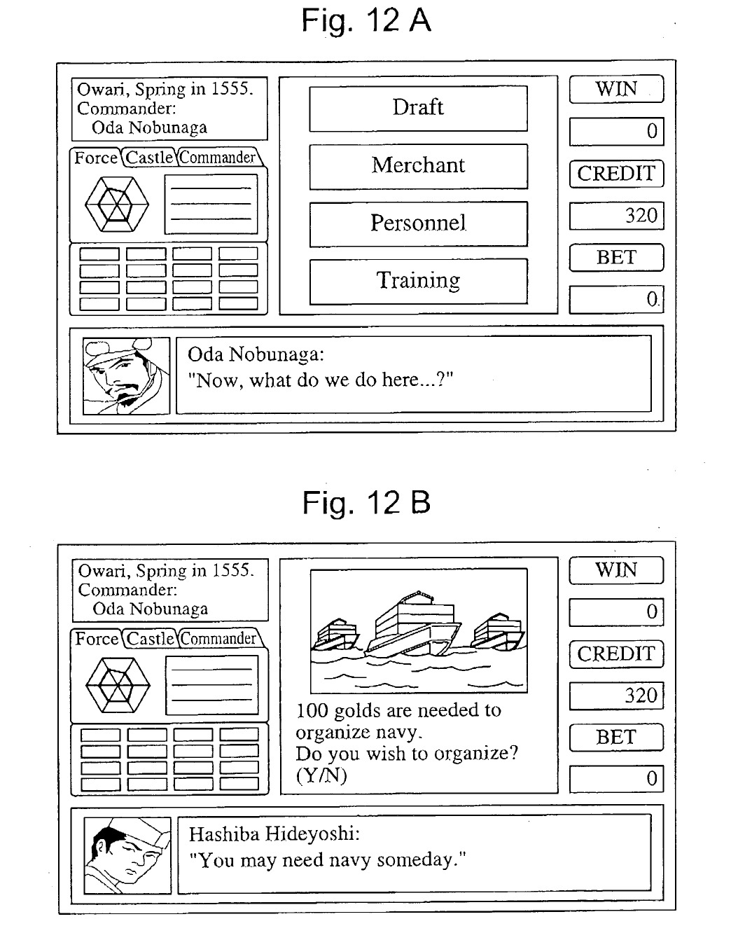

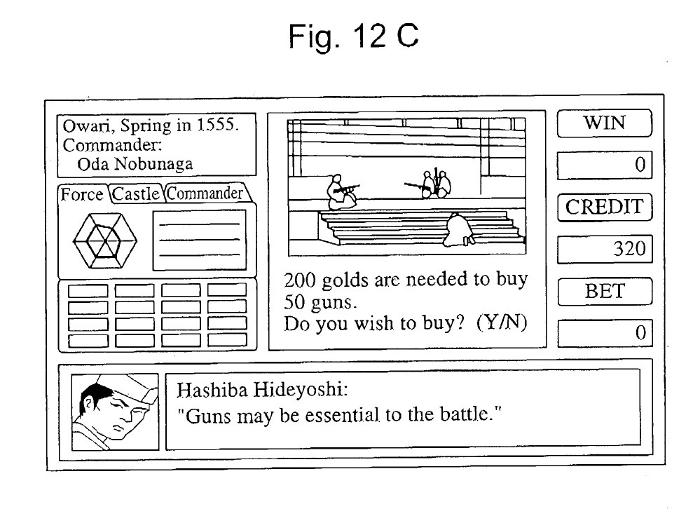

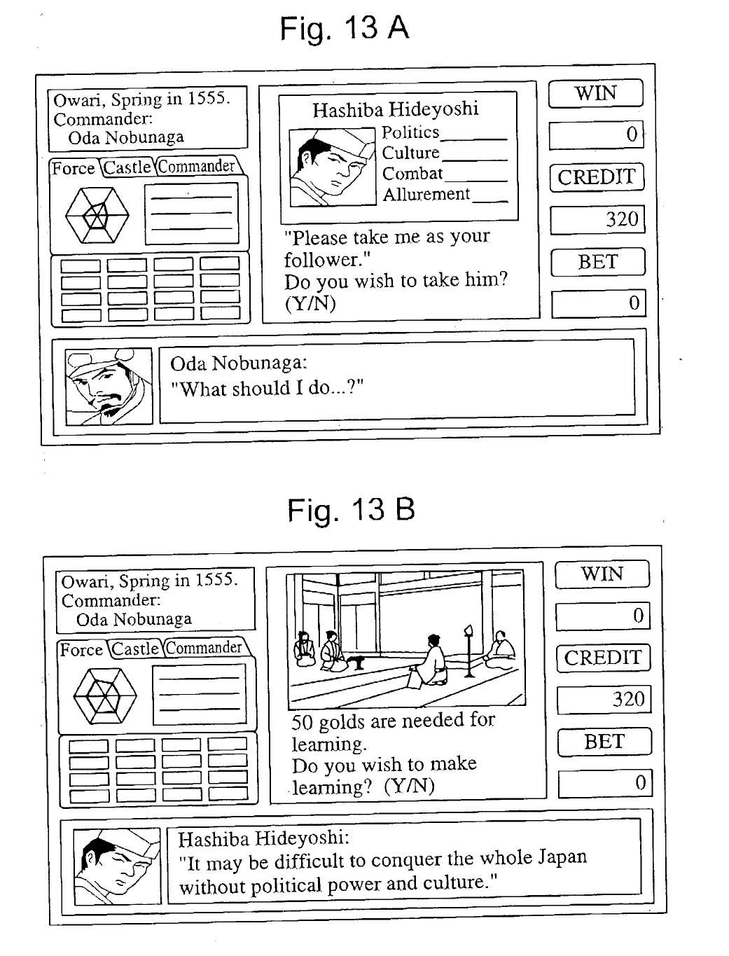

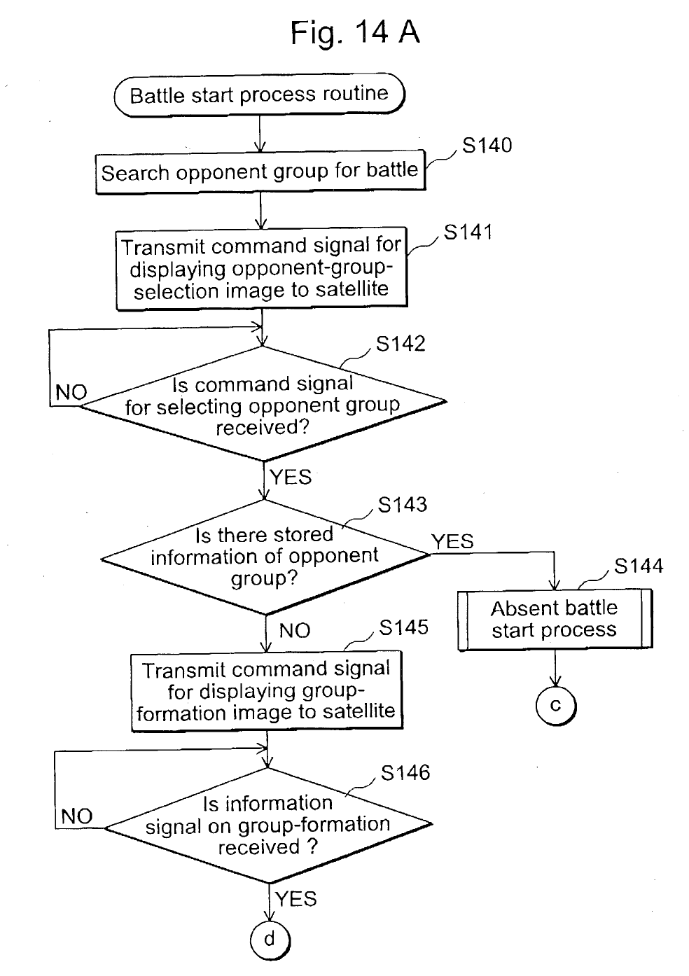

FIG. 12A to FIG. 12C and FIG. 13A to FIG. 13B show and example of an image screen displayed on the screen 14a of the satellite A, when the proceeding strategic simulation game is in training mode.

First of all, an image screen shown in the FIG. 12A is explained here.

An image, “1555 Spring Owari,” shows an imaginary year, season, and location of the group in a strategic simulation game.

These imaginary year and season (hereinafter referred to as “year and so on”) change as the strategic simulation game proceeds, and at the same time, they are displayed on the screen of the satellite where the strategic simulation game is played.

For example, when “Spring 1555” is displayed, a player playing a strategic simulation game on the satellite A can once input an indication, which is described hereinafter, for the group that the player operates (hereinafter referred to as “group A”). Moreover, a player playing a strategic simulation game in other satellite can once input the indication for the group that the player operates.

In addition, when the group makes a move in response to the input indication in each satellite, “Spring 1555” finishes, and “Summer 1555” will be displayed on the upper left of the screen.

An image shown below the above image, “Commander: Oda Nobunaga,” represents that the leader of the group A operated by the player, who plays the strategic simulation game on the satellite A, is Oda Nobunaga. Moreover, an image, which represents the name of the leader of the group operated by the player playing the strategic simulation game on the aforementioned satellite, is displayed on a screen of each satellite.

Furthermore, an image shown below the above image represents the ability value of the group A. Moreover, an image displayed under it is the one which shows the value of the ability (ability value) of the group A. Specifically, the ability value about the “force” (the number of the soldiers and their morale measured in numerical value), the ability value about the “castle” (size of the castle and the strength of the castle wall measured in numerical value) and the ability value of the “commander” (the ability of the main character, Oda Nobunaga, and his followers that area measured in numerical value) are shown.

On the lower part of the screen, an image showing a face of the leader of the group A, “Oda Nobunaga,” is displayed, along with an image representing the operational procedure of “Now, what do we do here . . . ” as a line of “Oda Nobunaga.” In response to the operational procedure, images, such as “Military draft,” “Merchant,” “Personnel,” “Training” and so on, which represent an indication for the group, are displayed in the midsection of the screen. Here, the player operates the control portion 15 and gives an indication for the group A by selecting an image showing a desired indication.

Moreover, abovementioned indications are all for training/reinforcement of the groups. Any of the indications can be selected by a player, and when a specified indication is input additionally, the CPU 131 of the control unit 130 carries out the processing of changing (increasing) the ability value, which is subject to change, among, for example, the ability value of the group stored in the RAM 133 or flash memory 138, and also carries out the processing of adding the data concerning the new unit to the data concerning the group.

An image “WIN” displayed on the right side of the screen and an image “0” displayed below that are the images representing the accumulative number of medals (total number of the points) acquired by the player in a strategic simulation game. When an image shown in FIG. 12A is displayed, the accumulative number of the medals that the player acquire in a strategic simulation game is zero.

An image “CREDIT” displayed on the right side of the screen and an image “320” displayed below that are the images representing the number of the points stored in the RAM 133 of the satellite 12. When an image shown in the FIG. 12A is displayed, the number of the points stored in the RAM 133 of the satellite 12 is 320.

An image “BET” additionally displayed below the above image and an image “10” displayed below “BET” are the images representing a challenge fee, which is paid to the other group when the player provoked the fight. The challenge fee is stored as a point in the RAM 133 of the satellite 12. In addition, when an image shown in FIG. 12A is displayed the challenge fee stored in the RAM 133 of the satellite 12 is zero.

When the image shown in the FIG. 12A is displayed, if the player selects an option of “Military draft” and moreover inputs the indication to organize a navy, an image shown in FIG. 12B will be displayed.

On the center of the screen an image representing the navy is displayed, along with an image representing an operational procedure of “Insert 100 golds to organize navy. “Do you wish to organize?” and an option of “(Y/N)” in response to the operation procedure. Moreover, on the lower part of the screen an image showing “You may need navy someday” as a line of “Hashiba Hideyoshi”, a unit belonging to the group, is displayed. The image represents an advise that “Hashiba Hideyoshi” gives to the leader of the group “Oda Nobunaga.”

When the image shown in FIG. 12A is displayed, selecting “Y” will organize navy, while selecting “N” will not organize it.

Furthermore when “Y” is selected, in the step S135 of the subroutine shown in FIG. 11, the CPU 131 judges that the condition for changing the number of the points is satisfied, and in the step S136 executes the processing of reducing the number of the points stored in the RAM 133 (320 points) to 100 points to make it 220 points.

CPU 131 also carries out the processing of increasing the ability value, which is subject to change, among the ability value of the group A stored in the RAM 133 or flash memory 138.

When the image shown in FIG. 12A is displayed, if the player selects the option of “Merchant” and inputs an indication for buying 50 guns, the image shown in FIG. 12C will be displayed.

On the center of the screen an image representing a scene of the deal with the Merchant is displayed, along with an image of the operational procedure indicating “Insert 200 golds to buy 50 guns. “Do you wish to buy?” and an image showing an option of “(Y/N)” in response to the operation procedure.

Moreover, an image representing an advise, “A gun may be essential in a fight,” which, “Hashiba Hideyoshi,” a unit belonging to the group gives to the leader, “Oda Nobunaga.”

At this point, when “Y” is selected, the player can purchase 50 guns, and when “N” is selected, no guns will be purchased.

Moreover, when “Y” is selected, in the step S135 of the subroutine indicated in the FIG. 11, CPU 131 decides that the condition for changing the number of the points is satisfied and in the step S136 executes the processing of deducting 200 points from the number of the points stored in the RAM 133 (320 points) to make it 120 points.

CPU 131 also executes the processing of increasing the ability value (for example the ability value concerning the weapons and so on), which is subject to change, among the ability value of the group A stored in the RAM 133 or flash memory 138.

When an image shown in the FIG. 12C is displayed, if the player selects the option of “Personnel,” an image shown in the FIG. 13A, for example, will be displayed.

On the center of the screen the data concerning a unit “Hashiba Hideyoshi” is displayed, along with an image showing “Please take me as your follower” as a line of “Hashiba Hideyoshi”, an image representing the operation procedure or “Include in the servants?”, and an image representing the option of “(Y/N)” in response to the operational procedure.

Moreover on the lower part of the screen an image representing a line of “Oda Nobunaga”, “What should I do . . . ” is displayed.

At this moment when “Y” is selected, the CPU 131 can add the data concerning the unit “Hashiba Hideyoshi” to the data concerning the group A stored in the RAM 133 or flash memory 138.

Furthermore, when an image shown in the FIG. 12A is displayed, if the player selects the option of “Training” and inputs the indication for learning, the image shown in FIG. 13B will be displayed.

On the center of the screen an image showing a scene where both commanders are talking is displayed, along with an image representing an operational procedure of “Insert 50 golds for carrying out learning.” “Do you wish to conduct?” and an image representing the option of “(Y/N)” in response to the operational procedure.

On the lower part of the screen an image representing an advise, “It is difficult to conquer the whole Japan without political power and education” which, “Hashiba Hideyoshi,” a unit belonging to the group gives to the leader, “Oda Nobunaga.”

At this time, when “Y” is selected learning will be carried out, and when “N” is selected learning will not be carried out.

Moreover when “Y” is selected, in the step S135 of the subroutine shown in FIG. 11, CPU 131 decides that the condition for changing the number of the points is satisfied, and in the step S136 carries out the processing of deducting 50 points from the number of the points stored in the RAM 133 (320 points) to make it 270 points.

CPU 131 also does the processing of increasing the ability value (for example, the ability value of government, education and so on), which is subject to change, among the ability value of the leader of the group A, “Oda Nobunaga,” stored in the RAM 133 or flash memory 138.

[3-1] Step To Provoke A Fight Against The Other Group

In training mode of abovementioned strategic simulation game, when achieving a specified purpose, for example, such as unifying the country or a location of a group (“Owari” is an example shown in FIG. 12A through FIG. 12C and FIG. 13A through FIG. 13B), training mode ends, and a combat mode is started. In this combat mode, a plurality of players can, by having the trained/reinforced groups fight in the training mode, play a game where each group rob each other for the administered territories and eventually one group will achieve the desired objective of world unification.

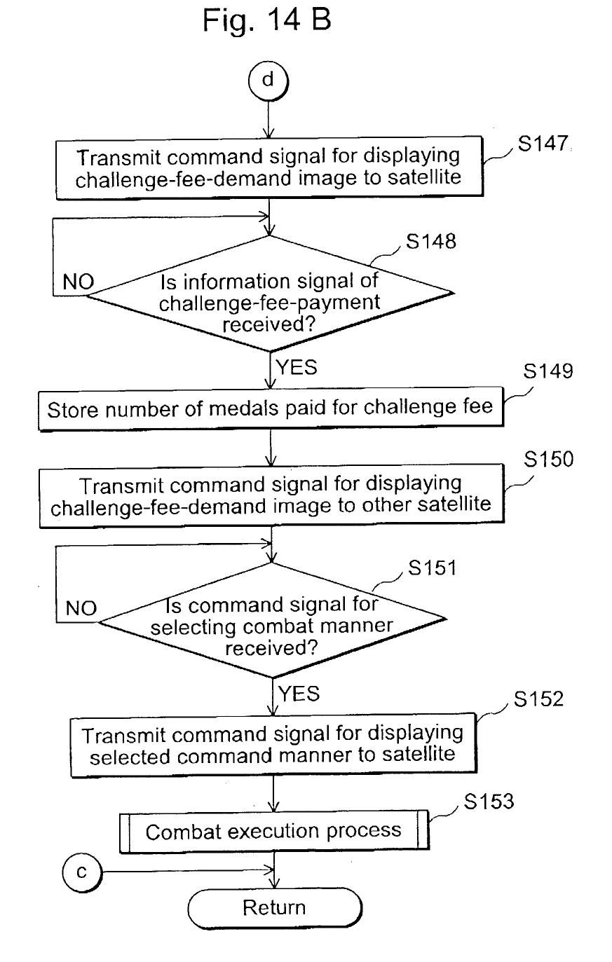

FIGS. 14A and 14B are flow charts, which illustrate a subroutine to be executed in order to start a fight between a group and another group in a strategic simulation game. Here, for an explanation of the of the FIGS. 14A and 14B, a group, which the group A provokes a fight against, is group B, and a satellite, in which the player operating the group B plays a strategic simulation game, is satellite B.

The subroutine illustrated in FIGS. 14A and 14B is, in response to the designation given by the group A for provoking a fight, executed after being called by the control program controlling the strategic simulation game on the medal operated gaming machine 10.

If the designation given by the group A for provoking a fight is input through the control section 15 of the satellite A, the CPU 131 of the controller 130 provided on the satellite A sends a signal to the CPU 101 of the main control unit 100 to indicate that the designation given by the group A for provoking a fight had been input.

As soon as the CPU 101 of the main control unit 100 receives this signal, the CPU 101, first, searches the group, which can provoke a fight against the group A, according to the data stored in the RAM 103 or the flash memory 104 of the main control unit 100, in otherwords the data concerning the group other than the group A (including the data stored as the paused-game data).

This search is to be done by determining whether or not the data and so on, which relate to the group(s) other than the group A, satisfies the specified condition(s).

For example in a strategic simulation game, when a group provokes a fight only against a group administering a territory lying next to the territory administered by aforementioned group, the search described above is done by determining whether or not the condition, where any of the other groups other than the group A (for example, the group B, group C and so on) administer the territory lying next to the territory administered by the group A, is satisfied, based on the data concerning the group other than the group A.

Secondly, the CPU 101 of the main control unit 100, based on the search results in the step S140, sends a command signal to the CPU 131 of the controller 130 provided in the satellite A to display the image for selecting a match-up group (step S141). After receiving the signal, CPU 131, then, sends a draw command and so on to the VDP 136. VDP 136, then, reads a necessary image data out of the image data stored in the ROM 132, generates a composite image data, and writes it into the frame buffer 137. Thereafter, the composite image data written in the frame buffer 137 is sent to the image display device 14, and the image for selecting a match-up group is displayed on the screen 14a.

This image for selecting a match-up group is generated according to the search results in the step S140. For example, if the search results in the step S140 are the groups B-D, an image illustrating a name of each group B-D is shown in abovementioned image for selecting a match-up group as an option. At this moment, the player can start a fight with a group by selecting it among the displayed groups to carry out the fight.

Next, the CPU 101 of the main control unit judges whether or not the CPU 101 received the command signal for selecting a match-up group (step S142).

This command signal is signaled from the control section 15 to the CPU 131 in response to that a group, among the groups displayed in aforementioned image for selecting a match-up group, has been selected by the player operating the control section 15 provided in the satellite A, when abovementioned image for selecting a match-up group is displayed. Consequently the CPU 101 of the main control unit 100 receives the signal from the CPU 131.

The control unit 101 of the main control unit 100 returns the processing to the step S142 when judging not to receive the above command signal.

On the other hand, in the step S142, when receiving the command signal for selecting the fighting group, the CPU 101 judges whether there is the game stop data of the fighting group selected in the RAM 103 or the flash memory 104 or not (step S143).

When it is judged that there is the game stop data of the fighting group selected in the RAM 103 or the flash memory 104, the player operating the fighting group selected stops the strategic simulation game and does not perform the strategic simulation game at this time. Therefore, the CPU 101 executes the absent fight start processing (step S144), and starts the fighting between the group B not operated by the player and the group A.

On the one hand, in the step S143, the player operating the fighting group selected performs the strategic simulation game at this time when it is judged that there is not the game stop data of the fighting group selected in the RAM 103 or the flash memory 104. Therefore, a command signal for displaying the group formation image is transmitted to the CPU 101 of the control unit 100 provided on the satellite A (step S145).

The CPU 131 receiving the command signal transmits the drawing command etc. to the VDP 136. The VDP 136 reads out the required image data by the drawing command etc. of the CPU 131 among the image data stored in the ROM 132, and writes into the flame buffer 137 by generating composite image data. After that, the composite image data wrote in the flame buffer 137 is transmitted to the image display device 14 and the group formation image is displayed on the screen 14a.

Moreover, the group formation image is an image facilitating to decide an unit going in for the fight among one or more units belonging to the group. For instance, the group formation image includes an image showing namings of each unit (U1 to U5) for selection when the player performs the strategic simulation game by using five built-in-IC-chip medals (Ml to M5) which store data of each unit (U1 to U5) for selection.

Furthermore, the CPU 101 of the main control unit 100 executes the following fight execution processing based on data of the units (U1 to U3) stored in the built-in-IC-chip medals (M1 to M3), when the player operates the control section 15; and for example, inputs a command for making the units (U1 to U3) go in for the fight.

Therefore, the fight can be started based on data stored in at least one built-in-IC-chip medal among data red by the information writing/reading device 112 of the satellite A and stored in a plurality of the built-in-IC-chip medals.

Then, the CPU 101 judge whether an information signal on group formation is received (step S146).

According to the above described example, the information signal on group formation is a signal to be transmitted from the CPU 131 of the control section 130 set to the satellite A to the CPU 101 of the main control section 100 when the control section 15 is operated by a player and an instruction for making units (U1 to U3) participate in a fight is input.

When it is judge in step S146 that the signal for group formation is not received, the CPU 101 of the main control section 100 returns the processing to step S146.

However, when it is judge in step S146 that the information signal on group formation is received, the CPU 101 of the main control section 100 transmits an instruction signal for displaying a challenge-cost request image to the CPU 131 of the control section 130 set to the satellite A (FIG. 14B, step S147).

The CPU 131 receiving the instruction signal transmits a drawing instruction or the like to the VDP 136. The VDP 136 reads necessary image data from the image data stored in the ROM 132, generates synthetic image data, and writes the data in the frame buffer 137 Then, the synthetic image data written in the frame buffer 137 is transmitted to the image display device 14 and a challenge-cost request image is displayed on the screen 14a.

Moreover, the challenge-cost request image is an image for prompting the group B to pay a challenge cost necessary for the group A to start a fight. When the challenge-cost request image is displayed, the control section 15 is operated by a player and a designation for paying a challenge cost is input, the CPU 131 of the control section 130 set to the satellite A judges in step S136 that a condition for changing the number of points is satisfied, executes the processing for updating (decreasing) the points stored in the RAM 133 or flash memory 138, and transmits an information signal showing that the challenge cost is paid to the CPU 101 of the main control section 100.

Then, then CPU 101 of the main control section 100 judges whether the information signal showing that the challenge cost is paid is received (step S148) When the CPU 101 judges that the information signal showing that the challenge cost is paid is not received, it returns the processing to step S148.

However, when the CPU 101 judges in step S148 that the information signal showing that the challenge cost is paid is received, it stores the number of medals paid as the challenge cost in the RAM 103 or flash memory 104 (step S149).

Then, the CPU 101 of the main control section 100 transmits an instruction signal for displaying a meeting selection image to the CPU 131 of the control section 130 (step S150).

The CPU 131 receiving the instruction signal transmits a drawing instruction to the VDP 136. The VDP 136 reads necessary image data from the image data stored in the ROM 132 in accordance with the drawing instruction supplied from the CPU 131, generates synthetic image data, and writes the data in the frame buffer 137. Thereafter, the synthetic image data written in the frame buffer 137 is transmitted to the image display device 14 and a meeting selection image is displayed on the screen 14a.

The above meeting selection image is an image for prompting selection of a combat manner in the fight between the group A and group B and the meeting selection image includes one or more images showing a combat manner as an option.

Then, when the control section 15 is operated by a player and a designation for selecting a combat manner is input, the CPU 101 of the main control section 100 performs the fight execution processing to be described later in accordance with the selected combat manner.

Then, the CPU 101 of the main control section 100 judges whether an instruction signal for selecting a combat manner is received (step S151).

When determining that the information signal for selecting a combat manner is not received, the CPU 101 of the control section 100 returns the processing to step S151.

However, when the CPU 101 judges that the instruction signal for selecting a combat manner is received, it transmits an instruction signal for displaying an image of the selected combat manner to the satellite A (step S152).

The CPU 131 receiving the instruction signal transmits a drawing instruction or the like to the VDP 136. The DVP 136 reads necessary image data from the image data stored in the ROM 132 in accordance with the drawing instruction supplied from the CPU 131, generates synthetic image data, and writes the data in the frame buffer 137. Thereafter, the synthetic image data written in the frame buffer 137 is transmitted to the image display device 14 and the image showing the selected combat manner is displayed on the screen 14a.

Thereafter, the fight execution processing to be described later is executed (step S153), a fight is executed between the group A and group and this subroutine ends.

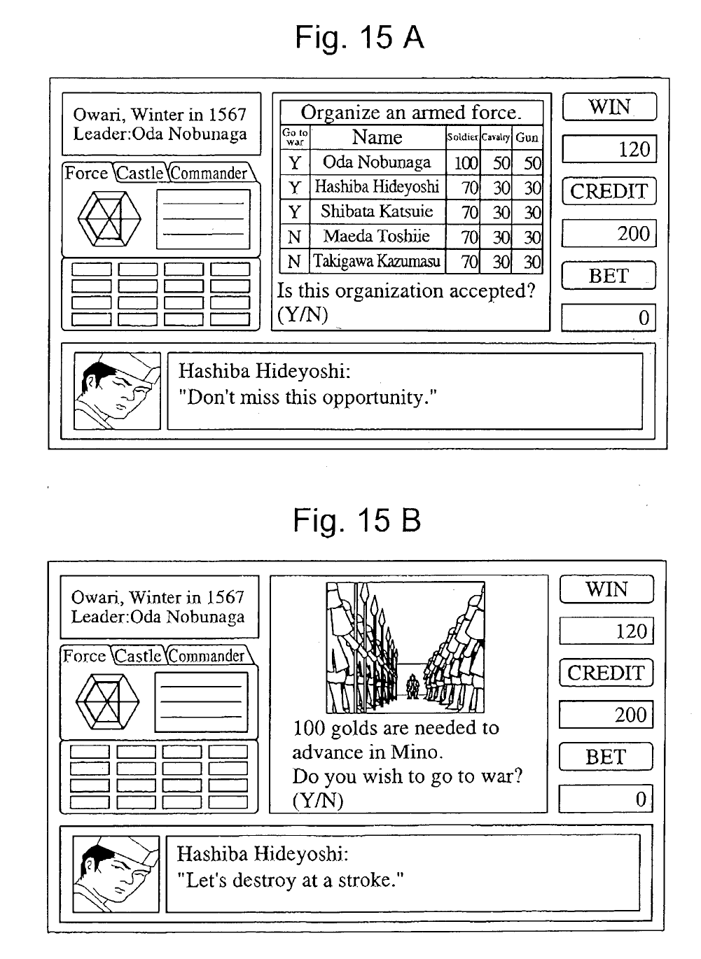

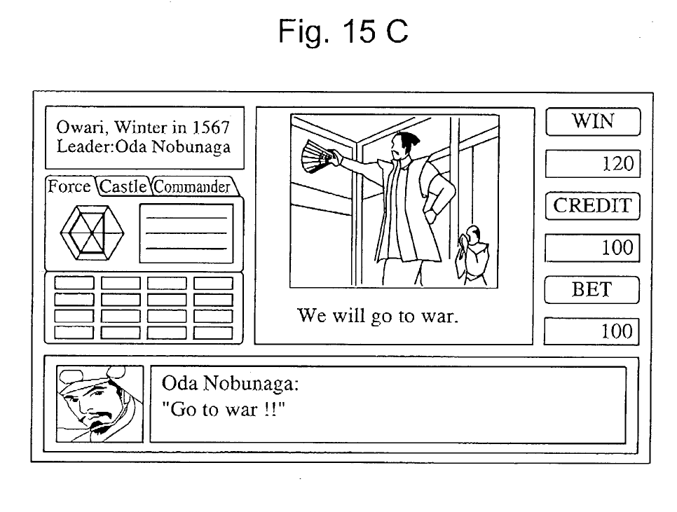

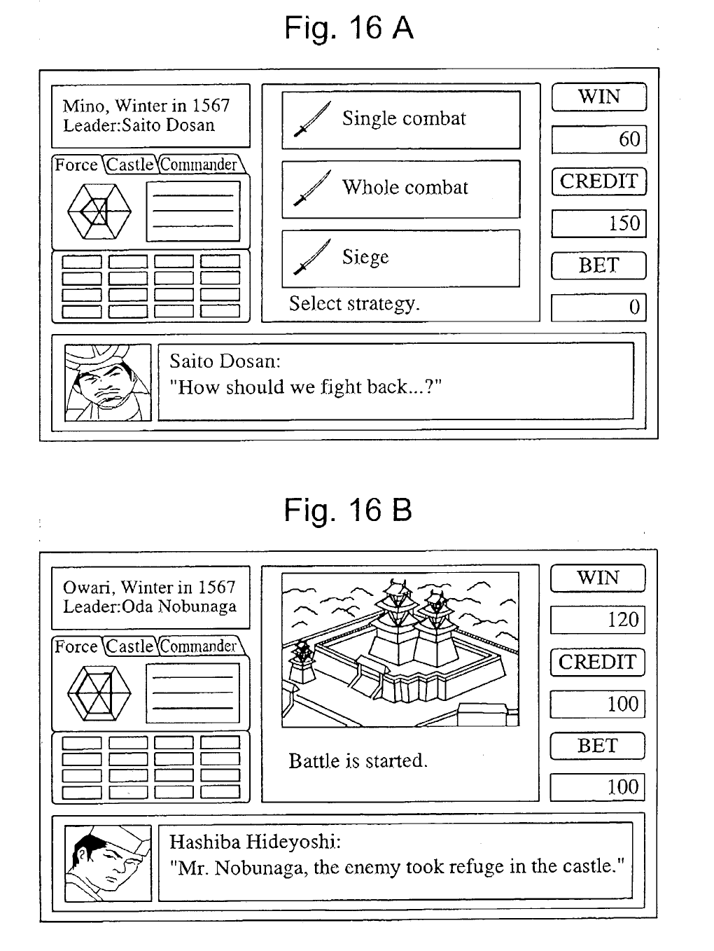

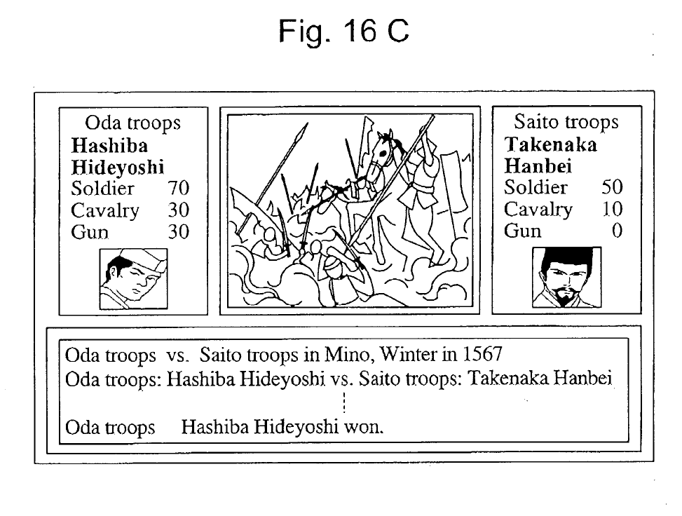

FIGS. 15A to 15C and FIGS. 16A to 16C are illustrations schematically showing screen images displayed on the screen 14a of the image display device 14 set to the satellites or satellite A and/or B when the subroutine shown in FIGS. 14A and 14B is executed.

The screen images shown in FIG. 15A are group formation images displayed on the screen 14a of the image display device 14 of the satellite A when the processings in steps S145 and S146 of the subroutine shown in FIG. 14A are executed.

An image “1567 Winter Owari” displayed on the upper left of the screen shows an imaginary year season and the location of the group A in a strategic simulation game. An image “Leader: Oda Nobunaga” displayed at the lower side of the above screen is the image showing that the leader of the group A to be operated by a player who performs the strategic simulation game is Oda Nobunaga. Moreover, the ability value of the group A to be operated by a player who performs the strategic simulation game at the satellite A is displayed below the above screen.

Moreover, images of “WIN”, “120”, “CREDIT”, “200”, “BET”, and “0” are displayed in order from the upper side at the right of the screen and these images show that the accumulated number of medals obtained by a player who performs the strategic simulation game at the satellite A is 120, the number of points stored in the RAM 133 of the satellite A is 200, and the challenge cost stored in the RAM 133 of the satellite A is point 0.

The image of “Organize an armed force.” showing an operational procedure is displayed at the upper side of the center of the screen and a list showing ability values of five units belonging to the group A is displayed below the above image.

The second item “name” from the left of the list is an item showing names of units, in which “Oda Nobunaga” who is the leader of the group A, and “Hashiba Hideyoshi”, “Shibata Katsuie”, “Maeda Toshiie”, and “Takigawa Kazumasu” who are units belonging to the group A are displayed in order from the top. Moreover, the third item “Soldier” from the left of the list is an item showing the number of foot soldiers of a foot-soldier troop led by each unit, the fourth item “cavalry” from the left is an item showing the number of soldiers of a cavalry troop led by each unit, and the fifth item “iron” from the left is an item showing the number of soldiers of a gun troop led by each unit. Therefore, the armed force led by “Oda Nobunaga” who is the leader of the group A is constituted by 100 soldiers of a foot-soldier troop, 30 soldiers of a cavalry troop, and 50 soldiers of a gun troop.

Moreover, the data on these units is stored in a built-in-IC-chip medal every data on each unit.

The leftmost item “go to war” of the list is an item for selecting whether to make the unit displayed at the right of the item go to war, on which “Y” or “N” can be displayed when a player inputs a designation.

In the case of the screen images shown in FIG. 15A, “Y” is displayed on the item of “go to war” in the case of “Oda Nobunaga” who is the leader of the group A and “Hashiba Hideyoshi” and “Shibata Katsuie” who are units belonging to the group A and “N” is displayed on the item of “go to war” in the case of “Maeda Toshiie” and “Takigawa Kazumasu” who are remaining units.

Moreover, the image of “Is this organization accepted?” for prompting confirmation is displayed at the lower side of the above list and moreover, the image showing an option “Y/N” is displayed.

Furthermore, the image showing the advice “Don't loose this opportunity.” to be given to the leaser “Oda Nobunaga” from “Hashiba Hideyoshi” which a unit belonging to the group A is displayed at the lower side of the screen.

When the images shown in FIG. 15A are displayed and “Y” is selected, the unit in which “O” is displayed on the item of “go to war” is displayed, that is, “Oda Nobunaga” who is the leader of the group A and “Hashiba Hideyoshi” and “Shibata Katsuie” participate in a fight.

By setting the above mentioned, it is possible to start a fight in accordance with the data stored in three built-in-IC-chip medals in the data stored in five built-in-IC-chip medal read by the information reading/writing device 112 set to the satellite A.

When the screen images shown in FIG. 15A are displayed and the organization of a group is completed, the processings in steps S147 and S148 of the subroutine shown in FIG. 14B are executed.

The screen images shown in FIG. 15B are challenge-cost request images displayed on the screen 14a of the image display device 14 of the satellite A.

Because the images displayed at the left of the screen are the same as those shown in FIG. 15A, their description is omitted.

The image showing a state in which the preparation for goring to war is completed and the image showing an operational procedure of “100 golds are necessary to got to war in Mino. Do we go to war?” is displayed at the central portion of the screen and the image showing an option of “(Y/N)” is displayed.

Moreover, the image showing the advice “Let's destroy at a stoke.” to be given to the leader “Oda Nobunaga” from “Hashiba Hideyoshi” which is a unit belonging to a group is displayed at the lower side of the screen.

When the screen images shown in FIG. 15B are displayed and “Y” is selected, the CPU 131 of the control section 130 set to the satellite A judges that a condition for changing the number of points is satisfied in step S135 of the subroutine shown in FIG. 11, subtracts 100 points from the number of points (200 points) stored in the RAM 133, executes the processing for decreasing the number of points to 100 points, and moreover transmits an information signal showing that a challenge cost is paid to the CPU 101 of the main control section 100.

Moreover, the CPU 101 of the main control section 100 judges in step S148 that the information signal showing that the challenge cost is paid is received and executes the processing for storing the number of medals (number of points) paid as a challenge cost in the RAM 103 or flash memory 104.

Thereafter, when the processing in step S149 of the subroutine shown in FIG. 14B is executed, the images shown in FIG. 15C are displayed on the screen 14a of the image display device 14 set to the satellite A.

The image showing a state in which “Oda Nobunaga” who is the leader of the group A gives a command for going to war and the image of “We will go to war.” are displayed at the central portion of the screen.

Moreover, the image showing the words “Go to war!!” of “Oda Nobunaga” who is the leader of the group A is displayed at the lower side of the screen.

Furthermore, because 100 points are paid as a challenge cost when the images shown in FIG. 15B are displayed, images displayed as “CREDIT”, “200”, “BET”, and “0” in the screen images of FIG. 15B are changed to images “CREDIT”, “100”, “BET”, and “100”.

Screen images shown in FIG. 16A are screen images displayed on the screen 14a of the image display device 14 of the satellite B when steps S150 and S151 of the subroutine shown in FIG. 14B are executed.

An image “1567 Winter Mino” displayed on the top left of the screen are images showing an imaginary year season and location of the group B in a strategic simulation game and the image “Leader: Saito Dosan” displayed below the above images is an image showing that the leader of the group B to be operated by a playerwho performs the strategic simulation game at the satellite B is Saito Dosan. Moreover, the image showing the ability value of the group B to be operated by a player who performs the strategic simulation game at the satellite B is displayed below the above image.

Images of “WIN”, “60”, “CREDIT”, “150”, “BET”, and “0” are displayed in order from the upper side at the right of the screen and these images show that the accumulated number of medals obtained by a player who performs the strategic simulation game at the satellite B is 60, the number of points stored in the RAM 133 of the satellite A is 150, and the challenge cost stored n the RAM 133 of the satellite A is 0 point.

Images showing combat manners such as “single combat”, “whole combat”, and “siege” are displayed at the central portion of the screen and the image showing the operational procedure of “Select strategy.” is displayed below the above images.

Moreover, the image showing the words “How should we intercept . . . ?” of “Saito Dosan” who is the leader of the group B is displayed at the lower side of the screen.

In this case, the player can perform the fight with the group A by a selected combat manner by operating the control section 15 of the satellite B and selecting the image showing a desired combat manner.

Among the above combat manners, the combat manner “single combat” is a combat manner in which one unit belonging to the group A fights with one unit belonging to the group B. When a fight is performed in accordance with this combat manner, the fight is started in accordance with the data stored in one built-in-IC-chip medal among the data read by the information reading/writing device 112 set to a satellite.

Moreover, the combat manner “whole combat” is a combat manner in which two or more units belonging to the group A fights with two or more units belonging to the group B.

When a fight is performed in accordance with this method, the fight is started in accordance with the data stored in two or more built-in-IC-chip medal among the data read by the information reading/writing device 112 set to a satellite.

Moreover, the combat manner “siege” is a combat manner in which one or two or more units belonging to the group A fights with one or two or more units belonging to the group B in accordance with ability values and the like of the groups A and B.

In the case of a strategic simulation game provided by a medal-operated gaming machine of the present invention, a combat manner which can be selected when starting a fight is not restricted. However, it is preferable that a medal-operated gaming machine of the present invention for providing a strategic simulation game is constituted so that the combat manner of the above “single combat”, that is, a combat manner in which players fight with each other by using the data stored in one built-in-IC-chip medal among the data stored in a plurality of built-in-IC-chip medals respectively can be selected.

Because a player can perform a strategic simulation game by using an built-in-IC-chip medal storing the data for his favorite unit or an built-in-IC-chip medal storing the data for a unit having a high ability value, it is possible to make the player strongly have the feeling of commitment on a medal (medal with the built-in IC chip) and improve the want for collection of medals (medal with the built-in IC chips), and moreover it is possible to make the player further being too much into the game.

Moreover, it is preferable that a medal-operated gaming machine of the present invention for providing a strategic simulation game is constituted so that the above-described combat manner “whole combat”, that is, the combat manner in which players fight with each other by using the data stored in two or more built-in-IC-chip medal among the data stored in a plurality of built-in-IC-chip medal respectively can be selected.

Because a player having more built-in-IC-chip medals storing the data for a unit having a high ability value can advantageously process a fight, it is possible to remarkably improve the want for collection of medals (medal with the built-in IC chips) of the player.

When the images shown in FIG. 16A are displayed on the screen 14a of the image display device 14 set to the satellite B, for example, when “siege” is selected a combat manner, images for a selected combat manner are displayed on the screen 14a of the image display device 14 set to the satellite A as shown in FIG. 16B.

The screen images shown in FIG. 16B are screen images to be displayed on the screen 14a of the image display device 14 set to the satellite A when the processing in step S152 of the subroutine shown in FIG. 14B is executed.

Because the images displayed at the left of the screen are the same as the images shown in FIG. 15C, the description is omitted.

The image showing the castle in which “Saito Dosan” belonging to the group B stand a siege is displayed and the image of “Fight is started.” is displayed at the central portion of the screen.

Moreover, the image showing the words “Mr. Nobunaga, the enemy is sieged.” of “Hashiba Hideyoshi” who is one unit belonging to the group A is displayed at the lower side of the screen.

The screen images shown in FIG. 16C are images showing the state of a fight to be displayed on the screen 14a of the image display device 14 set to the satellites A and B when the processing in step S153 of the subroutine shown in FIG. 14B is executed.

The image showing the data for “Hashiba Hideyoshi” who is one unit belonging to the group A is displayed at the top left of the screen and the data for “Takenaka Hanbei” who is one unit belonging to the group B is displayed at the right of the screen. Moreover, the image showing a state in which a fight is performed is displayed at the central portion of the screen.

Furthermore, the image showing the process of a fight between the group A and group B is displayed at the lower side of the screen.

[3-2] Stage of Performing Fight with Other Group

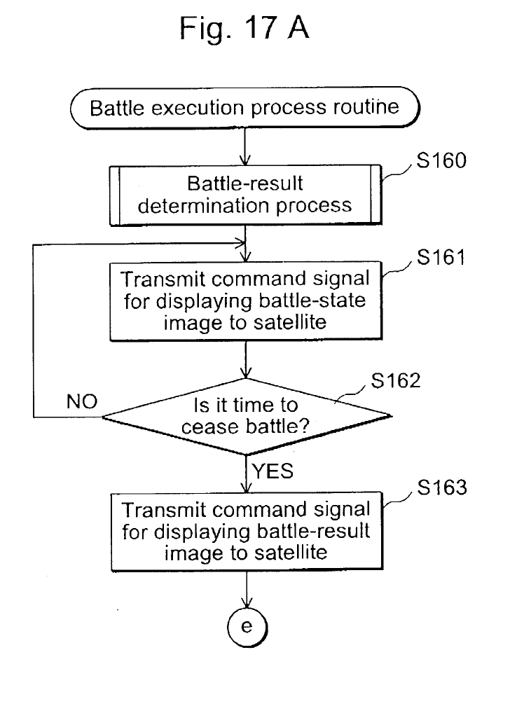

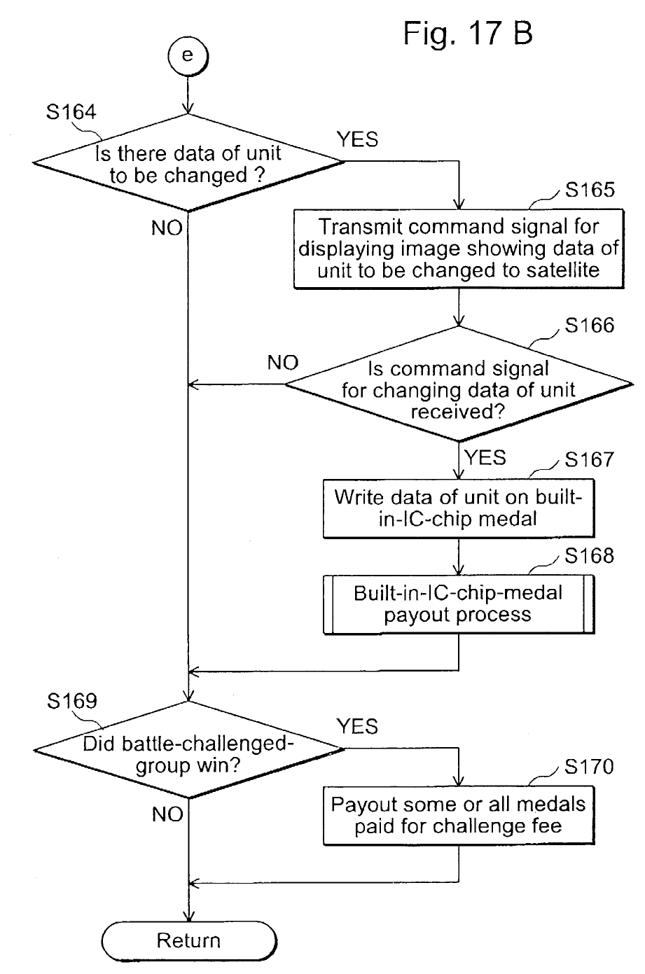

FIGS. 17A and 17B are flowcharts sowing a subroutine to be executed to perform a fight between one group and another group in a strategic simulation game in the main control section 100 of the medal-operated gaming machine 10.

The subroutine is a subroutine to be called and executed in step S153 of the subroutine shown in FIG. 14B.

FIGS. 17A and 17B are described on a case in which the group A wins a victory in the fight between the groups A and B.

First, the fight-result decision processing is executed (step S160).

The fight-result decision processing is a processing for the CPU 101 of the main control section 100 to decide a result of the fight between the groups A and B in accordance with the data for the group A, the data for the group B, and the data for the selected combat manner in step S151 of the flowchart shown in FIG. 14B.

For example, when the combat manner “single combat” is selected among the above-described combat manners, the CPU 101 of the main control section 100 performs the processing for comparing ability values of units each other in accordance with the data for one unit belonging to the group A and the data for one unit belonging to the group B and decides a result of the fight between the groups A and B.

Moreover, when the combat manner “whole combat” is selected, the CPU 101 of the main control section 100 performs the processing for comparing ability values of units each other in accordance with the data for two or more units belonging to the group A and the data for two or more units belonging to the group B and decides a result of the fight between the groups A and B.

Moreover, in the case of the fight-result decision processing, the CPU 101 of the main control section 100 not only decides a group wining a victory but also performs the processing for deciding changes of various ability values set to the groups A and B such as the number of soldiers in groups decreased due to a fight and ability values of units to be changed due to a fight as fight results.

Moreover, in the case of the fight-result decision processing in step S160, it is judged whether to change the data for a unit belonging to a defeated group (group B) as the data for a unit belonging to a victorious group (group A). In this case, it is decided to change the data for which unit.

Furthermore, the CPU 101 of the main control section performs the processing for storing the data for the fight result decided in step S160 in the RAM 103 of the main control section 100 and the processing for changing ability values of the groups A and B in accordance with the fight result.

Then, the CPU 101 of the main control section 100 transmits an instruction signal for displaying the image showing a fight state to the CPU 131 of the control section 130 set to the satellites A and B in accordance with the fight result decided in step S160 (step S161).

The CPU 131 receiving the instruction signal transmits a drawing instruction to the VDP 136. The VDP 136 reads necessary image data from the image data stored in the ROM 132 in accordance with the drawing instruction supplied from the CPU 131, generates synthetic image data, and writes the data in the frame buffer 137. Then, the synthetic data written in the frame buffer 137 is transmitted to the image display device 14 and the images showing a state of a fight shown in FIG. 16C are displayed.

Then, the CPU 101 of the main control section 100 judges whether the current timing is the timing for ending the fight (step S162). When the CPU 101 judges that the current timing is not the timing for ending the fight, it returns the processing to step S161 and performs the processing for displaying the image showing a state of the fight on the screen 14a of the image display device 14 set to the satellites A and B.

By repeatedly executing the processings in steps S161 and S162, it is possible to display the image showing a state of the fight between the groups A and B while economically changing the image and produce a realistic fight scene.

When the CPU 101 judges in step S162 that the current timing is the timing for ending the fight, it transmits an instruction signal for displaying a fight result image to the CPU 131 of the control section 130 set to the satellites A and B in accordance with the fight result decided in step; S160 (step S163).

The CPU 131 receiving the instruction signal transmits a drawing instruction and the like to the VDP 136. The VDP 136 reads necessary image data from the image data stored in the ROM 132 in accordance with the drawing instruction and the like supplied from the CPU 131, generates synthetic image data, and writes the data in the frame buffer 137. Then, the synthetic image data written in the frame buffer 137 is transmitted to the image display device 14, and a fight result image is displayed on the screen 14a.

It is allowed to apply the processings in steps S161 to S163 not only to the satellites A and B but also to another satellite at which a strategic simulation game is performed. By performing the above operation, it is possible that a player other than the player who operates the group A and the player who operates the group B can also watch a state of the fight between the groups A and B.

Moreover, it is allowed that the image showing the above fight and a fight result image are displayed on the screen 13a of the large display device 1. In this case, a person other than the players who perform the strategic simulation game can watch a state of the fight between the groups A and B.

Then, the CPU 101 judges whether the data for a unit to be change is present in the data for the fight result stored in the RAM 103 of the main control section 100 (step S164).

When the CPU 101 of the main control section 100 judges that the data for the unit to be changed is present, it then transmits an instruction signal for displaying the image showing the data for the unit to be changed to the CPU 131 of the control section 130 set to the satellite A (step S165).

The CPU 131 receiving the instruction signal transmits a drawing instruction and the like to the VDP 136. The DVP 136 reads necessary image data from the image data stored in the ROM 132 in accordance with the drawing instruction and the like supplied from the CPU 131, generates synthetic image data, and writes the data in the frame buffer 137. Then, the synthetic image data written in the frame buffer 137 is transmitted to the image display device 14, and the image showing the data for the unit to be changed is displayed on the screen 14a.

The image for prompting to select whether to recognize the above unit as a unit belonging to the group A is included in the image showing the data for the unit to be changed.

When the processing in step S165 is executed, the CPU 101 of the main control unit 100 judges whether a command signal for changing the data for units is received (step S166).

When the CPU 101 judges that the command signal for changing the data for units is not received, it does not change the data for units to be changed to the data for units belonging to the group A but it starts the processing in step S169.

In this case, the CPU 101 of the main control unit 100 performs the processing for deleting the data for units constituting the group B serving as the data for units to be changed among the data stored in the RAM 103 or flash memory 104 or for maintaining the data for units.

When the CPU 101 judges that the command signal for changing the data for units is received, it performs the processing for changing the data for units to be changed to the data for units belonging to the group A and writing the data in a built-in-IC-chip medal stored in a predetermined place in the satellite A (step S167).

That is, the CPU 101 of the main control unit 100 performs the processing for changing an ID code and the like included in the data for units to be changed to an ID code and the like included in the data for units belonging to the group A and thereby changing the data for units to be changed to the data for units belonging to the group A, and storing the data in the RAM 133 of the control unit 130 or flash memory 138. Moreover, the CPU 101 transmits a command signal for driving the information writing device 113 set to the satellite A to the CPU 131 of the control unit 130 set to the satellite A. When the CPU 131 receives the above command signal, it performs the processing for driving the information writing device 131 and writing the data for units newly decided to belong to the group A in a built-in-IC-chip medal stored in a predetermined place of the satellite A.

Moreover, the CPU 101 of the main control unit 100 performs the processing for deleting the data for units constituting the group B serving as the data for units to be changed among the data stored in the RAM 103 or flash memory 101.

Thereafter, the CPU 101 of the main control unit 100 performs the processing for paying out a built-in-IC-chip medal (step S168). That is, the CPU 101 transmits a command signal for driving the built-in-IC-chip medal paying-out device 114 to the CPU 131 of the control unit 130 set to the satellite A. When the CPU 131 receives the above command signal, it pays out the built-in-IC-chip medal in which the data for units newly decided to belong to the group A is written from a built-in-IC-chip medal outlet.

As a result, a player who operates the group A can obtain the built-in-IC-chip medal in which the data for units newly decided to belong to the group A is stored.

When the processings in steps S167 and S168 are executed, the main control unit 100, control unit 130 set to the satellite A, information writing device 113, and built-in-IC-chip medal paying-out device 114 function as a built-in-IC-chip medal paying-out means because a predetermined condition is satisfied while a game progresses.

It is allowed to repeatedly execute the processings in the above steps S164 to S168 in accordance with the number of present data values when a plurality of data values for units to be changed are present.

When the CPU 101 judges in step S164 that the data for units to be changed are not present, in step S166 that a command signal for changing the data for units is not received, or executes the processing in step S168, it judges whether a group for which a fight is started (group B for the above described example) wins a victory in accordance with the fight result obtained in step S160 (step S169).

When the CPU 101 judges that the group for which the fight is started (group B) wins a victory, it performs the processing for paying out some or all of the medals paid as a challenge cost in step S149 (step S170).

That is, the CPU 101 decides the number of medals to be paid out among the medals paid as the challenge cost and then, transmits a command signal for paying out the medals to the CPU 131 of the control unit 130 set to the satellite.

When the CPU 131 receives the command signal, it transmits the command signal to the hopper 121 and thereby, drives the hopper 121 and makes the hopper 121 pay out the medals. When the medal detecting section 122 detects a medal paid out from the hopper 121, it transmits a detection signal to the CPU 131.

The CPU 131 stores the frequency of receiving detection signals in the RAM 133 whenever receiving a detection signal and when judges that the frequency of receiving detection signal reaches a predetermined frequency, it transmits a command signal for stopping paying-out of medals to the hopper 121. As a result, paying-out of medals by the hopper 121 is stopped. When the CPU 131 judges that the group for which a fight is started does not win a victory or executes the processing in step S170, it ends this subroutine.

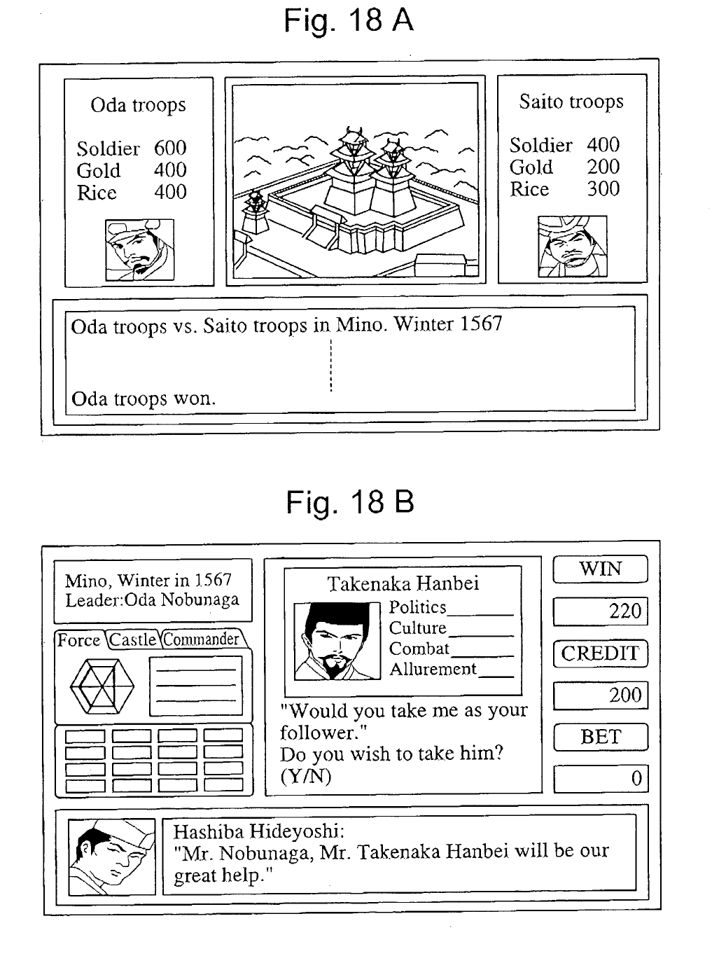

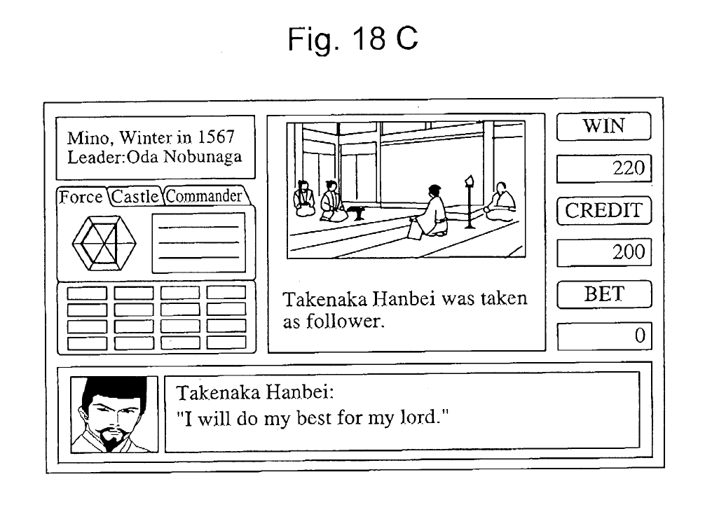

FIGS. 18A to 18C are illustrations schematically showing screen images displayed on the screen 14a of the image display device 14 set to the satellites or satellite A and/or B when the subroutine shown in FIGS. 17A and 17B is executed.

As described above, when the processings in steps S161 to S162 of the subroutine shown in FIG. 17A are executed, the images shown in FIG. 16C are displayed on the screen 14a of the image display device 14 set to the satellites A and B and the process of the fight between the groups A and B is displayed. However, thereafter when the fight between the groups A and B ends and step S163 is executed, the images shown in FIG. 18A are displayed.

The screen images shown in FIG. 18A are fight result images to be displayed on the screen 14a of the image display device 14 of the satellites A and B when step S163 of the subroutine shown in FIG. 17A is executed.

Images showing ability values of the whole group A (obtained by digitizing a force size, gold, and rice) are displayed at the top left of the screen and images showing ability values of the whole group B are displayed at the right of the screen. Moreover, images showing states in which the siege combat between the groups A and B is performed are displayed at the central portion of the screen. Furthermore, images of “1567 Winter Mino Fight between Oda troops and Saito troops” and “Oda troops wins a victory.” are displayed at the lower side of the screen as images showing the result of the fight between the groups A and B.

The screen images shown in FIG. 18B are screen images to be displayed on the screen 14a of the image display device 14 set to the satellite B when step S165 of the subroutine shown in FIG. 17B is executed.

The images {1567 Winter Mino” displayed at the top left of the screen are images showing imaginary year and season and the location of the group A in a strategic simulation game and the image “Leader: Oda Nobunaga” displayed below the above images is an image showing that the leader of the group A to be operated by a player who performs the strategic simulation game is Oda Nobunaga. Moreover, the image showing the ability value of the group A to be operated by a player who performs the strategic simulation game at the satellite A is displayed below the above image.

Images of “WIN”, “220”, “CREDIT”, “200”, “BET”, and “0” are displayed at the right of the screen and these images show that the accumulated number of medals obtained by a player who performs the strategic simulation game at the satellite B is 220, the number of points stored in the RAM 133 OF the satellite A is 200, and the challenge cost stored in the RAM 133 of the satellite A is 0 point.

On the midsection of the screen, data concerning “Takenaka Hanbei,” a unit which was belonging to the group B is displayed, along with an image of the line of “Takenaka Hanbei,” “Prithee I shall be grateful if you could make me your follower.” Moreover, an image of an operational procedure showing, “Do you wish to have him as your follower?” will be displayed, along with an image of the options illustrating, “(YIN),” in response to the operational procedure.

Also on the lower side of the screen, an image illustrating an advise, “Mister Nobunaga, Mister Takenaka Hanbei will be our great force,” which is given by “Hashiba Hideyoshi,” a unit belonging to the group A, to the leader “Oda Nobunaga,” is displayed.

Hereupon, if “Y” is selected, “Takenaka Hanbei” can be included as a unit to be belonging to the group A.

When the image illustrated in FIG. 18B is displayed, an image on the screen illustrated in FIG. 18C is displayed on the screen 14a of the image display device 14 of the satellite A in response to that the “Y” has been selected from the two options.

The images displayed on the upper left and the upper right of the screen are the same as the image shown in FIG. 18B, of which the explanations have already been done. Therefore the explanation for this is omitted here.

On the center portion of the screen is displayed an image where “Oda Nobunaga” of the leader of the group A dialogues with “Takenaka Hanbei” of an unit newly belonging to the group A, and also is displayed an image where “Takenaka Hanbei goes in for a feudatory”.

Moreover, on the lower part of the screen is displayed an image where “I effort to serve for my lord.” as the part of “Takenaka Hanbei”.

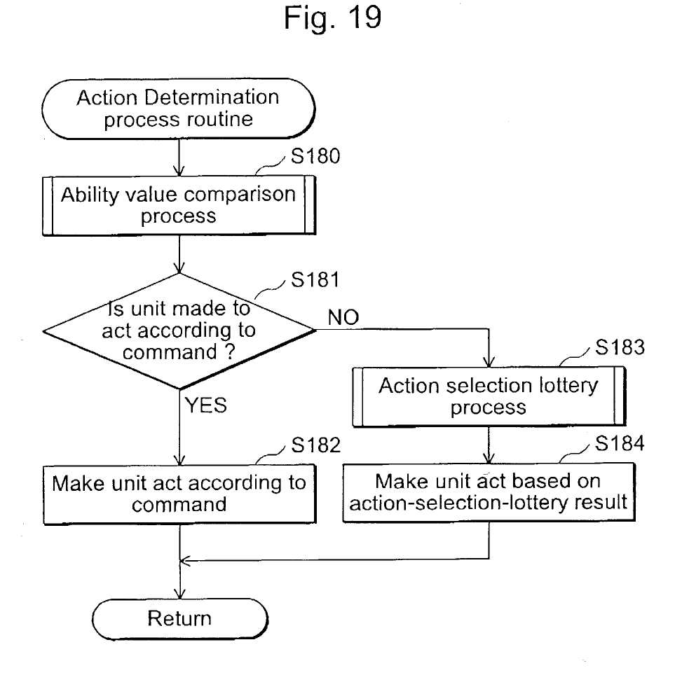

FIG. 19 is a flow chart showing a subroutine for determining an unit action of a group in the main control unit 100 of the medal gaming machine 10.

The subroutine is executed by being called from the control program for controlling the strategic simulation game of the medal gaming machine 10 executed in advance by receiving the input of the command for the unit of the group in the strategic simulation game.

If the command for one unit of the group A is inputted though the control section 15 of the satellite A, the CPU 131 of the control unit 130 provided on the satellite A transmits a signal indicating the input of the command for one unit of the group A to the CPU 101 of the main control unit 100. The CPU 101 of the main control unit 100, when receiving the signal, executes on the basis of the comparison processing of the leader's ability value of the group A and the unit's ability value of the group A among the data stored in the RAM 103 of the main control unit 100 or the flash memory 104 (step S180).

Although the comparison processing method of the ability value is specially limited, for example, as one of the ability values for the leader of the group, an “appeal” which is an ability to submit units is set. If a “loyalty” which is an ability obedient to the leader is set as one of ability values for an unit of the group, the above method adds the “appeal” of the leaders ability value and the “loyalty” of the unit's ability value, and also executes samplings of random numbers to obtain numbers within a given region (for example, 1 to 100). In addition, it compares a sum of the added number and a number obtained by sampling of random numbers with a criterion number (for example, 200), and decides whether to make the unit act based on the command or not by determining whether to surpass this criterion number or not.

In the above example, if the “appeal” of the leader's ability value of the group A is 80, the “loyalty” of the unit's ability value of the group A is 90, and the number value obtained by sampling of random numbers is 50, the sum is 230, so the method decides to make the unit of the group A act based on the command. On the other hand, if the number value obtained by sampling of random numbers is 20, the sum is 190, so it is decided not to make the unit of the group A act based on the command.

Next, the CPU 101 of the main control unit 100 judges on the basis of the result of the comparison processing of the ability value whether to make the unit act according to the command or not (step S181).

The CPU101 makes the unit act according to the inputted command when judging to make the unit act according to the command (step S182).

For instance, if the command for making one unit of the group A go in for the fight is inputted through the control unit 15 of the satellite A, when judging to make the unit go in for the fight in the step S181, the CPU101 advances the strategist simulation game by making one unit of the group A go in for the fight in the step S182.

On the other hand, in the step S182, the CPU 101 executes the action selection draw processing when judging not to make the unit act according to the command (step S183). For example, in the action selection draw processing theS main control unit 100 stores in advance a plurality of the probability tables for determining the action of unit corresponding to random number in the ROM 102 of the main control unit 100 or the like, and sets the probability table according to the inputted command to the RAM 103 of the main control unit 100 or the like. Thereafter the main control unit 100 executes the action selection draw processing by sampling random numbers.

For example, if the inputted command is one for making an unit of the group A go in for the fight, the probability table for determining the unit action such as “not to go in for the fight”, “to go over to the group of the fighting opponent” is set corresponding to random numbers. After that, the CPU 100 can decide the unit action of the group A by sampling random numbers.

Next, the CPU 101 makes the unit act based on the result of the action selection draw (step S184).

For example, in the case where the command for making one of units belonging to the group A go in for the fight is inputted through the control unit 15 of the satellite A, the CPU 101 executes the action selection draw in the step S183 when judging not to make the unit act according to the above command in the step S181. At the result of the action selection draw, if one unit of the group A is judged “not to go in for the fight”, the CPU 101 advances the strategic simulation game without making one unit of the group A go in for the fight.

The present subroutine is finished when the processing of the step S182 is executed, or when the processing of the step S184 is executed.

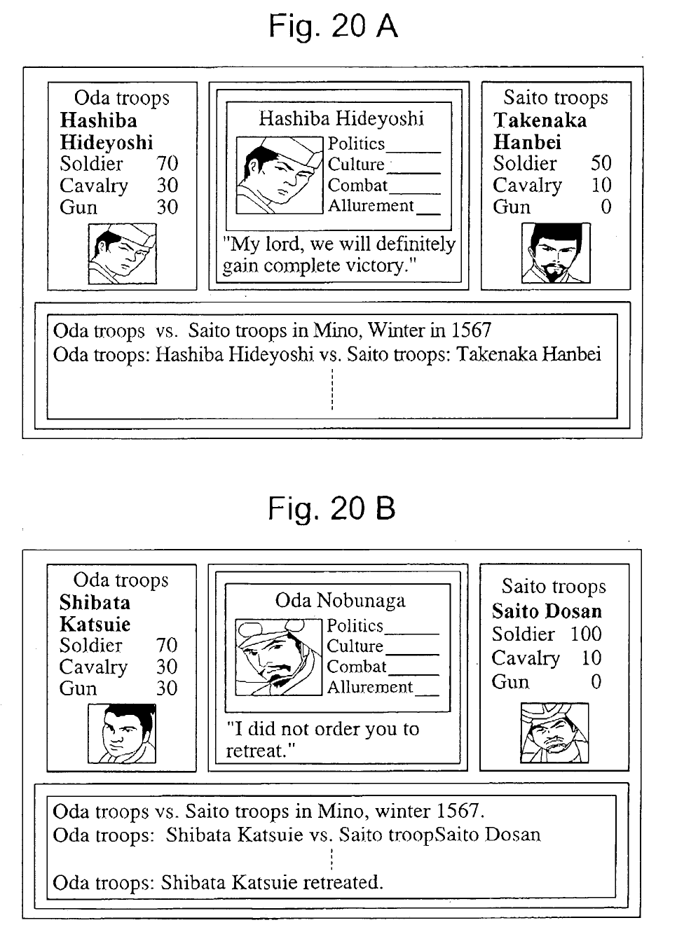

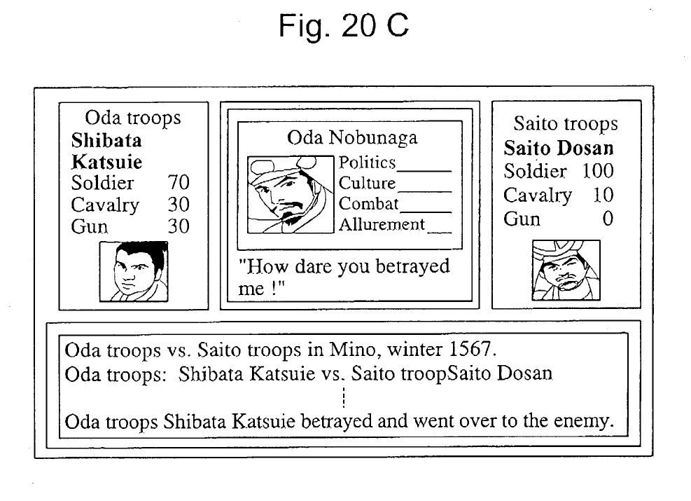

FIG. 20A to FIG. 20C show example models of picture image which are displayed on the screen 14a of the image display device 14 provided in the groups A and B when the subroutine shown in FIG. 19 is executed after the picture image shown in FIG. 16B is displayed and the combat is started between the group A and the group B.

The picture image shown in FIG. 20A is an example of a picture image which is displayed when the combat is started between the group A lead by the leader “ODA Nobunaga” and the group B lead by the leader “SAITO Dosan” after a command for enrolling the units “HASHIBA Hideyoshi” and “SHIBATA Katsuie” under the group A as the participants in the combat and it is decided in the step S181 of the subroutine shown in FIG. 19 that the unit “HASHIBA Hideyoshi” is to take action following the inputted command.

An image showing the data in regards to the unit “HASHIBA Hideyoshi” under the group A is displayed at the upper left of the screen while the data in regards to a unit “TAKENAKA Hanbei” under the group B is displayed at the upper right of the screen.

Moreover, at the center of the screen, “My lord, we will definitely gain a complete victory.” is displayed as a line of the unit “HASHIBA Hideyoshi” under the group A showing the run of events that the unit “HASHIBA Hideyoshi” takes action following the inputted command.

Further, displayed at the bottom of the screen is an image showing the development of the combat fought between the unit “HASHIBA Hideyoshi” under the group A and the unit “TAKENAKA Hanbei” under the group B.

The picture image shown in FIG. 20B is an example of a picture image which is displayed when the combat is started between the group A lead [led] by the leader “ODA Nobunaga” and the group B lead by the leader “SAITO Dosan” after a command for enrolling the units “HASHIBA Hideyoshi” and “SHIBATA Katsuie” under the group A as the participants in the combat is inputted and it is decided in the step S181 of the subroutine shown in FIG. 19 that the unit “HASHIBA Hideyoshi” is to take action not following the inputted command.

An image showing the data in regards to the another unit “SHIBATA Katsuie” under the group A is displayed at the upper left of the screen while an image showing the data in regards to “SAITO Dosan” who is the leader of the group B is displayed at the upper right of the screen.

Further, displayed at the bottom of the screen is an image showing the development of the combat fought between the unit “SHIBATA Katsuie” under the group A and “SAITO Dosan” as the leader of the group B. At the very bottom, an image of “SHIBATA Katsuie of ODA Corps has retreated.” is displayed showing the run of events that the unit “SHIBATA Katsuie” takes action not following the inputted command.

In addition, at the center of the screen, “I have not ordered you to retreat.” is displayed as a line of “ODA Nobunaga” as the leader of the group A.

The picture image shown in FIG. 20C is another example of a picture image which is displayed when the combat is started between the group A led by the leader “ODA Nobunaga” and the group B led by the leader “SAITO Dosan” after a command for enrolling the units “HASHIBA Hideyoshi” and “SHIBATA Katsuie” under the group A as the participants in the combat is inputted and it is decided in the step S181 of the subroutine shown in FIG. 19 that the unit “HASHIBA Hideyoshi” is to take action not following the inputted command.

An image showing the data in regards to the unit “SHIBATA Katsuie” under the group A is displayed at the upper left of the screen while an image showing the data in regards to “SAITO Dosan” who is the leader of the group B is displayed at the upper right of the screen.

Displayed at the bottom of the screen is an image showing the development of the combat fought between the unit “SHIBATA Katsuie” under the group A and “SAITO Dosan” as the leader of the group B. At the very bottom, an image of “SHIBATA Katsuie of ODA Corps has betrayed and gone over to the enemy” is displayed showing the run of events that the unit “SHIBATA Katsuie” takes action not following the inputted command.

In addition, at the center of the screen, “How dear you betrayed me!” is displayed as a line of “ODA Nobunaga” as the leader of the group A.

[4] A Step of Interrupting the Ongoing Combat Simulation Game

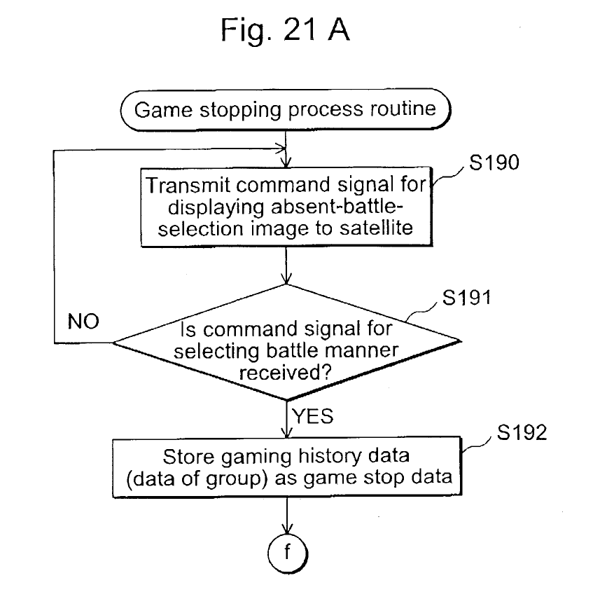

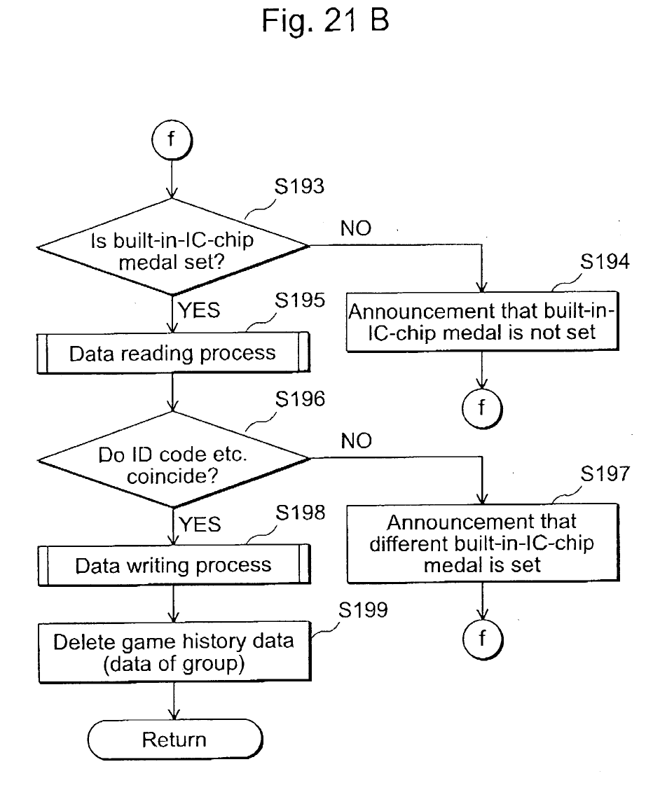

FIG. 21A and FIG. 21B are flowcharts showing the subroutine which is executed for interrupting the ongoing combat simulation game in the main control unit 100 of the medal operated gaming machine 10.

Upon receiving the command signal for interrupting the combat simulation game through the control unit 15 provided in one satellite (satellite A), the subroutine is called to be executed from the control program for controlling the combat simulation game of the medal machine 10, which has been already executed.

First, a command signal for displaying an absentee match selection image is transmitted to the CPU 131 of the control unit 130 provided in the satellite A (step S190).

The CPU 131, upon receiving the command signal, transmits a drawing command and the like to the VDP 136. According to the drawing command and the like from the CPU 136, the VDP 136 reads out the necessary image data from the image data stored in the ROM 132, generates a composite image data so as to write it onto the frame buffer 137. Then, the composite image data written onto the frame buffer 137 is transmitted to the image display device 14 and the absentee match selection image is displayed on the screen 14a.

The above described absentee match selection image is an image for letting the player select the manner of fighting the combat to be fought between the group A and another group after the player of the group A interrupts the game. The absentee match selection image contains an image showing one, two, or more manners of fighting as selections. Examples of the combat manners, which can be selected from the absentee match selection image, may be the same as those of the match selection image described above, which can be selected.

When the player controls the control unit 15 and inputs a command for selecting the combat manner for the absentee match, the CPU 101 of the main control unit 100 stores the data in regards to the selected combat manner for the absentee match in the RAM 103 or the flash memory 104 of the main control unit 100 as the game interruption data.

Next, it is judged whether or not a command signal for selecting the combat manner has been received (step S191). When it is judged that the command signal for selecting the combat manner has not been received, the CPU 101 of the main control unit 100 returns the processing to the step S191.

On the other hand, when it is judged in the step S191 that the command signal for selecting the combat manner has been received, the history data of the game of the player operating the group A (the data in regards to the group A) is stored as the game interruption data (Step S192). In other words, the CPU 101 of the main control unit 100 stores the history data of the game of the player operating the group A (the data in regards to the group A), which has been stored in the RAM 103 or the flash memory 104, in the flash memory 104 as the game interruption data.

Next, the CPU 101 judges whether or not the medal with the built-in IC chips 30 are provided (FIG. 21B, step S193).

In other words, the CPU 101 transmits a command signal for recognizing the built-in-IC-chip medal 30 to the CPU 131 of the control unit 130 provided in the satellite A. Upon receiving the command signal, the CPU 131 transmits a command signal for recognizing the built-in-IC-chip medal 30 to the information reading/writing device 112.

The information reading/writing device 112 after receiving the command signal performs processing for recognizing the built-in-IC-chip medal 30 and transmits a response signal to the CPU 131 when recognizing the built-in-IC-chip medal 30. Further, the CPU 131 after receiving the response signal transmits a response signal to the CPU 101 of the main control unit 100.

The CPU 101 of the main control unit 100 judges whether or not the built-in-IC-chip medal 30 are provided in the concave part 19 of the built-in-IC-chip medal placing stand 20 provided in the satellite A based on the fact whether or not the response signal has been received.

In the case where the history data of the game (the data in regards to the group A), which is stored as the game interruption data, contains the data in regards to a plurality of units, the combat simulation game is to have been played by the number of built-in-IC-chip medals in accordance with the number of the units. Thus, the CPU 193 judges whether or not the number of built-in-IC-chip medals in accordance with the number of the units are provided.

When it is judged in the step S193 that the built-in-IC-chip medals is not provided, it is so notified (step S194) and the processing is returned to the step S193. Such notification can be achieved, for example, by displaying a specific image showing a warning (e.g., “medal memory is unset”) on the screen 14a of the image display device 14.

On the other hand, when it is judged in the step S193 that the built-in-IC-chip medals are provided in the concave part 19 of the built-in-IC-chip medal placing stand 20 of the satellite A, data reading processing is performed (step S195).

In the data reading processing, the CPU 101 transmits a command signal for reading out the data stored in the built-in-IC-chip medals to the CPU 131. On the other hand, the CPU 131 of the control unit 130 provided in the satellite A drives the information reading/writing device 112 so as to perform the processing for reading out the data stored in the built-in-IC-chip medals for storing the read data in the RAM 133.

Then, the CPU 101 of the main control unit 100 judges whether or not the ID code and the like contained in the read date and the ID code and the like contained in the game interruption data are consistent (step S196). In other words, the CPU 101 obtains the ID codes and the like from the data stored in the RAM 133 in the step S195 and the history data of the game stored in the step S192 so as to judge whether the both are consistent or not.

When it is judged that the both are not consistent, the built-in-IC-chip medal provided in the built-in-IC-chip medal placing stand 20 are different from the built-in-IC-chip medal provided before the combat simulation game is started and the like. Thus, the CPU 101 notifies that different built-in-IC-chip medals are provided and returns the processing to the step S193. Such notification can be achieved, for example, by displaying a specific image showing a warning (e.g., “Different medal memory is set”) on the screen 14a of the image display device 14.

On the contrary, when it is judged in the step S196 that the ID code and the like contained in the read data and the ID code and the like contained in the game interruption data are consistent, the same built-in-IC-chip medals as the ones provided before the combat simulation game is started and the like are provided in the built-in-IC-chip medal placing stand 20. Thus, the CPU 101 performs the data writing processing (step S198).

In the data writing processing, the CPU 101 transmits a command signal for writing the game interruption data onto the built-in-IC-chip medals and, at the same time, stores the game interruption data in the RAM 133 of the satellite A. On the other hand, the CPU 131 of the control unit 1 30 provided in the satellite A, upon receiving the above-described command signal, drives the information reading/writing device 112 so as to write the game interruption data stored in the RAM 133 onto the built-in-IC-chip medals.

In the steps S195 and S198, the main control unit 100, and the control unit 130 and the information reading/writing device 112 provided in the satellite A function as data reading/writing means which perform writing of at least either the initial data of the game or the history data of the game onto the built-in-IC-chip medals and reading of at least either the initial data of the game or the history data of the game from the built-in-IC-chip medals.

Subsequently, the CPU 101 deletes the history data of the game (the data in regards to the player operating the group A) among the data stored in the RAM 103 or the flash memory 104 of the main control unit and the data stored in the RAM 133 or the flash memory 138 of the control unit 130 provided in the satellite A except for the data stored as the game interruption data (step S199) and the subroutine is completed.

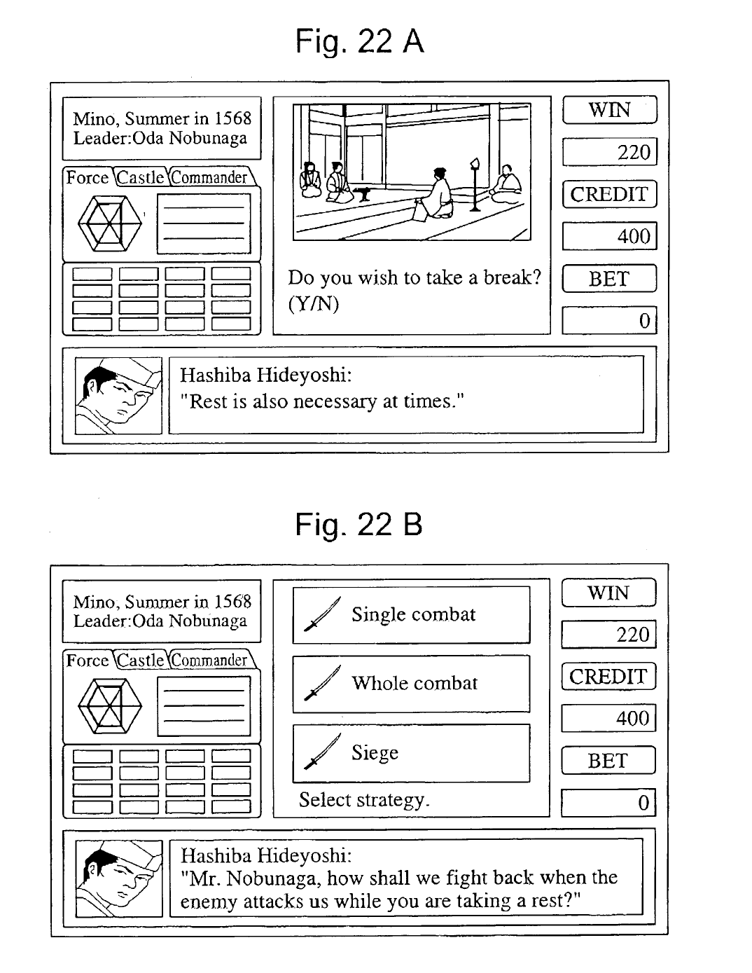

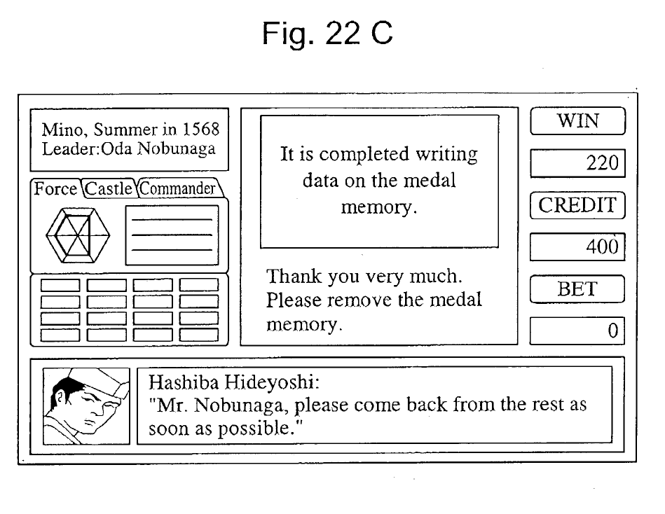

FIG. 22A-FIG. 22C show schematically an example of the screen image displayed on the screen 14a of the image display device 14 installed in the satellite A when an ongoing strategic simulation game is stopped.

The screen image shown in the FIG. 22A is the screen image displayed on the screen 14a of the image display device 14 installed in the satellite A before the subroutine shown in FIG. 21A and FIG. 21B is executed.

The image “1568 Summer Mino ” displayed at the top left of the screen is an image that shows a imaginary year, season, and the location of the group A in the strategic simulation game, while the image “Leader: Oda Nobunaga” displayed below is an image showing that the leader of the group A operated by the player who is playing the strategic simulation game on the satellite A. In addition, an image that indicates the ability value of the group A operated by the player who is playing the strategic simulation game on the satellite A is displayed below this.

Moreover, images such as “WIN”, “220”, “CREDIT”, “400”, “BET”, and “0” are displayed at the top right of the screen, and these images show respectively that the accumulated number of medals acquired by the player who is playing the strategic simulation game on the satellite B is 220 pieces, the number of points stored in the RAM133 of the satellite A is 200 points, and the challenge fee stored in the RAM133 of the satellite A is 0 point.

An image that shows the dialog scene between the leader of the group A, “Oda Nobunaga” and an unit belonging to the group A “Hashiba Hideyoshi” is displayed in a central part on the screen, and an image showing an operating procedure, “Do you wish to take a break?” or “Do you want to stop the game?”, is displayed, and an image showing the choice of “(Y/N)” corresponding to the operating procedure, is displayed.

Moreover, an image that shows an advice “The rest is also necessary at times” that an unit belonging to the group A “Hashiba Hideyoshi” gives the leader “Oda Nobunaga”, is displayed at the bottom of the screen.

At this time, when the player inputs an instruction to select “Y” through the control section 15 installed in the satellite A, the CPU131 in the control unit 130 disposed in the satellite A sends an instruction signal that shows that the instruction to stop the strategic simulation game was input to the CPU101 in the main control unit 100.

When this instruction signal is received, the CPU101 in the main control unit 100 executes the subroutine shown in FIG. 21A and FIG. 21B.

The screen image shown in FIG. 22B is an absent fight selection image displayed on the screen 14a of the image display device 14 installed in the satellite A when the processing of step S190 of the subroutine shown in FIG. 21A is executed.

The image displayed at the top right and at the top left of the screen is similar to the image shown in FIG. 22A, and it has been explained; therefore, the explanation here shall be omitted.

The image “Sir (means Nobunaga), by which method shall we fight back when attacked by the enemy while you are taking the rest?” is displayed at the bottom of the screen as a speech of one unit “Hashiba Hideyoshi” that belongs to the group A, and moreover, images that show the combat manners “Sigle combat” (or “Man-to-man fight”), “Whole combat”, and “Siege”, are sequentially displayed from the top in this order, in the central part on the screen, and an image that shows the operating procedure “Please select the strategy”, is displayed below them.

At this time, the player, can fight during the absence by the combat manner selected by the operation of control section 15 of the satellite A, and the selection of the image that shows the desired combat manner.

The screen image shown in FIG. 22C is a screen image displayed on the screen 14a of the image display device 14 installed in satellite A when the processing of the step S198 of the subroutine shown in FIG. 21B is executed.

The image displayed at the top right and at the top left of the screen is similar to the image shown in FIG. 22A, and it has been explained; therefore, the explanation here shall be omitted.

An image that shows the progress status report of processing “It is completed writing data on the medal memory.”, is displayed, and another image showing the operating procedure “Thank you very much. Please remove the medal memory.” is displayed in the central part of the screen Moreover, the image “Sir (Nobunaga), please return from the rest as soon as possible.” is displayed at the bottom of the screen as a speech of one unit “Hashiba Hideyoshi” that belongs to the group A.

The strategic simulation game is executed continuously with the presence of the group A in the medal operated gaming machine 10 though the strategic simulation game is stopped in the satellite A when the subroutine shown in FIG. 21A and FIG. 21B is executed, and the screen image shown in FIG. 22C is displayed.

And, when an instruction that a player playing the game in the other satellite challenges the group A to a fight is input by that player during the absence of the group A, the fight will be done in the steps S190-S191 by the combat manner selected beforehand.

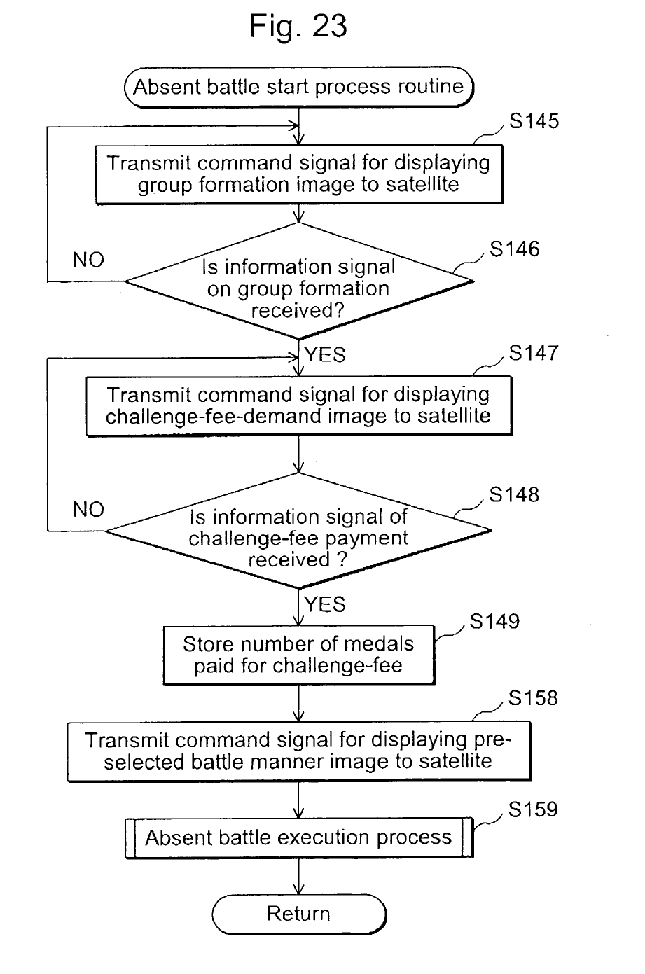

FIG. 23 is a flow chart that shows a subroutine to be executed when the strategic simulation game progresses.

In the explanation of FIG. 23, it is assumed that the group operated by the player who has stopped the strategic simulation game be the group A, the group that challenges the group A to a fight is called the group C, and the satellite where the player operating the group C plays the strategic simulation game, is assumed to be the satellite C.

The subroutine shown in FIG. 23 is a subroutines to be executed in the main control unit 100 upon reception of a instruction that the player playing the game on the satellite C challenges the group A where the player is absent to a fight, by the operation of the control section 15, namely, a subroutine to be called and executed in the step S144 of the flow chart shown in FIG. 14A.

In the flow chart shown in FIG. 23, the same symbol is affected to the step where a processing similar to the flow chart shown in FIG. 14A and FIG. 14B is performed.

When the absent fight start processing routine is started, the CPU11 in the main control unit 100 transmits an instruction signal to display the group organization image to the CPU131 in the control unit 130 disposed in the satellite C (step S145). Note that the processing to be executed in the step S145 is a processing similar to the processing executed in the step S145 of the subroutine shown in FIG. 14A, and has already been explained; therefore, the explanation thereof shall be omitted here.

Next, the CPU101 judges whether to have received the information signal concerning the group organization or not (step S146). The processing is returned to the step S146 when it is judged that the signal concerning the group organization has not been received.

On the other hand, the CPU101 of the main control unit 100 transmits an instruction signal to display the challenge fee demand image to the CPU131 in the control unit 130 disposed in the satellite C, when it is judged that the information concerning the group organization, was received in the step S146 (step S147).

Next, CPU101 judges whether to have received the information signal that the challenge fee is paid or not(step S148).

It returns the processing to the step S148, when it is judged that the information signal that the challenge fee is paid has not been received.

On the other hand, the CPU11 stores the number of medals paid as challenge fee (number of points) in the RAM103 or flash memory 104 in the step S148 when it is judged that the information signal that the challenge fee is paid was received (step S149).

Note that the processing of the steps S145-S149 mentioned above is similar to the processing of the steps S145-S149 of the subroutine shown in FIG. 14A and FIG. 14B and has already been described; therefore, the explanation thereof shall be omitted this time.

Next, the CPU11 of the main control unit 100 transmits an instruction signal to display the image concerning the combat manner selected beforehand (step S158).

The CPU131, that receives this instruction signal, transmits a drawing instruction and so on to the VDP136. Upon the drawing instruction and so on from the CPU131, the VDP136 reads out necessary image data among the image data stored in the ROM132, generates the synthetic image data, and writes it in the frame buffer 137. Afterwards, the synthetic image data written in the frame buffer 137 is transmitted to the image display device 14 and the image that shows the combat manner that was selected beforehand will be displayed on the screen 14a.

Afterwards, the absent fight execution processing described later is executed (step S159) to terminate this subroutine.

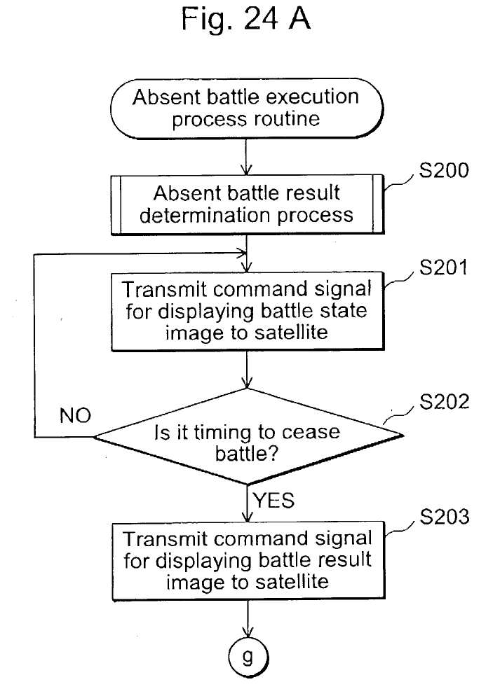

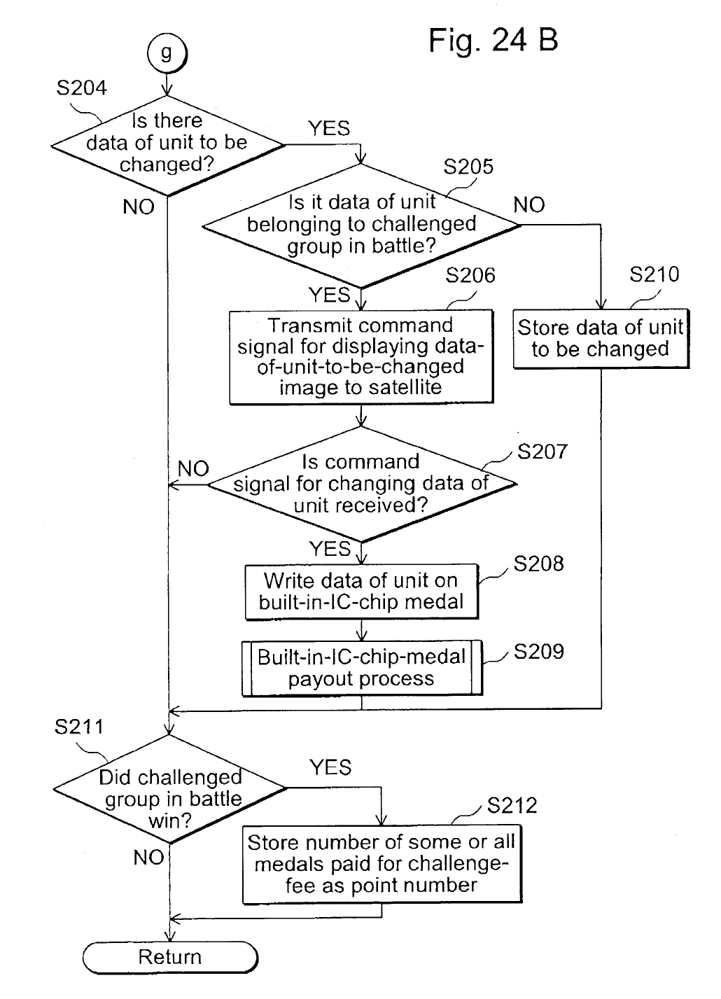

FIG. 24A and FIGS. 24 and B are flow charts that show the subroutine that is called and executed in the step S159 of the subroutine shown in FIG. 23.

First of all, CPU101 in the main control unit 100 performs the absent fight result decision processing (step S200).

This absent fight result decision processing is a processing where the CPU101 of the main control unit 100 decides the results of the fight of the group C and the group A based on the data concerning the group C, the data concerning the group A during the absence of the player and the data concerning the combat manner selected beforehand in the steps S190-S191 of the subroutine shown in FIG. 21A. Moreover, data concerning group A during the absence of the player is included in the game stop data stored in the flash memory 104 in the step S192 mentioned above. Note that the absent fight result decision processing is a processing substantially similar to the fight result decision processing mentioned above and has already been described; therefore, the explanation here shall be omitted.

Next, the CPU101 transmits the instruction signal to display the image that shows the scene of the fight to the CPU131 in the control unit 130 disposed in the satellite C (step S201). As a result, for instance, an image similar to the image shown in FIG. 16C will be displayed on the screen 14a of the image display device 14 disposed in the satellite C.

Next, the CPU11 judges whether it is the timing to end the fight (step S202). The CPU101 returns the processing to the step S202, and processes to display the image that shows the scene of fight on the screen 14a of the image display device 14 installed disposed in the satellite C when it judges that it is not the timing for ending the fight.

On the other hand, the CPU101 transmits an instruction signal to display the fight result image to the CPU131 in the control unit 130 disposed in the satellite C when it judges that it is the timing to terminate the fight (step S203).

Note that the processing in the step S203 is a processing similar to the processing in the step S163 of the subroutine shown in FIG. 17A, and has already been described; therefore, the explanation here shall be omitted.

Next, it is judged whether the data concerning the unit that should be changed exist in the data concerning the results of the fight stored in the RAM103 of the main control unit 100 (step S204).

When it is judged that data concerning the unit that should be changed exists in the step S204, next, the CPU101 of the main control unit 100 judges whether data concerning the unit that should be changed is data concerning the unit that belongs to the group which is challenged in a fight (group A) (step S205).

The CPU101 of the main control unit 100 transmits an instruction signal to display the image that shows data concerning the unit that should be changed to the CPU131 of the control unit 130 disposed in the satellite C in the step S205, when it is judged that data concerning the unit that should be changed is the data concerning the unit that belongs to the group which is challenged in a fight (group A) (step S206).

The CPU131, that receives this instruction signal, transmits a drawing instruction and so on to the VDP136. The VDP136 reads out necessary image data by the drawing instruction and so on from the CPU131 from the image data stored in the ROM132, generates synthetic image data and write it into the frame buffer 137. Afterwards, the synthetic image data written in the frame buffer 137 is transmitted to the image display device 14, and the image that shows data concerning the unit that should be changed will be displayed on the screen 14a.

An image prompting to select whether to make the above-mentioned unit an unit that belongs to the group A is included in the image that shows data concerning this unit that should be changed.

Afterwards, the CPU131 judges whether to have received the instruction signal to change data concerning the unit or not (step S207).

The CPU101 in the main control unit 100 does not change the data concerning the unit that should be changed to data concerning the unit that belongs to the group C, and advances the processing to the step S169, when it is judged that the instruction signal to change the data concerning the unit was not received, namely when it is judged that an instruction signal not to change data concerning the unit was received.

At this time, the CPU11 of the main control unit 100 deletes data concerning the unit that composes the group A that became data concerning the unit that should be changed among the data stored in the RAM103 or flash memory 104 or processes to maintain is as it is.

When it is judged that the instruction signal to change the data concerning the unit was received, next, the data concerning the unit that should be changed is changed to the data concerning the unit that belongs to the group C, and processed to be written into the built-in-IC-chip medal stored in a prescribed part in the satellite C (step S208).

Namely, the CPU101 of the main control unit 100 changes the data concerning the unit that should be changed to the data concerning the unit that belongs to group C by changing the ID code and so on included in the data concerning the unit that should be changed to the ID code and so on included in data concerning the unit that belongs to the group C, and processes to make it be stored in the RAM133 in the control unit 130 disposed in the satellite C or flash memory 138. Moreover, the CPU11 transmits an instruction signal to drive an information writing device 113 installed in the satellite C to the CPU131 in the control unit 130 disposed in the satellite A. When the CPU131 receives the above-mentioned instruction signal, it drives the information writing device 113, and writes the data concerning the unit that newly came to belong to the group C in the built-in-IC-chip medal stored in a prescribed part of the satellite A.

In addition, the CPU101 of the main control unit 100 deletes the data concerning the unit configuring the group A that became data concerning the unit that should be changed from the data stored in the RAM103 or flash memory 104.

Thereafter, the CPU101 of main control unit 100 performs a processing of paying out the built-in-IC-chip medal (step S209). In short, the CPU101 transmits an instruction signal to drive the built-in-IC-chip medal pay-out device 114 to the CPU131 in the control unit 130 disposed in the satellite C. When the above-mentioned instruction signal is received, the CPU131 pays out the built-in-IC-chip medal in which data concerning the unit that came newly to belong to the group C is written from the built-in-IC-chip medal outlet installed in the satellite 12.

As a result, the player operating the group C can acquire the built-in-IC-chip medal to which data concerning the unit that came newly to belong to the group C is stored.

During the execution of the processing of these steps S208 and S209, the main control unit 100, and the control unit 130, the information wring device 113 and the built-in-IC-chip medal pay-out device 114 provided in the satellite C function as built-in-IC-chip medal pay-out means for paying out built-in-IC-chip medals, provided that prescribed conditions are satisfied while the game is progressing.

On the other hand, when it is judged that data concerning the unit that should be changed is not the data concerning the unit that belongs to the group (group A), or, that it is the data concerning the unit that belongs to the group which is challenged in a fight (group C) in the step S205, the CPU101 in the main control unit 100 makes the data concerning the unit that should be changed be stored in addition to the game stop data (data concerning the group A) stored in the flash memory 104 (step S210).

The CPU101 of the main control unit 100 judges whether the group which is challenged in a fight won or not (step S211), when it is judged that data concerning the unit that should be changed does not exist in the step S204, when it is judged that the instruction signal to change the data concerning the unit is not received in the step 209, or, when the processing of the step S209 or the S210 is executed.

A part or all of medals paid as challenge fee is added to the game stop data (data concerning the group A) stored in the flash memory 104 as a number of points and stored when it is judged that the group which is challenged in a fight (group A) won (step S212).

In the step S211, when it is judged that the group which is challenged in the fight won or when the processing of the step S212 is executed, the subroutine will be ended.

[5] Step To Resume The Stopped Strategic Simulation Game

In the aforementioned step [4], the player who paused (interrupted, canceled, stopped) the strategic simulation game (the player who operates the group A) can resume the aforementioned strategic simulation game by using the built-in-IC-chip medal in which the data related to the stop of the game is stored.

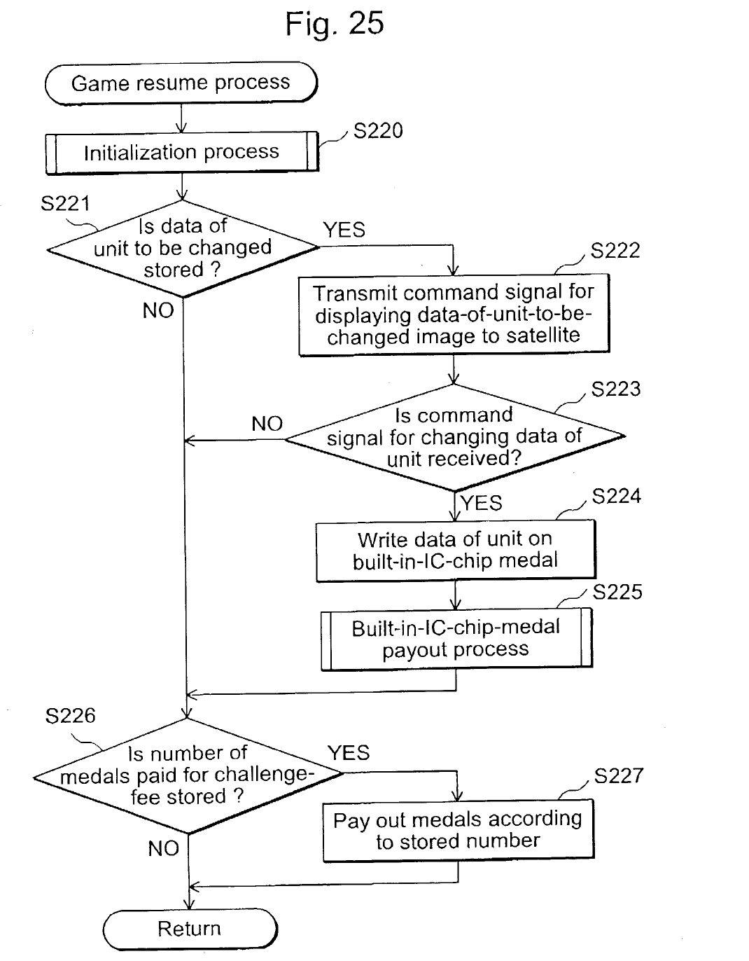

FIG. 25 is a flowchart illustrating a subroutine to be executed for the resume of the strategic simulation game, which has been stopped in the main control unit 100 of the medal operated gaming machine 10. The subroutine is the one which is read out and executed in the step S117 of the subroutine as illustrated in the FIG. 9B.

Moreover, in an explanation about the FIG. 25, the case where the player who operated the group A and stopped the game resumes the strategic simulation game is explained by executing the subroutine illustrated in the FIG. 21A and the FIG. 21B.

First of all, CPU 101 of the main control unit 100 executes the initialization processing (step S220).

This initialization processing is to resume the stopped strategic simulation game, according to the game stop data (the data concerning the group A) read in the subroutine of the step S112 shown in FIG. 9A, and the game stop data (the data concerning the group A) stored in the flash memory 104 in the subroutine of the step S192 shown in the FIG. 21A.

Secondly, the CPU 101 of the main control unit 100 judges whether the data concerning the unit to be changed is stored or not (step S221). In the above-mentioned step S210, the data concerning the unit to be changed is the one added to and stored in the game stop data (the data concerning the group A) stored in the flash memory 104. In other words, in the step S221, the CPU 101 of the main control unit 100, in the step S210, judges whether or not the data concerning the unit necessary to be changed is added and stored in the game stop data that is stored in the flash memory 104.

If it is judged that the data concerning the unit necessary to be changed is stored in the game stop data stored in the flash memory 104, the command signal for displaying the image representing the data concerning the unit necessary to be changed is sent to the CPU 131 of the controller 130 provided on the satellite A (step S222).

The CPU 131 which receives the command signal sends a draw command and so on to the VDP 136. Then, the VDP 136, based on the draw command from the CPU 131, reads a necessary image data out of the image data stored in the ROM 132, generates a composite image data, and writes into the frame buffer 137. Thereafter, the composite image data written into the frame buffer 137 is sent to the image displaying device 14, an image showing the data concerning the unit necessary to be changed is displayed on the screen 14a.

This image showing the data concerning the unit necessary to be changed includes an image, which prompts to choose whether to make the abovementioned unit belong to the group A or not.

If the process of the step S222 is executed, the next thing is to judge whether or not the command signal for changing the data concerning the unit is received (step S223).

If it is judged that the command signal for changing the data concerning the unit is not received, in other words, if the command signal that does not change the data concerning the unit is received, the CPU 101 of the main control unit 100 carries out the processing of the data concerning the unit necessary to be changed in the step S226, without changing the data related to the unit belonging to the group A.

In such a situation, the CPU 101 of the main control unit 100 either deletes the data concerning the unit comprising the group B, which becomes the data concerning the unit to be changed among the data stored in the RAM 103 or the flash memory 104 or just carries out the processing to maintain as it is. If it is judged that the command signal for changing the data concerning the unit is received, the next thing is to carry out the processing of changing the data, which concerns the unit necessary to be changed, to the data concerning the unit belonging to the group A, and then writes it into the built-in-IC-chip medal stored in a specified part within the satellite A (step S224).

In other words, by changing the ID code and so on included in the data, which concerns the unit necessary to be changed, to the ID code and so on included in the data concerning the unit belonging to the group A, the CPU 101 of the main control unit 100 carries out the processing of changing the data, which concerns the unit necessary to be changed, to the data concerning the unit belonging to the group A, and then stores it to the RAM 133 or the flash memory 138 of the controller 130 provided in the satellite A. Moreover, the CPU 101 sends a command signal for driving the information-writing device 113 provided in the satellite A to the CPU 131 of the controller 130 provided in the satellite A. As soon as the CPU 131 receives the abovementioned command signal, the CPU 131 executes the processing of driving the information-writing device 113 and of writing the data concerning the unit, which newly belongs to the group A, into the built-in-IC-chip medal stored in a specified part of the satellite A.

Moreover, the CPU 101 of the main control unit 100 also carries out the processing of deleting the data concerning the unit configuring the group B, which became the data concerning the unit to be changed, out of the data stored in the RAM 103 or the flash memory 104.

Thereafter, the CPU 101 of the main control unit 100 carries out the pay out processing of the built-in-IC-chip medal (step S225). In other words, the CPU 101 sends a command signal for driving the payout device of the medal device 114 to the CPU 131 of the controller 130 provided in the satellite A. When the CPU 131 receives the abovementioned command signal, the CPU 131 pay out the built-in-IC-chip medal in which the data concerning the unit newly belonging to the group a is written, from the pay outlet of the built-in-IC-chip medal provided in the satellite 12.

As a result, the player operating the group A can acquire the built-in-IC-chip medal in which the data concerning the unit newly belonging to the group A.

When the processing of these steps S224 and S225 are carried out, the main control unit 100, the controller 130 provided in the satellite A, information-writing device 113, and the payout device of the medal device 114 function as a payout mean of the built-in-IC-chip medal for paying out the built-in-IC-chip medal, following the fact that the specified conditions are satisfied during the progress of the game.

In addition, the processing of the abovementioned steps S221 to S225 may be repeatedly carried out depending on the number of the existing data, when there is a plurality of the data concerning the unit necessary to be changed.

When it is judged that the data concerning the unit necessary to be changed is stored in the step S221, when it is judged that the command signal for changing the data concerning the unit is not received in the step S223, or when it is judged that the processing of the step S225 is executed, the CPU 101 judges whether or not some or all of the number of the medals paid as challenge fees are stored as the number of the points in the game stop data (data concerning the group A) stored in the flash memory 104 (step S226). The data concerning the number of the medals paid as challenge fees is what is additionally stored into the game stop data stored in the flash memory 104 in the step S212.

In the step S226, when it is judged that some or all of the number of the medals paid as challenge fees are stored as the number of the points in the game stop data (data concerning the group A) stored in the flash memory 104, the CPU 101 of the main control unit 100, based on the data (data concerning the number of the medals paid as challenge fees) additionally stored in the game stop data (data concerning the group A), makes a decision on how many medals to be paid out, and then sends the command signal for paying the medal(s) to the CPU 131 of the controller 130 provided in the satellite A.

As soon as the CPU 131 receives the command signal, the CPU 131 5 drives the hopper 121 and pays out the medal(s) by sending a command signal to the hopper 121. The detecting portion 122 sends a detection signal to the CPU 131 as soon as it detects the medal issued by the hopper 121.

Every time when the CPU 131 receives the detection signal, it stores the number of times that it receives the detection signal. When the CPU 131 decides that the number of the receiving times of detection signal reaches to the specified number, payout of the medal(s) from the hopper 121 terminates. When it is judged that the group carried out a game against is not winning, or when the processing of the step S227 is executed, the whole subroutine ends.

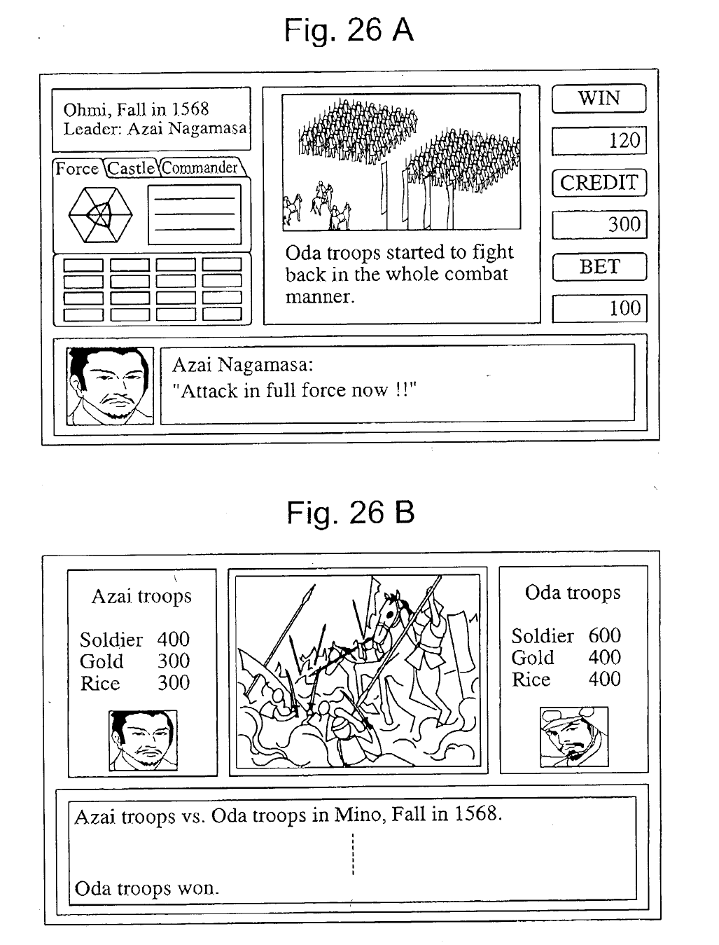

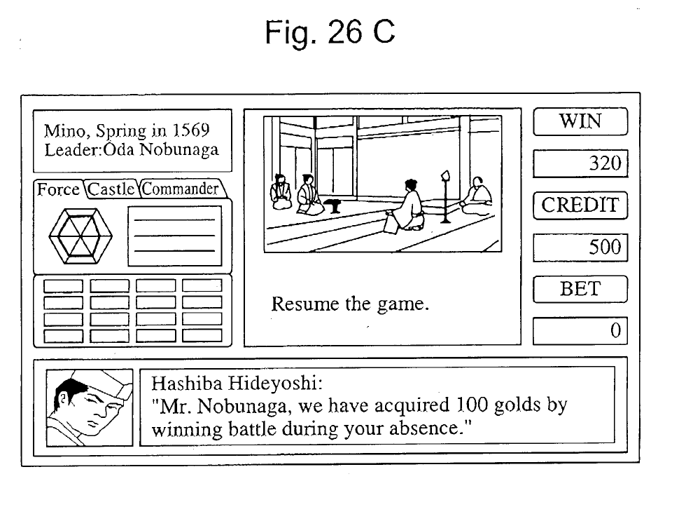

FIG. 26A to FIG. 26C are pattern diagrams schematically showing an example of the screen image displayed on the screen 14a of the image display device 14 provided in the satellite A and/or satellite C when the subroutine shown in the FIG. 23 to FIG. 25 is executed.

The screen image shown in the FIG. 26A is a pattern diagram illustrating an example of the screen image displayed on the screen 14a of the image display device 14 provided in the satellite C when the process of the subroutine of the step S158 shown in the FIG. 23 is executed.

This screen image is an image for showing the combat manner selected by the player operating the group A beforehand.

An image “1568 Fall Omi” displayed on the upper left of the screen shows an imaginary year, season, and location of the group C in a strategic simulation game. An image “Leader: Azai Nagamasa” shows that the leader of the group C operated by the player, who plays the strategic simulation game on the satellite C, is Azai Nagamasa. Moreover, an image, which shows the ability value of the group C operated by the player playing the strategic simulation game on the satellite C, is displayed below.

Furthermore, images as “WIN”, “120”, “CREDIT”, “300”, “BET”, and “100” are listed and displayed beginning at the top on the right side of the screen. These images represent that the accumulative number of the medals won by the player playing the strategic simulation game on the satellite A is 120, that the points stored in the RAM 133 of the satellite A are 300, and that the challenge fees stored in the RAM 133 of the satellite A are 100.

An image, which shows the scene where the group A “Oda troops” and the group C “Azai troops” are about to start the fight, is displayed on the central part of the screen, along with an image showing “Oda troops started to fight back in the whole combat manner.”

Moreover, an image which shows “Attack in full force now!!” as a line of the leader of the group C “Azai Nagamasa”, is displayed on the lower part of the screen.

A screen image presented in the FIG. 26B is an image displayed on the screen 14a of the image display device 14 provided in the satellite C when the processing of the subroutine of the step S203 shown in the FIG. 24A is executed.

The upper left of the screen display an image showing the ability value of the entire group C (the force of arms, gold and rice as the group's fortune are measured in numerical terms), while the left side of the screen displays an image showing the ability value of the entire group A (force strength, gold and rice measured in numerical terms). Moreover, an image which shows the scene where the group C and the group A are about to start the fight, is displayed on a midsection of the screen. And also on the lower side of the screen, images of “Azai troops vs. Oda troops in Mino. Fall 1568”, “Oda troops won.” are displayed to show the course of the fight between the group A and the group C.

A screen image presented in the FIG. 26C is a screen image displayed on the screen 14a of the image display device 14 provided in the satellite A when the processing of the subroutine of the step S217 shown in the FIG. 25 is executed.

An image, “Spring 1569, Mino”, displayed on the upper left of the screen, shows an imaginary year, season, and location of the group A in a strategic simulation game. An image “Leader: Oda Nobunaga” shows that the leader of the group A operated by the player, who plays the strategic simulation game on the satellite A, is Oda Nobunaga. Moreover, an image, which shows the ability value of the group A operated by the player playing the strategic simulation game on the satellite A, is displayed below.

An image, which shows the scene where the leader of the group A, “Oda Nobunaga,” and the unit belonging to the group A, “Hashiba Hideyoshi,” are having a conversation, is displayed on the central part of the screen, along with an image showing “Resume the game.” Moreover an image, which shows “My lord, Mr. Nobunaga, we have acquired the 100 golds by winning the battle during your absence.” as a line of the unit belonging to the group A “Hashiba Hideyoshi”, is displayed on the lower part of the screen.

Images as “WIN”, “320”, “CREDIT”, “500”, “BET”, and “0” are displayed. These images indicate that the accumulative number of the medals won by the player playing the strategic simulation game on the satellite A is 320, that the points stored in the RAM 133 of the satellite A are 500, and that the challenge fee stored in the RAM 133 of the satellite A is 0.

In addition, when the player operating the group A stops playing the strategic simulation game, images as “WIN”, “220”, “CREDIT”, “400”, “BET”, and “0” are displayed on the screen 14a of the image display device 14 provided in the satellite A (refer the FIG. 22C). This indicates that, even though the accumulative number of the medals was 220 and the number of the points stored in the RAM 133 of the satellite A was 400 when the player operating the group A stopped the strategic simulation game, the group A won the fight against the group C while the player operating the group A has stopped the game, thus when the player operating the group A resumeed continuing the game, the player operating the group A has won the challenge fee (100 points) paid by the player operating the group C when the aforementioned player provoked the fight.

[6] The Step of Participating in the Strategic Simulation Game Different from the Stopped Game.

In abovementioned step [5], the situation, in which the player (the player operating the group A) who stopped playing the strategic simulation game resumes playing by using the built-in-IC-chip medal stored in the game stop data, has been explained. In the present invention, however, it is possible for the player who stopped the other strategic simulation game to start playing the aforementioned strategic simulation game by using the built-in-IC-chip medal with in which the stop game data in the aforementioned other strategic simulation game is stored.

For example, in the medal operated gaming machine of the present invention, when each player operating the group A through C is playing a strategic simulation game G1 in each satellite A through C, a player who has the built-in-IC-chip medal where the game stop data (data concerning the group D) in the strategic simulation game G2 is stored, can newly participate in the strategic simulation game G1 with the aforementioned built-in-IC-chip medal.

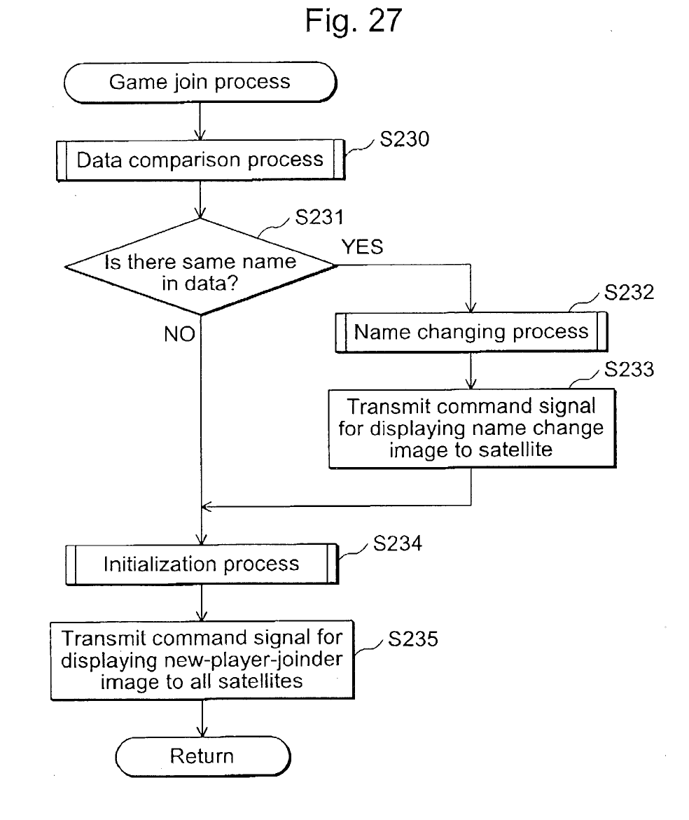

FIG. 27 is a flowchart illustrating the subroutine to be executed in the main control unit 100, when the player who stopped the other strategic simulation game participates in the aforementioned strategic simulation game with the built-in-IC-chip medal where the game stop data in the aforementioned other strategic simulation game is stored. This subroutine is executed after being called in the subroutine of the step S119 presented in the abovementioned FIG. 9B.

In addition, the explanation of FIG. 27 talks about the situation, in which when each player operating the group A through C plays a strategic simulation game in each satellite A through C, a player who has the built-in-IC-chip medal where the history data of the game (data concerning the group D) is stored, newly participates in the strategic simulation game with aforementioned built-in-IC-chip medal. The satellite, in which the strategic simulation game is played by a player operating the group D, is called satellite D.

First of all, the CPU101 of the main control unit 100 executes the processing of comparing the data read in the step S118 of the subroutine illustrated in the FIG. 9B (data concerning the group D) with the data concerned the groups participating in advance in a strategic simulation game (data concerning the groups A to C) (step S230).

The data-comparing process is to compare and see, for example, whether or not the name of the leader of the group D and the name of the unit belonging to the group D and so on correspond to the names of the leader of the groups A to C and the names of the units belonging to the groups A to C and so on.

When executing the processing of the step S230, the CPU 101 of the main control unit 100 judges if there is a data overlapping into the data read in the step S118 of the subroutine illustrated in the FIG. 9B (data concerning the group D) and into the data concerning the groups participating in advance in the strategic simulation game (data concerning the groups A to C) (step S231).

When it is judged that there is an overlapping data in the step S231, the CPU 101 of the main control unit 100 changes the data, which overlaps into the data concerning the groups participating in advance in the strategic simulation (data concerning the groups A to C) among those data read in the step S118 of the subroutine illustrated in FIG. 9B, to another data (step S232).

For example, when the leader of the group D is “Oda Nobunaga” and the leader of the group A is also “Oda Nobunaga,” there will be some trouble in proceeding with the game if letting the group D remain participated in the strategic simulation game, since the name of the leader of the group D is same as the one of the group A. Moreover, when the territory administered by the group D is “Owari” and the territory administered by the group A is also “Owari,” it will be difficult to let the group D remain participated in the strategic simulation game. In order to avoid such kind of situations, in the step S232, the CPU 101 of the main control unit 100 carries out the processing of changing the data overlapping into the data concerning the groups A to C, among the data concerning the group D, to other data.

When changing the data overlapping into the data concerning the groups A to C, among the data concerning the group D, to other data, the methods described hereafter can be available as a method to choose the aforementioned other data. In other words, it is possible to use the method for choosing the other data by previously setting a probabilistic tables for the leaders and the units appearing in a strategic simulation game corresponding to random numbers, and by sampling the random numbers by the CPU 101. Moreover, as a result of the abovementioned drawing(sampling?), when the overlapping data is selected, it is possible to select the data, which does not overlap, by having a drawing once again. For the data concerning the territory etc. administered by the groups, it is possible to change to the other data by using the same method.

In addition, the data to be changed in the processing of the step S232, as described above, for example, are related to the names of the leader or the unit of the group and to the territory and so on administered by the group, and in step S232, the ability value of the group (for example, ability values and so on of the leader or the unit of the group).

In the step S232, when executing the processing of changing the names and so on as described above, the next thing is to send a command signal for displaying an image, which represents that the data concerning the group D (for example, the data concerning the names of the leader or the unit of the group, the data concerning the territory administered by the group D and so on) has been changed, to the CPU 101 of the controller 100 provided in the satellite D (step S233).

On tire other hands as soon as the CPU 13-1 receives abovementioned command signal, the CPU 131(101?) does the processing of having the screen 14a of the image display device 14 display the image showing that the data concerning the group D has been changed. In other words, based on the draw command and so on from the CPU 131, VDP 136 reads the a necessary image data out of the image data stored in the ROM 132, generates a composite image data, and writes it into the frame buffer 137. Then, the composite image data written into the frame buffer 137 is sent to;the image display device 14, and the image, which shows that the data concerning the group D has been changed, is displayed on the screen 14a.

In addition, the image, which shows that the data concerning the group D has been changed, includes an image prompting to select participation or nonparticipation in the game based on the changed data. When a player inputs the indication of nonparticipation based on the changed data, it is desirable to carry out the processing of changing the names and so on as described above.

This is because, for example, when the names of the leader or the unit of the group are changed, the player's attachment for the group may wane off and also the player may lose interest in the game. However, it is possible to avoid the situation where the player may lose interest by giving the player a chance to decide to what type of data the player would want to change.

In the step S231, when it is judged that there is no overlapping data, or when carrying out the processing of the step S233, the CPU 101 of the main 5 control unit 100 executes the initialization processing. The initialization processing is to have a player participate in the strategic simulation game proceeding in the group D based on the data concerning the group D after the change, when the game stop data read in the step S112 of the subroutine shown in the FIG. 9A (data concerning the group D) or the data in abovementioned step S232 is changed.

Next, the CPU 101 of the main control unit 100 sends the command signal for displaying the image showing that a new player has participated to the CPU 131 of the controller 130 provided in all of the satellites (satellite A to C), where the strategic simulation game is played, and terminates the present subroutine thereafter.

The CPU 131 that received the command signal, then, sends a draw command and so on to the VDP 136. The VDP 136, then, reads a necessary image data out of the image data stored in the ROM 132, generates the composite image data, and writes it into the frame buffer 137. Thereafter the composite image data written into the frame buffer 137 is sent to the image display device 14, and then an image illustrating that the new player has participated is shown on the screen 14a.

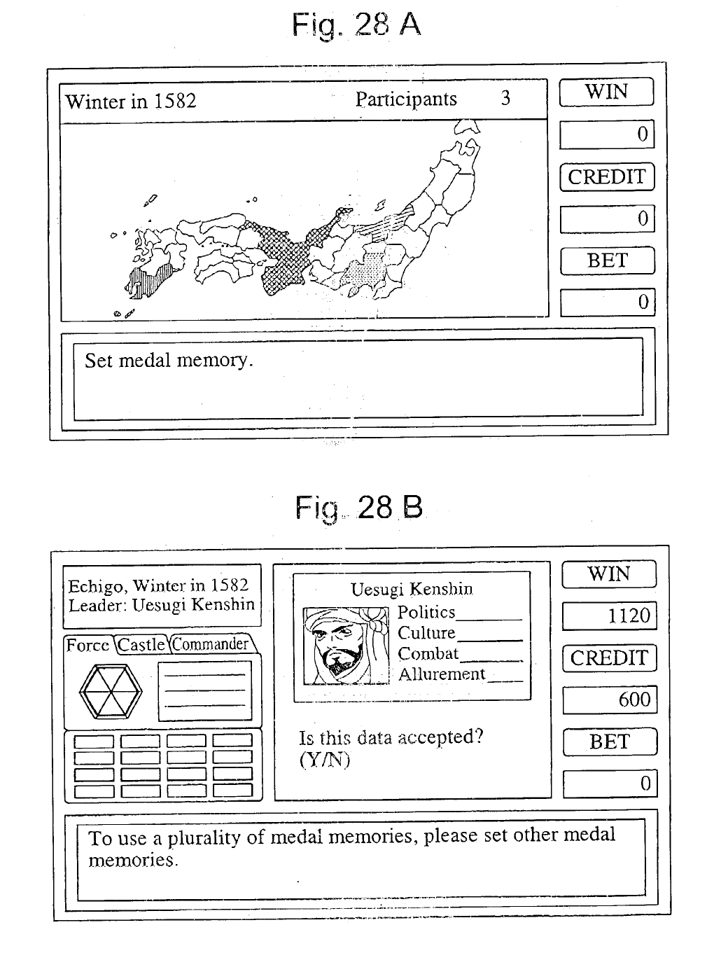

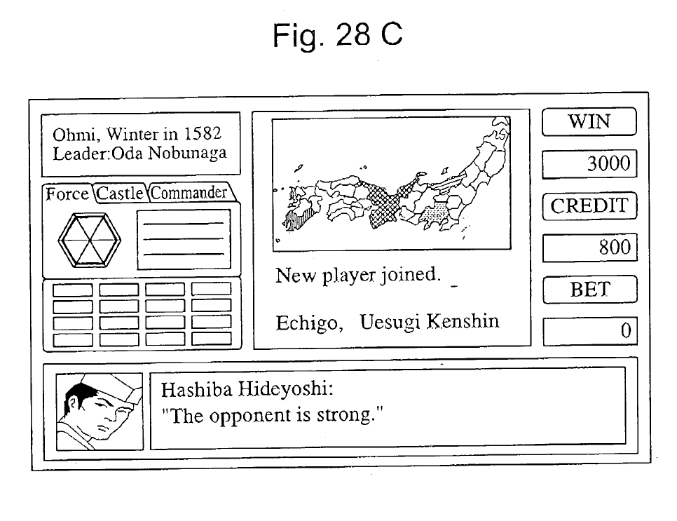

FIGS. 28A to 28C are illustrations schematically showing screen images displayed on the screen 14a of the image display unit 14 of the satellite A or D when the subroutine shown in FIG. 27 is executed.

The screen images shown in FIG. 28A are screen images displayed on the screen 14a of the image display unit 14 of the satellite on which no game is performed when a strategic simulation game is currently progressed on the medal game machine 10.

Images showing an imaginary year and season “Winter in 1582” of the strategic simulation game currently progressed on the medal game machine 10 and images showing the number of players “participants 3” participated in the strategic simulation game are displayed on the upper side of the screen.

The image showing a Japanese map is displayed at the center of the screen and the Japanese map shows which group governs which domain.

Moreover, the image showing an operational procedure “Set medal memory.” is displayed at the lower side of the screen.

Screen images shown in FIG. 28B are screen images displayed on the screen 14 of the image display unit 14 set to the satellite D when the processing in step S233 of the subroutine shown in FIG. 27 is executed.

Images “Echigo, Winter in 1582” displayed on the top left of the screen are images showing an imaginary year, season and the location of the group D in the strategic simulation game and the image “leader: Uesugi Kenshin” displayed at the lower side of the above images is an image showing that the leader of the group D to be operated by a player who starts the strategic simulation game at the satellite D is Uesugi Kenshin. Moreover, the image showing the ability value of the group D to be operated by a player who starts the strategic simulation game at the satellite D is displayed below the above image.

Images of “WIN”, “1120”, “CREDIT”, “600”, “BET”, and “0” are displayed at the right of the screen and these images show that the accumulated number of medals obtained by a player who starts the strategic simulation game at the satellite D is 1,120, the number of points stored in the RAM 133 of the satellite D is 600, and the challenge cost stored in the RAM 133 of the satellite D is point 0.

The data on “Uesugi Kenshin” who is the leader of the group D is displayed, moreover the image showing an operational procedure “Is this data acceptable?” is displayed, and an image showing an option “Y/N” is displayed correspondingly to the operational procedure at the central portion of the screen. Moreover, an image showing another operational procedure “To use a plurality of memories, also set another medal memory.” is displayed at the lower side of the screen.

In this case, when “N” is selected, names or the like are changed in step S232.

Screen images shown in FIG. 28C are screen images to be displayed on the screen 14a of the image display unit 14 set to the satellite A when the processing in step S235 of the subroutine shown in FIG. 27 is executed.

The images “1582 Winter Omi” displayed on the top left of the screen are images showing imaginary year, season and the location of the group A in the strategic simulation game and the image “leader: Oda Nobunaga” displayed at the lower side of the above images is an image showing that the leader of the group A to be operated by a player who performs the strategic simulation game at the satellite A is Oda Nobunaga. Moreover, the image showing the ability value of the group A to be operated by a player who performs the strategic simulation game at the satellite A is displayed below the above image.

Images of “WIN”, “3000”, “CREDIT”, “800”, “BET”, and “0” are displayed at the right of the screen and these images show that the accumulated number of medals obtained by a player who performs the strategic simulation game at the satellite A is 3,000, the number of points stored in the RAM 133 of the satellite A is 800, and the challenge cost stored in the RAM 133 of the satellite A is point 0.

A Japanese map showing which group governs which domain is displayed and images “New player joined.” and “Echigo Uesugi Kenshin” are displayed at the central portion of the screen. Moreover, an image “The opponent is strong.” is displayed as the words of the unit “Hashiba Hideyoshi” belonging to the group A at the lower side of the screen.

In the case of a medal game machine of the present invention which provides a strategic simulation game, it is preferable to give a player a predetermined number of medals when the player achieves a predetermined purpose given in a game.

It is possible to make a player further being too much into a game by arousing the motivation of the player for achieving a predetermined purpose.

When the player achieves the predetermined purpose and obtains a predetermined number of medals, it is possible to enhance the sense of accomplishment and feeling of satisfaction of the player.

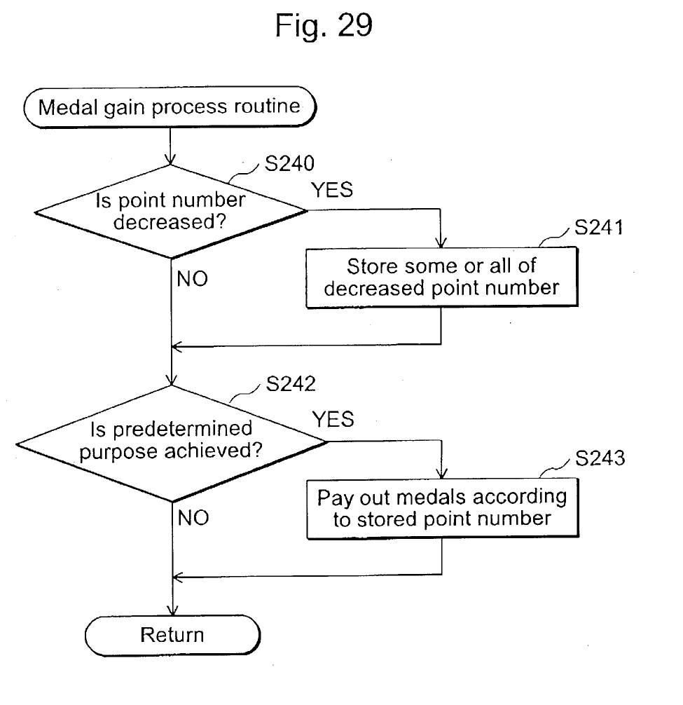

FIG. 29 is a flowchart showing a subroutine to be executed while a strategic simulation game is progressed. The subroutine is a subroutine to be executed by the control unit 130 set to a satellite when the strategic simulation game currently progressed in the satellite is in the training mode.

The subroutine is called from a main routine to bed executed by the control unit 130 at a predetermined timing and executed.

First, it is judged whether the number of points is decreased (step 241).

This determination corresponds to the processing in step S136 of the subroutine shown in the above FIG. 11.

When it is judged that the number of points is decreased, the CPU 131 of the control unit 130 set to the satellite 12 stores some or all of the decreased number of points in the RAM 133 or flash memory 138 (step S241).

Then, the CPU 131 of the control unit 130 set to the satellite 12 judges whether a predetermined purpose in the training mode is achieved (step S242). The predetermined purpose in the training mode is, for example, a purpose of unifying a country which is the location of a group (e.g. “Owari” ) as described above.

When it is judged in step S242 that the predetermined purpose is achieved, the processing for paying out the number of medals corresponding to the number of points stored in step S241 as bonus (step S243) is executed to complete this subroutine.

That is, the CPU 131 drives the hopper 121 to make the hopper 121 pay out medals by transmitting an instruction signal to the hopper 121. When the medal detecting section 122 detects the medals paid out from the hopper 121, it transmits a detection signal to the CPU 131. The CPU 131 stores the frequency of receiving detection signals in the RAM 133 whenever receiving a detection signal and when the CPU 131 judges that the frequency of receiving detection signals reaches a predetermined frequency, it transmits an instruction signal for stopping paying-out of medals to the hopper 121. As a result, paying-out of medals by the hopper 121 is completed. In the case of the processing in step S243, it is also allowed to increase the number of points stored in the RAM 133 or flash memory 138 instead of paying out medals.

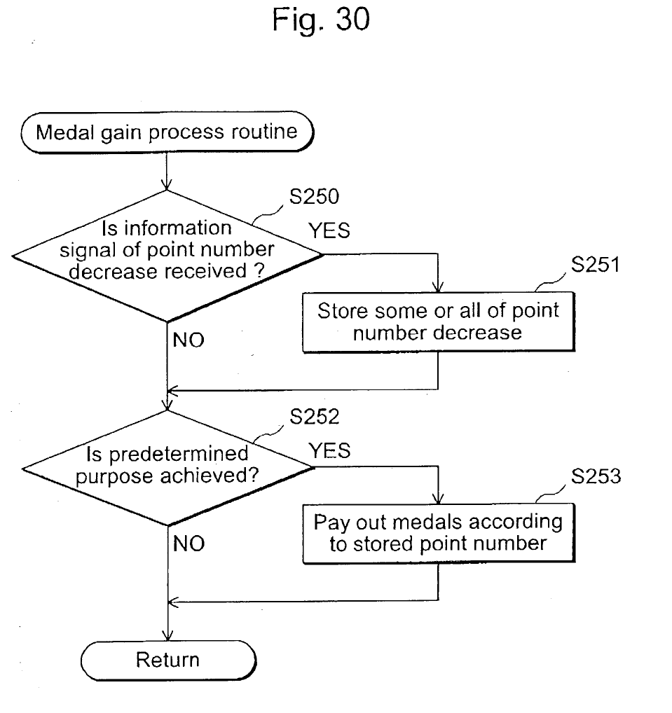

FIG. 30 is a flowchart showing a subroutine to be executed while a strategic simulation game is progressed. The subroutine is a subroutine to be executed by the main control unit 100 when a strategic simulation game in which any satellite is currently progressed is in the combat mode.

The subroutine is called from the main routine currently executed by the main control unit 100 at a predetermined timing and executed.

First, it is judged whether an information signal showing the number of points is decreased is received (step S251). That is, the CPU 101 of the main control unit 100 judges whether an information signal showing that the number of points is decreased is received from the CPU 131 of the control unit 130 of the satellite 12 in which a strategic simulation game is performed in the combat mode. The determination in the step S251 corresponds to the processing in step S136 of the subroutine shown in the above FIG. 11.

When it is judged that the information signal showing that the number of points is decreased is received from the CPU 131 of the control unit 130 of the satellite 12 in which the strategic simulation game is currently performed in the combat mode, the CPU 101 of the main control unit 100 stores some or all of the decreased number of points in the RAM 103 or flash memory 104 (step S251).

Then, the CPU 101 of the main control unit 100 judges whether a predetermined purpose in the combat mode is achieved (step S252). The predetermined purpose in the combat mode includes, for example, a purpose of unification of the whole country (to govern all domains) as described above.

When it is judged in step S252 that the predetermined purpose is achieved, the processing for paying out medals corresponding to the number of points stored in step S251 as a bonus is executed (step S253) to complete this subroutine.

That is, the CPU 100 transmits an instruction signal showing that a player achieving the predetermined purpose pays out medals to the CPU 131 of the control unit 130 of the satellite 12 in which a game is performed. The CPU 131 of the control unit 130 of the satellite 12 transmits an instruction signal to the hopper 121 and thereby drives the hopper 121 and makes the hopper 121 pay out medals. When the medal detecting section 122 detects the medals paid out from the hopper 121, it transmits a detection signal to the CPU 131. The CPU 131 stores the frequency of receiving detection signals in the RAM 133 whenever receiving a detection signal and when it judges that the frequency of receiving detection signals reaches a predetermined frequency, transmits an instruction signal for stopping paying-out of medals to the hopper 121. As a result, paying-out of medals by the hopper 121 is completed. In the case of the processing in step S243, it is also allowed to increase the number of points stored in the RAM 133 or flash memory 138 of the control unit 130 set to the satellite 12 instead of paying-out of medals.

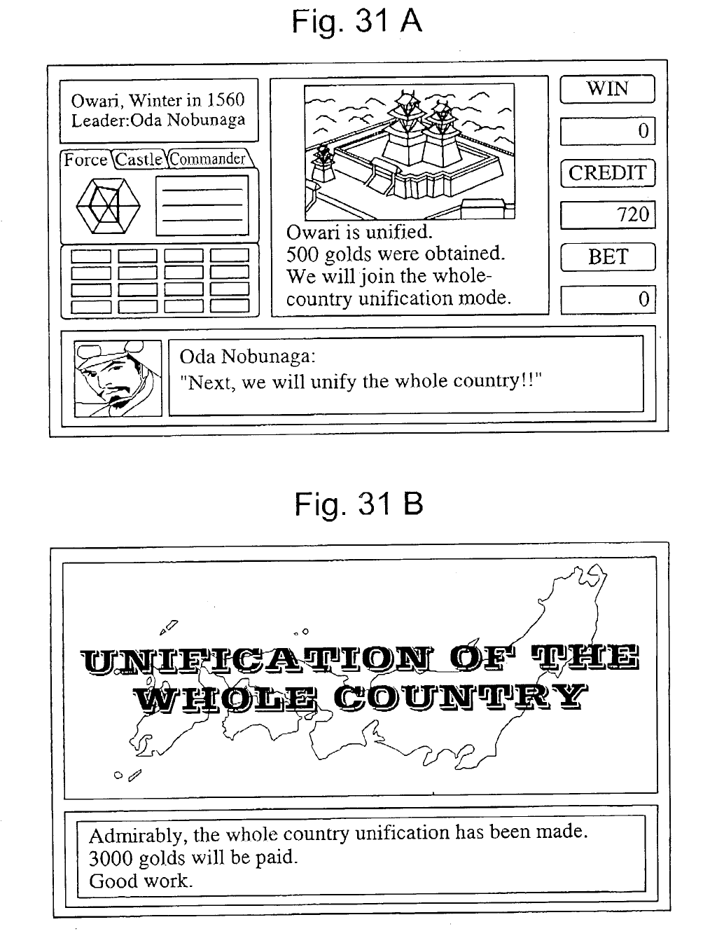

FIGS. 31A and 31B are illustrations showing screen images displayed on the screen 14a of the image display unit 14 set to the satellite 12 when the subroutine shown in FIGS. 29 or 30 is executed.

The screen images shown in FIG. 31A are screen images to be displayed on the screen 14a of the image display unit 14 set to the satellite 12 when a predetermined purpose in the training mode is achieved.

Images “1560 Winter Owari” displayed at the top left of the screen are images showing imaginary year, season and the location of the group A in a strategic simulation game and the image leader: Oda Nobunaga” displayed below the above images is an image showing that the leader of the group A to be operated by a player who performs the strategic simulation game at the satellite A is Oda Nobunaga. Moreover, an image showing the ability value of the group A to be operated by a player who performs the strategic simulation game at the satellite A is displayed below the above image.

Images of “WIN”, “0”, “CREDIT”, “720”, “BET”, and “0” are displayed at the right of the screen and these images show that the accumulated number of medals obtained by a player who performs the strategic simulation game at the satellite B is 0, the number of points stored in the RAM 133 of the satellite A is 720, and the challenge cost stored in the RAM 133 of the satellite A is point 0.

At the central portion of the screen, an image showing the castle where the group A stays is displayed and images showing “Owari is unified.”, “500 golds are obtained.”, and “We will join the whole-country unification mode.” are displayed. Moreover, an image showing “Next, we will unify the whole country!!” is displayed as the words of “Oda Nobunaga” the leader of the group A at the lower side of the screen.

In this case, the CPU 131 judges that the predetermined purpose is achieved in the step S242 of the subroutine shown in FIG. 29 and executes the processing of increasing the number of points stored in the RAM 133 up to 720 points by adding 500 points to 220 points in step S243.

The images shown in FIG. 31B are screen images to be displayed on the screen 14a of the image display unit 14 set to the satellite 12 when a predetermined purpose in the combat mode is achieved.

The image showing a Japanese map is displayed and the image showing “UNIFICATION OF THE WHOLE COUNTRY” is also displayed at the central portion of the screen. Moreover, images showing that “Admirably, the whole country unification is made.”, “3000 golds will be paid.” and “Good work.” are displayed at the lower side of the above images. In this case, the CPU 101 judges that the predetermined purpose is achieved in step S252 in the subroutine in FIG. 30 and performs the processing of adding 5,000 points to the number of points stored in the RAM 133 in step S253.

According to the medal with the built-in IC chip of the preferred embodiment of the present invention, it is possible for the built-in-IC-chip medal to have a new value in the game by having a plurality of the built-in IC chip medals store different types of data (for example, data of a character that appears in the game and/or an item that the character has) since the storage section for storing the initial data and the history data of the game supplied by the medal gaming machine is provided. It is possible to provide a medal with a novel value, increase the want for collecting medals, and make the player have the affection on the medal (medal with the a built-in IC chip). Therefore, by applying the built-in IC chip medal to the medal gaming machine, it is possible to make the player have a great fun with the game.

Furthermore, according to the present invention, it is possible to issue the built-in-IC-chip medal with the initial data of the game written in the storage section. Therefore, it is possible to issue built-in-IC-chip medals in which different data are stored every time of medal issuance. As a result, built-in-IC-chip medals having various values can be issued. Thus, it is possible for the player to be strongly impressed that the medal (the medal with built-in IC chip) has a new value to the player. For example, when the data of characters appearing on the game are stored in the built-in-IC-chip medal at the medal issuance, it is possible to make the player remarkably feel for the medal (medal with a built-in IC chip).

What is claimed is:

1. A medal used for a gaming machine, comprising:
an external body of a substantially thin disk shape which constitutes a medal external body;
an IC chip built-in said external body, wherein the IC chip comprises a storage section which is capable of storing initial data of a game and history data of the game supplied by the gaming machine; and
an interface section for transmitting the initial and/or history data between the gaming machine and the storage section.

2. The medal according to claim 1, comprising a distinction section being mounted on the external body such that the medal can be distinguished by the distinction section.

3. The medal according to claim 2, wherein the distinction section comprises a figure of a three-dimensional shape, which includes a planner shape.

4. The medal according to claim 2, wherein the distinction section has an appearance in association with a game character in a game played with the medal gaming machine.

5. The medal according to claim 1, wherein the IC chip comprises at least one pin being connected from the storage section and being exposed from an opening disposed on one side of the medal such that a contact of a connector of the gaming machine passes through the opening.

6. The medal according to claim 5, comprising at least one notch portion on a periphery of the external body.

7. The medal according to claim 6, wherein the medal may be set in a right rotational position by the notch portion to start a game.

8. The medal according to claim 1, wherein a strategic simulation game is played with the gaming machine by utilizing the medal.

9. A medal inscription machine for issuing a medal used for a gaming machine, comprising:
a main body;
a medal or coin inlet on the main body;
a control section on the main body for a purchaser to control the machine with;
a built-in IC chip medal pay outlet on the main body; and
a data writing device for writing an initial data of a game.

10. The medal inscription machine according to claim 9, wherein the medal comprises:
an external body of a substantially thin disk shape which constitutes a medal external body;
an IC chip built-in the external body, wherein the IC chip comprises a storage section which is capable of storing an initial data of a game and a history data of the game played with the gaming machine; and
an interface section for transmitting the initial and/or history data between the gaming machine and the storage section.

11. A medal system used for a game, comprising:
a first kind of medal which has a value for the game; and
a second kind of medal which has a built-in IC chips comprising a storage section for storing a status data of the game;
wherein the first and second kinds of medals are separated and different at least in possessed information thereof; and
wherein the first and second kinds of medals are used at the same time to play the game.

12. The medal system according to claim 11, comprising:
a medal inscription machine which may issue as many medals as a purchaser requests, wherein the medal inscription machine comprises: a main body; a medal or coin inlet on the main body; a control section on the main body for a purchaser to control the machine with; a built-in IC chip medal pay outlet on the main body; and a data writing device for writing an initial data of a game;
a gaming machine which requires at least one of the first and second kinds of medals, the game being played with the gaming machine such that the at least one of the first and second kinds of medals is disposed on the gaming machine so as that information from the at least one of the first and second kinds of medals is directed to a control section of the gaming machine.
